(19) United States
(12) Patent Application Publication
(10) Pub. No.: US 2025/0378725 A1
(43) Pub. Date: Dec. 11, 2025

(54) TECHNIQUES FOR MANAGING ACCESSORIES

(71) Applicant: Apple Inc., Cupertino, CA (US)

(72) Inventors: Mischa K. MCLACHLAN, San Francisco, CA (US); Trevor W. YOUNG, Livermore, CA (US)

(21) Appl. No.: 19/223,508

(22) Filed: May 30, 2025

Related U.S. Application Data
(60) Provisional application No. 63/657,901, filed on Jun. 9, 2024.

(51) Int. Cl. G07C 9/00

(52) U.S. Cl. CPC G07C 9/00309; G07C 2009/00333; G07C 2009/0042

(57) ABSTRACT

The present disclosure generally relates to managing accessories. Some techniques are for configuring accessories to be controlled in different manners in accordance with some embodiments. Other techniques are for configuring accessories to be controlled based on orientation in accordance with some embodiments. Other techniques are for surfacing a control in accordance with some embodiments. Other techniques are for notifying users of a current context in accordance with some embodiments. Other techniques are for distinguishing types of users in accordance with some embodiments.

### CROSS-REFERENCE TO RELATED APPLICATIONS

The present application claims priority to U.S. Provisional Patent Application Ser. No. 63/657,901, entitled “TECHNIQUES FOR MANAGING ACCESSORIES” filed Jun. 9, 2024, which is hereby incorporated by reference in its entirety for all purposes.

### FIELD

The present disclosure relates generally to computer user interfaces, and more specifically to techniques for managing accessories.

### BACKGROUND

Users often interact with accessories in many different ways. However, current techniques for interacting with such accessories via electronic devices is often complex and/or inefficient. Accordingly, there is a need for improved techniques related to accessing and/or managing accessories.

### SUMMARY

Some techniques for managing accessories using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing accessories. Such processes and interfaces optionally complement or replace other processes for managing accessories. Such processes and interfaces reduce the cognitive burden on a user and produce a more efficient human-machine interface. For battery-operated computing devices, such processes and interfaces conserve power and increase the time between battery charges. This can lead to improved system performance, reduced energy usage, and/or an overall better user experience when controlling accessories with electronic devices.

In some embodiments, a method that is performed at a computer system that is in communication with one or more input devices, and one or more display generation components is described. In some embodiments, the method comprises: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a non-transitory computer-readable storage medium storing one or more programs configured to be executed by one or more processors of a computer system that is in communication with one or more input devices, and one or more display generation components is described. In some embodiments, the one or more programs includes instructions for: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a transitory computer-readable storage medium storing one or more programs configured to be executed by one or more processors of a computer system that is in communication with one or more input devices, and one or more display generation components is described. In some embodiments, the one or more programs includes instructions for: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a computer system configured to communicate with one or more input devices, and one or more display generation components is described. In some embodiments, the computer system comprises one or more processors and memory storing one or more programs configured to be executed by the one or more processors. In some embodiments, the one or more programs includes instructions for: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a computer system configured to communicate with one or more input devices, and one or more display generation components is described. In some embodiments, the computer system comprises means for performing each of the following steps: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a computer program product is described. In some embodiments, the computer program product comprises one or more programs configured to be executed by one or more processors of a computer system that is in communication with one or more input devices, and one or more display generation components. In some embodiments, the one or more programs include instructions for: displaying, via the one or more display generation components, a user interface including a first user interface element and a second user interface element different from the second user interface element; while displaying the first user interface element and the second user interface element, detecting, via the one or more input devices, an input corresponding to a respective user interface element; and in response to detecting the input corresponding to the respective user interface element: in accordance with a determination that the respective user interface element is the first user interface element: configuring the computer system to control an accessory in a first manner without detecting, via the one or more input devices, an input; and configuring the computer system to control the accessory in a second manner without detecting, via the one or more input devices, an input, wherein the second manner is different from the first manner; and in accordance with a determination that the respective user interface element is the second user interface element, configuring the computer system to control the accessory in a third manner, wherein the third manner is different from the first manner and the second manner.

In some embodiments, a method that is performed at a computer system that is in communication with one or more input devices is described. In some embodiments, the method comprises: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a non-transitory computer-readable storage medium storing one or more programs configured to be executed by one or more processors of a computer system that is in communication with one or more input devices is described. In some embodiments, the one or more programs includes instructions for: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a transitory computer-readable storage medium storing one or more programs configured to be executed by one or more processors of a computer system that is in communication with one or more input devices is described. In some embodiments, the one or more programs includes instructions for: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a computer system configured to communicate with one or more input devices is described. In some embodiments, the computer system comprises one or more processors and memory storing one or more programs configured to be executed by the one or more processors. In some embodiments, the one or more programs includes instructions for: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a computer system configured to communicate with one or more input devices is described. In some embodiments, the computer system comprises means for performing each of the following steps: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a computer program product is described. In some embodiments, the computer program product comprises one or more programs configured to be executed by one or more processors of a computer system that is in communication with one or more input devices. In some embodiments, the one or more programs include instructions for: detecting, via the one or more input devices, a first orientation of a user relative to an accessory; and in response to detecting the first orientation of the user relative to the accessory: in accordance with a determination that the first orientation of the user relative to the accessory satisfies a first set of one or more criteria, controlling the accessory without detecting, via the one or more input devices, an input; and in accordance with a determination that the first orientation of the user relative to the accessory satisfies a second set of one or more criteria different from the first set of one or more criteria, forgoing control of the accessory.

In some embodiments, a method that is performed at a computer system that is in communication with one or more input devices and one or more display generation components is described. In some embodiments, the method comprises: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a transitory computer-readable storage medium storing one or more programs configured to be executed by one or more processors of a computer system that is in communication with one or more input devices and one or more display generation components is described. In some embodiments, the one or more programs includes instructions for: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a computer system configured to communicate with one or more input devices and one or more display generation components is described. In some embodiments, the computer system comprises means for performing each of the following steps: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: in response to automatically unlocking a lock, displaying, via the one or more display generation components, a user interface element corresponding to the lock; while displaying the user interface element corresponding to the lock, detecting, via the one or more input devices, an input corresponding to the user interface element; and in response to detecting the input corresponding to the user interface element, sending, to the lock, a request to lock.

In some embodiments, a method that is performed at a computer system that is in communication with one or more display generation components is described. In some embodiments, the method comprises: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a non-transitory computer-readable storage medium storing one or more programs configured to be executed by one or more processors of a computer system that is in communication with one or more display generation components is described. In some embodiments, the one or more programs includes instructions for: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a transitory computer-readable storage medium storing one or more programs configured to be executed by one or more processors of a computer system that is in communication with one or more display generation components is described. In some embodiments, the one or more programs includes instructions for: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a computer system configured to communicate with one or more display generation components is described. In some embodiments, the computer system comprises one or more processors and memory storing one or more programs configured to be executed by the one or more processors. In some embodiments, the one or more programs includes instructions for: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a computer system configured to communicate with one or more display generation components is described. In some embodiments, the computer system comprises means for performing each of the following steps: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a computer program product is described. In some embodiments, the computer program product comprises one or more programs configured to be executed by one or more processors of a computer system that is in communication with one or more display generation components. In some embodiments, the one or more programs include instructions for: detecting a request to display a user interface element corresponding to one or more accessories; and in response to detecting the request to display a user interface element corresponding to the one or more accessories: in accordance with a determination that a first set of one or more criteria is satisfied with respect to a current context, displaying, via the one or more display generation components, a first user interface element with information corresponding to the one or more accessories; and in accordance with a determination that a second set of one or more criteria is satisfied with respect to the current context, displaying, via the one or more display generation components, a second user interface element without information corresponding to the one or more accessories.

In some embodiments, a method that is performed at a computer system that is in communication with one or more display generation components is described. In some embodiments, the method comprises: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

In some embodiments, a non-transitory computer-readable storage medium storing one or more programs configured to be executed by one or more processors of a computer system that is in communication with one or more display generation components is described. In some embodiments, the one or more programs includes instructions for: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

In some embodiments, a transitory computer-readable storage medium storing one or more programs configured to be executed by one or more processors of a computer system that is in communication with one or more display generation components is described. In some embodiments, the one or more programs includes instructions for: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

In some embodiments, a computer system configured to communicate with one or more display generation components is described. In some embodiments, the computer system comprises one or more processors and memory storing one or more programs configured to be executed by the one or more processors. In some embodiments, the one or more programs includes instructions for: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

In some embodiments, a computer system configured to communicate with one or more display generation components is described. In some embodiments, the computer system comprises means for performing each of the following steps: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

In some embodiments, a computer program product is described. In some embodiments, the computer program product comprises one or more programs configured to be executed by one or more processors of a computer system that is in communication with one or more display generation components. In some embodiments, the one or more programs include instructions for: receiving a request to display a user interface of an accessory management application; and in response to receiving the request to display the user interface of the accessory management application: in accordance with a determination that an invitation to join a space of the accessory management application was received from a first user, displaying, via the one or more display generation components, the user interface with an indication of the first user and a user interface element of an accessory associated with the space of the accessory management application; and in accordance with a determination that the invitation to join the space of the accessory management application was received from a second user different from the first user, displaying, via the one or more display generation components, the user interface with an indication of the second user and the user interface element of the accessory associated with the space of the accessory management application.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing accessories, thereby increasing the effectiveness, efficiency, and user satisfaction with such devices. Such processes and interfaces may complement or replace other processes for managing accessories.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an electronic device in accordance with some embodiments.

FIG. 5J is a block diagram illustrating an electronic device in accordance with some embodiments.

FIGS. 6A-6AO illustrate exemplary user interfaces for managing accessories in accordance with some embodiments.

FIG. 7 is a flow diagram illustrating a process for configuring accessories to be controlled in different manners in accordance with some embodiments.

FIG. 8 is a flow diagram illustrating a process for configuring accessories to be controlled based on orientation in accordance with some embodiments.

FIG. 9 is a flow diagram illustrating a process for surfacing a control in accordance with some embodiments.

FIG. 10 is a flow diagram illustrating a process for notifying users of a current context in accordance with some embodiments.

FIG. 11 is a flow diagram illustrating a process for distinguishing types of users in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing accessories. For example, electronic devices can provide different unlock behaviors for an accessory based on user-selected settings. In another example, an electronic device can control an accessory based on the direction of user approach. In another example, electronic devices automatically display a relock control after auto-unlocking. In another example, electronic devices selectively display accessory information to guests based on context. In another example, electronic devices can display an inviter's name when showing accessory controls after invitation to a shared space. Such techniques can reduce the cognitive burden on a user who controls smart home accessories, thereby enhancing productivity. Further, such techniques can reduce processor and battery power otherwise wasted on redundant user inputs.

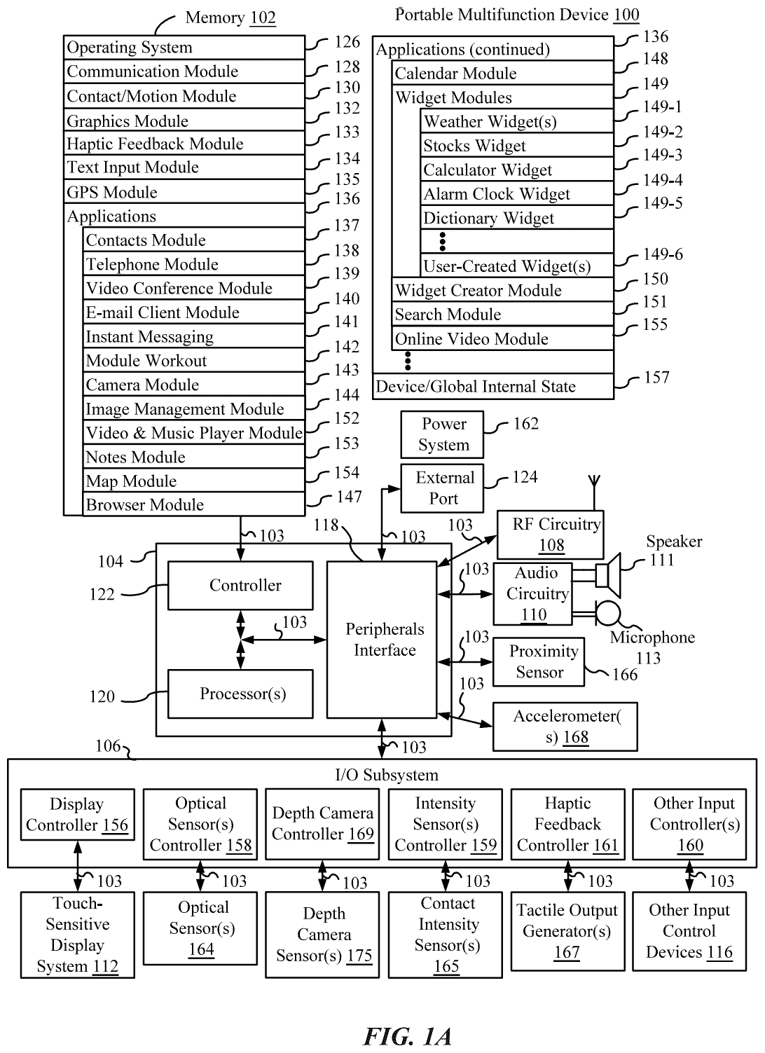

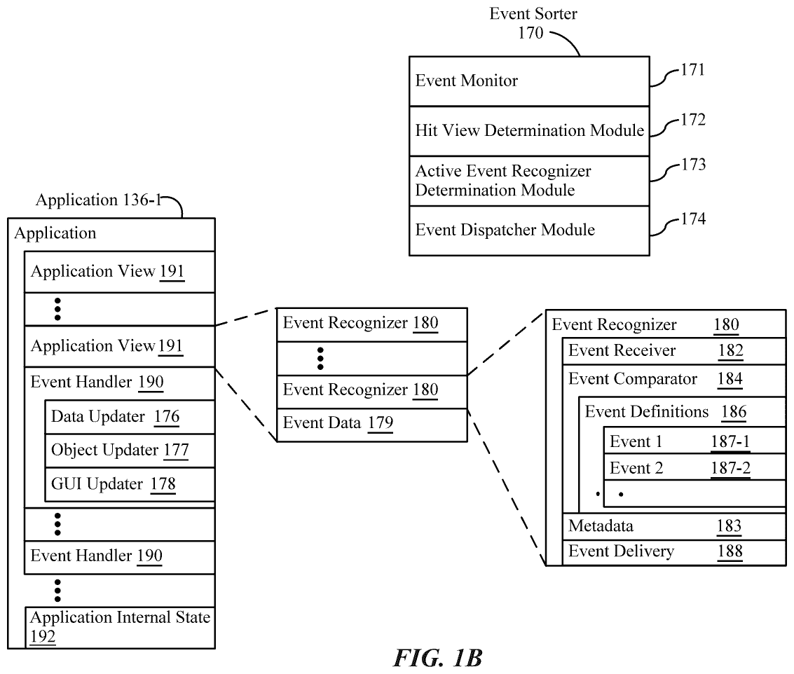

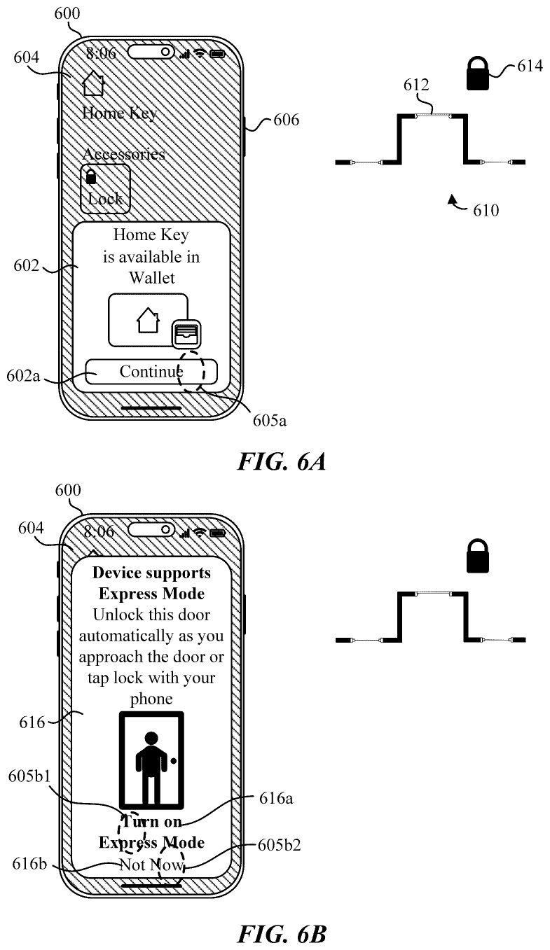

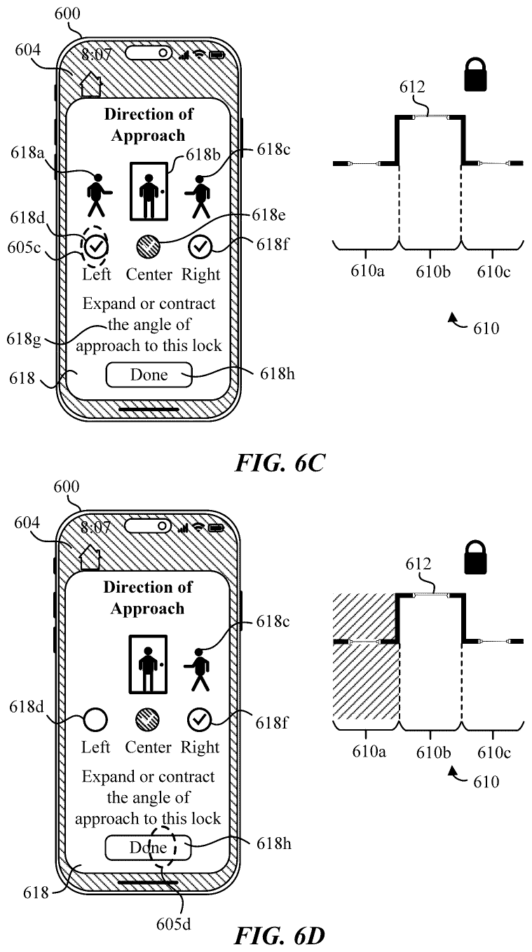

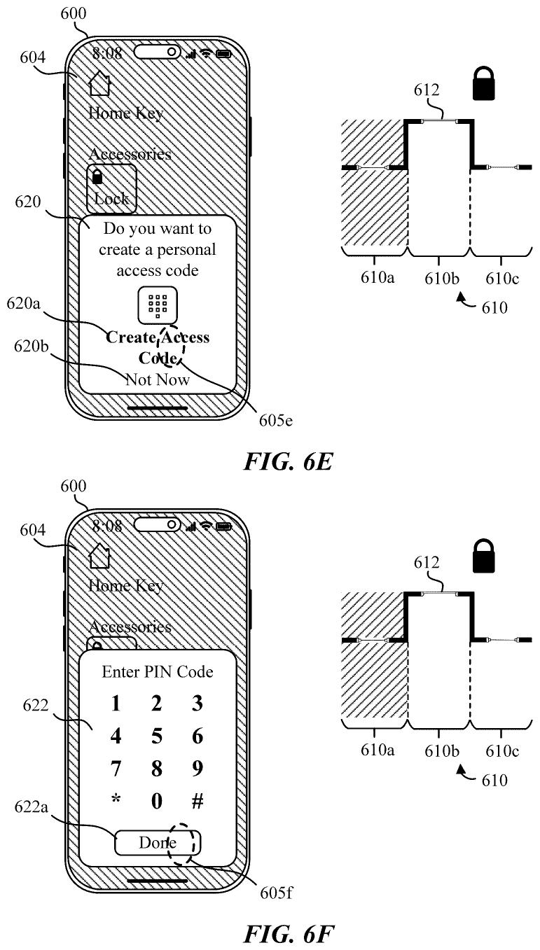

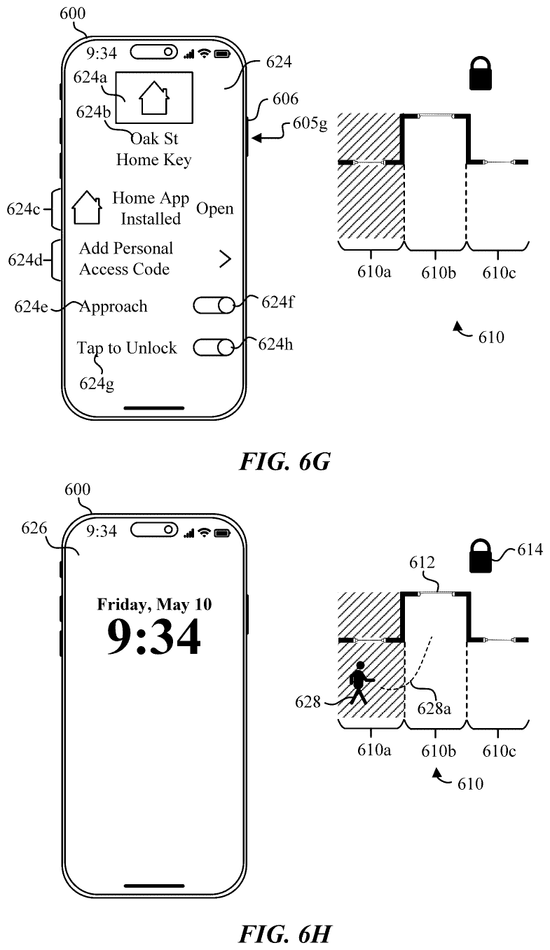

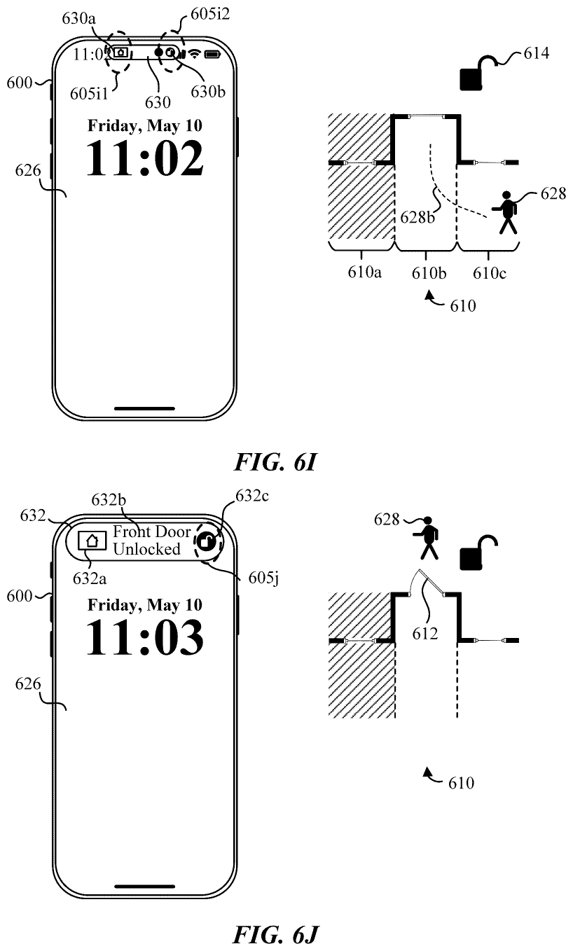

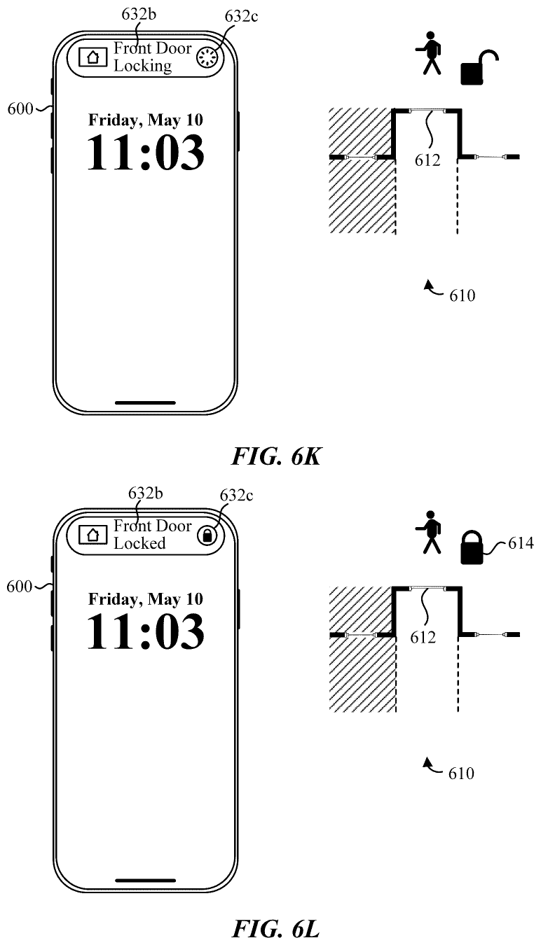

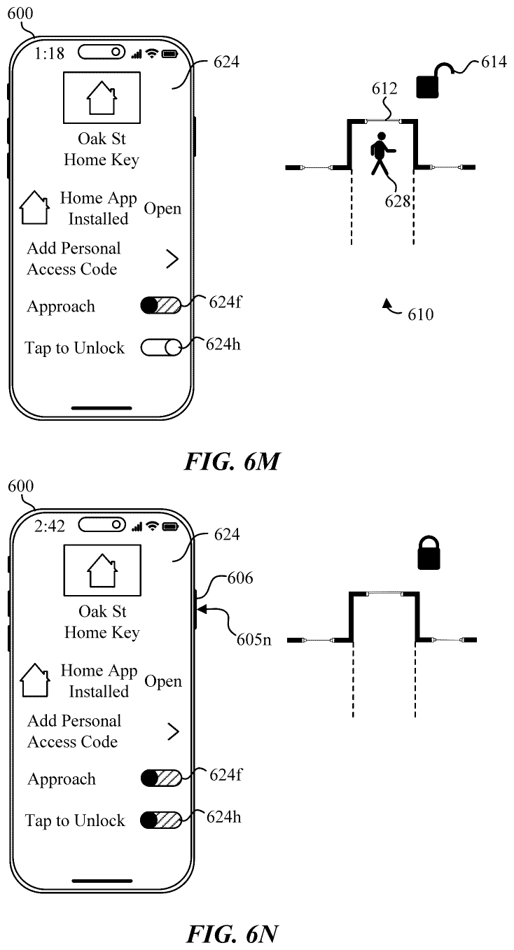

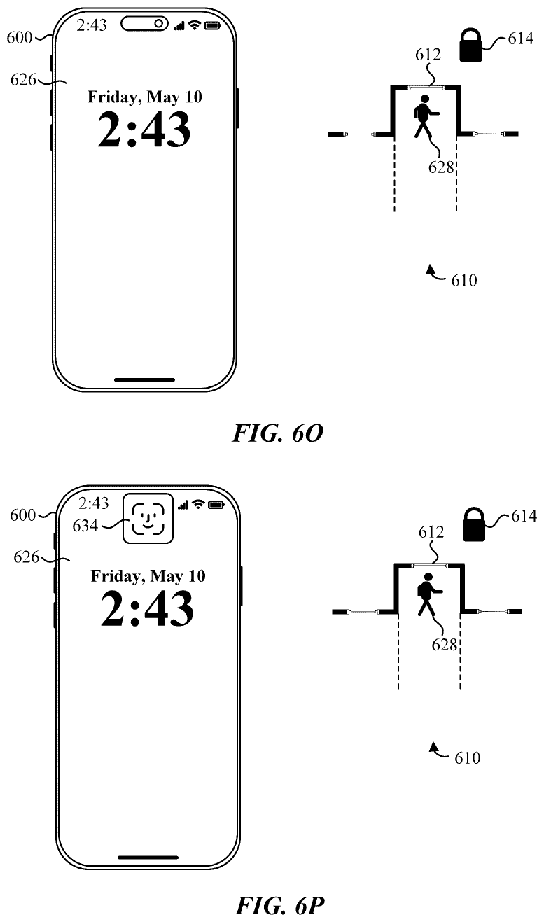

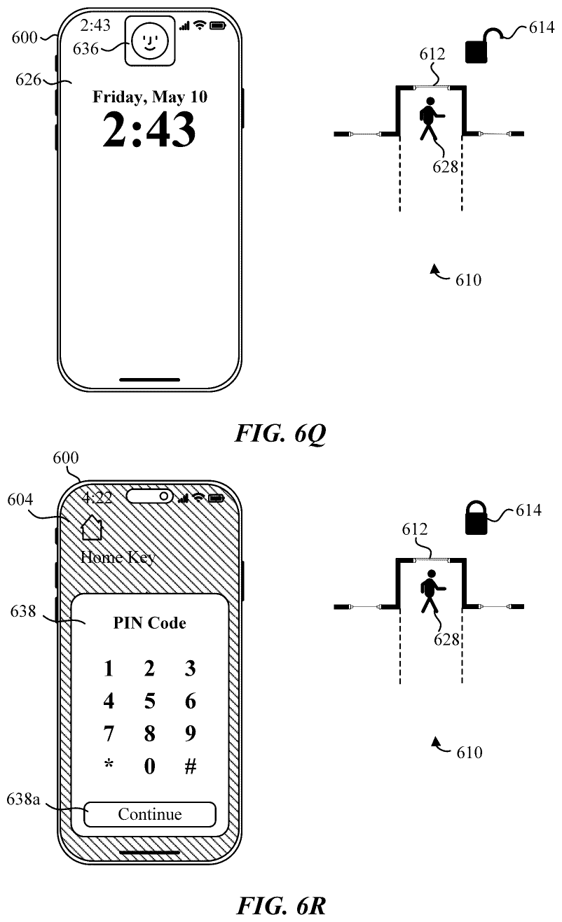

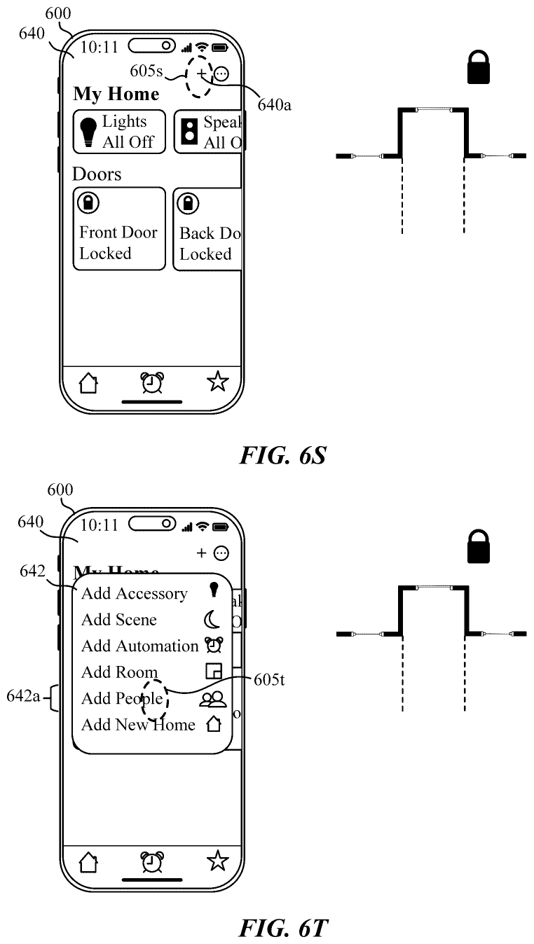

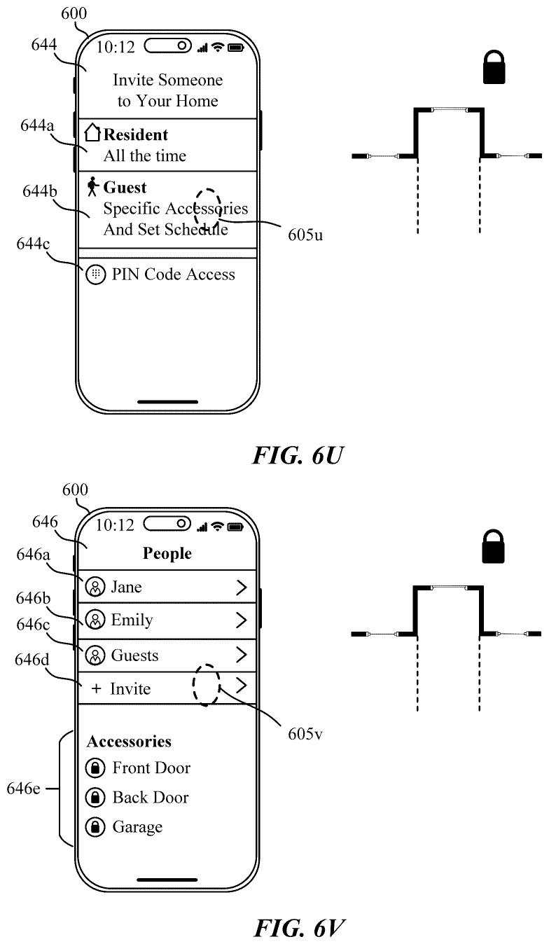

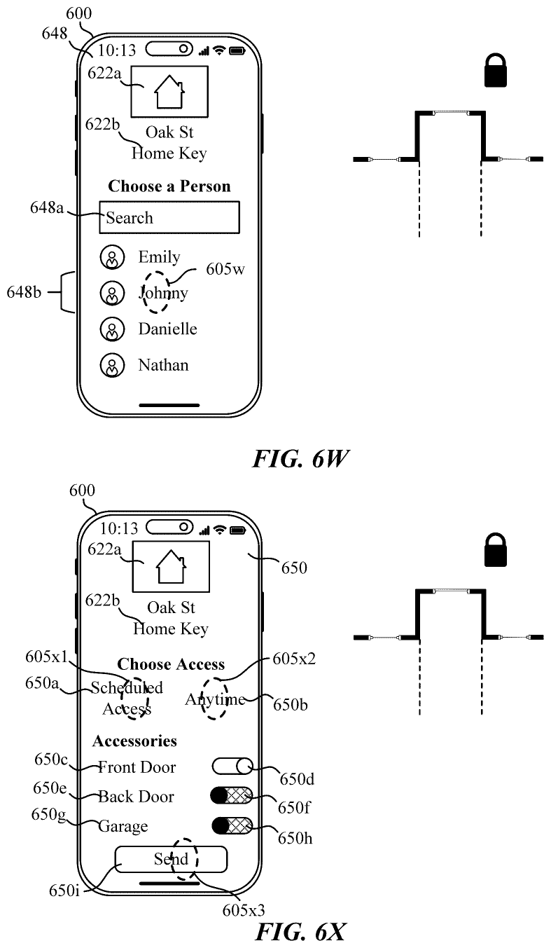

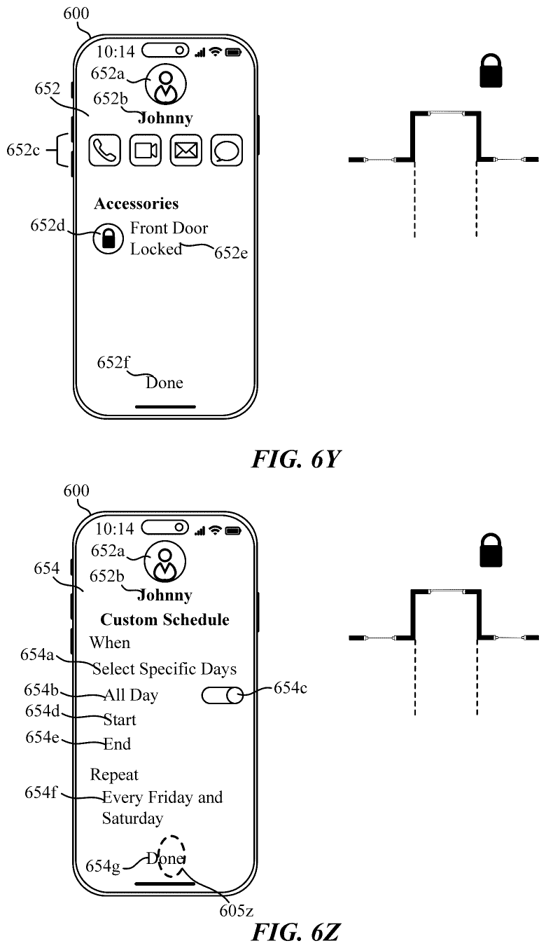

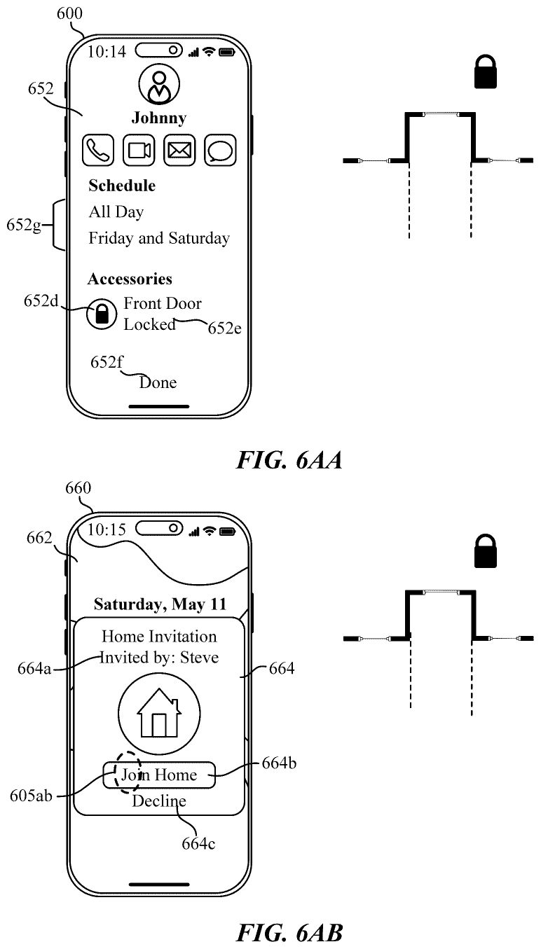

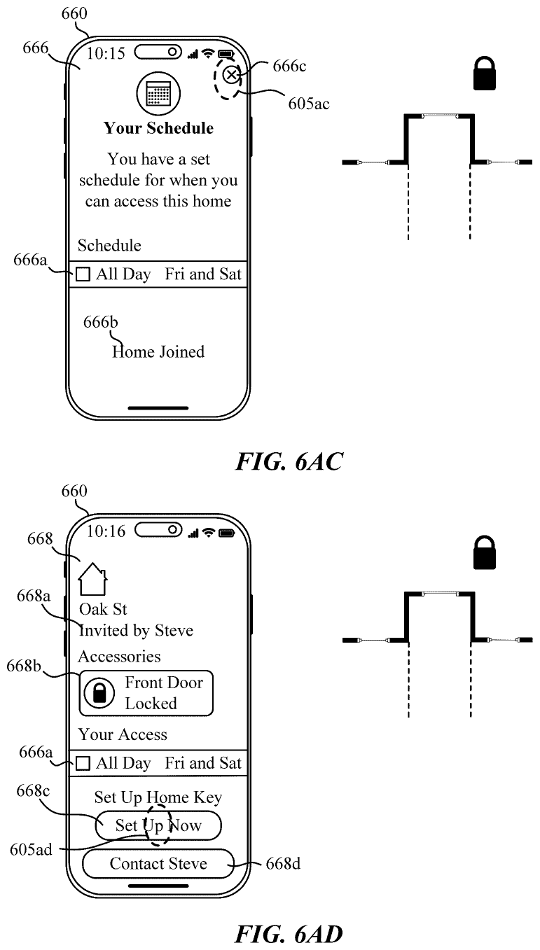

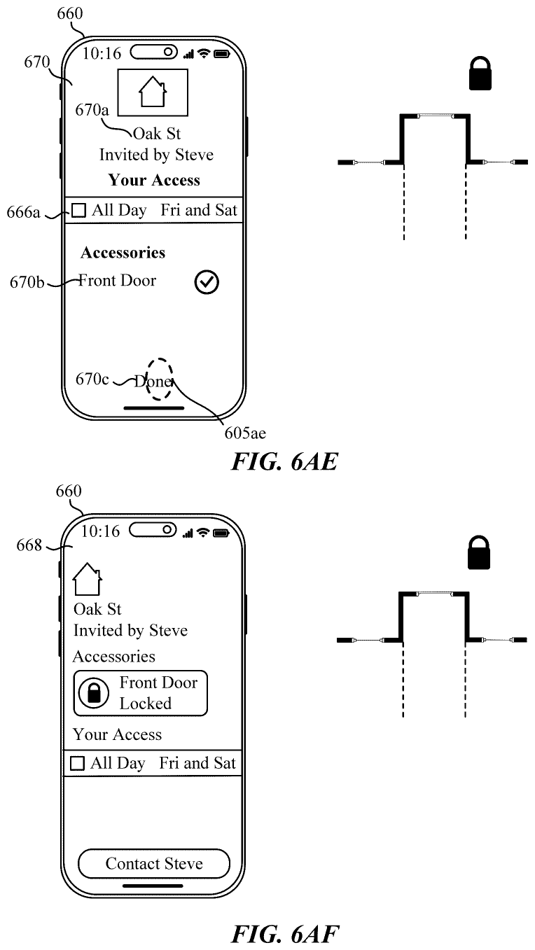

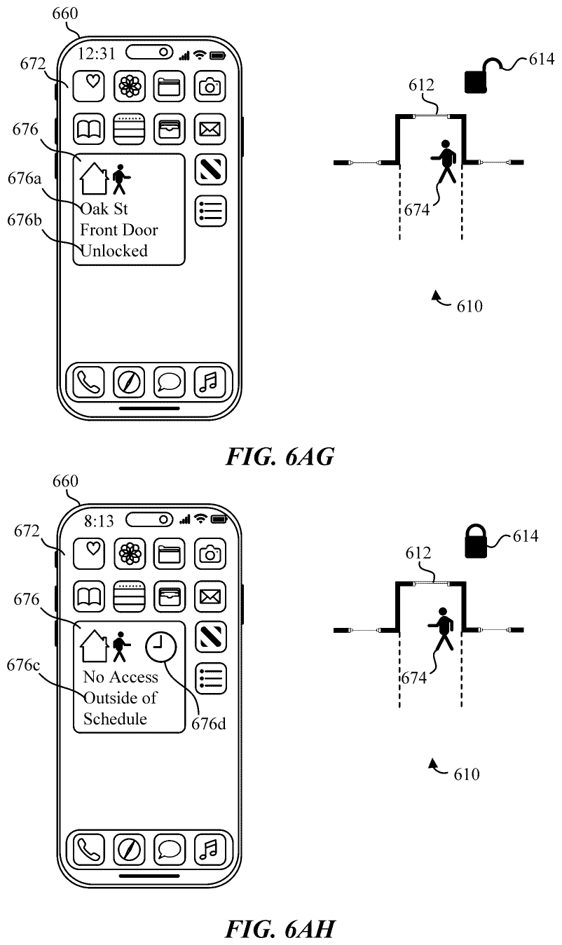

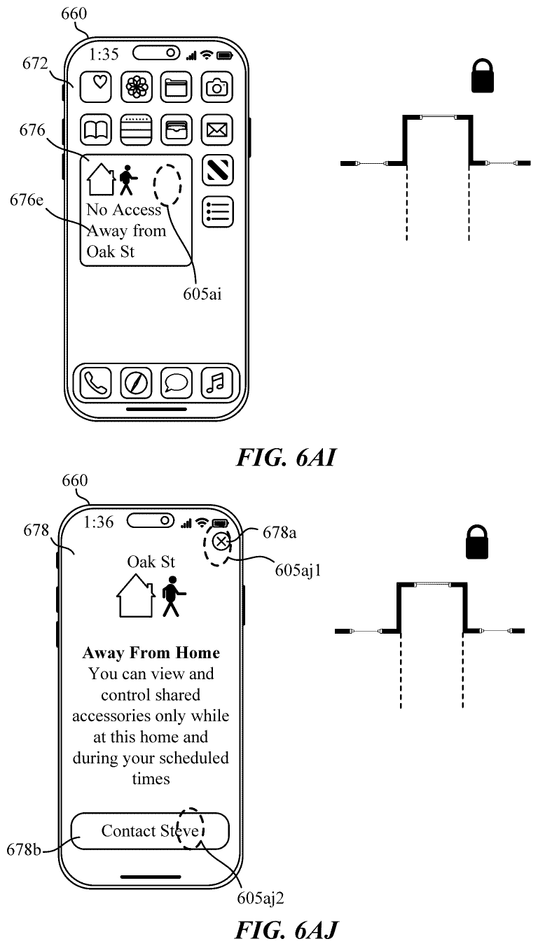

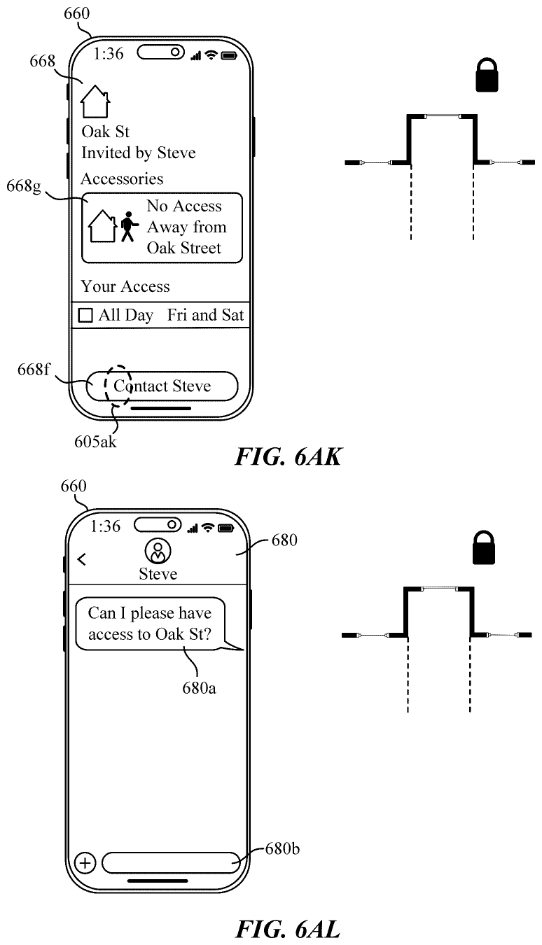

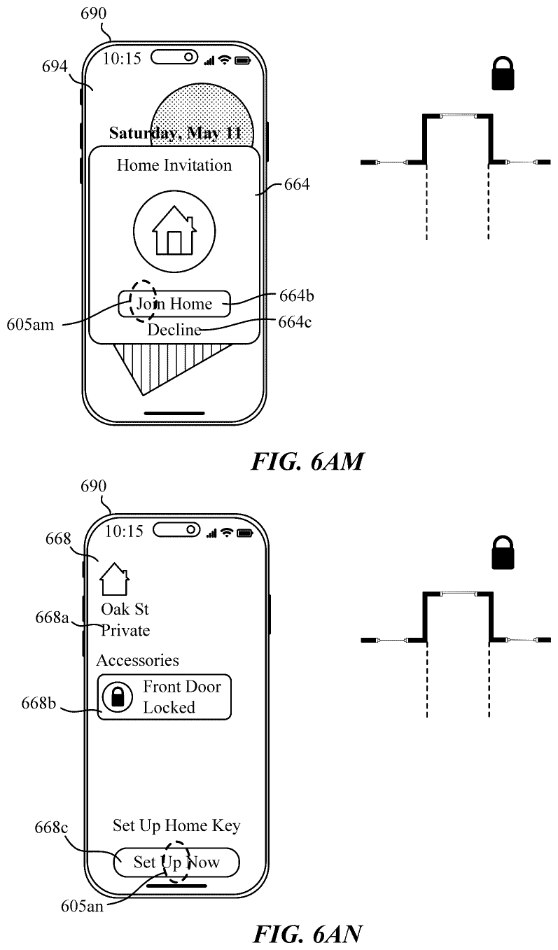

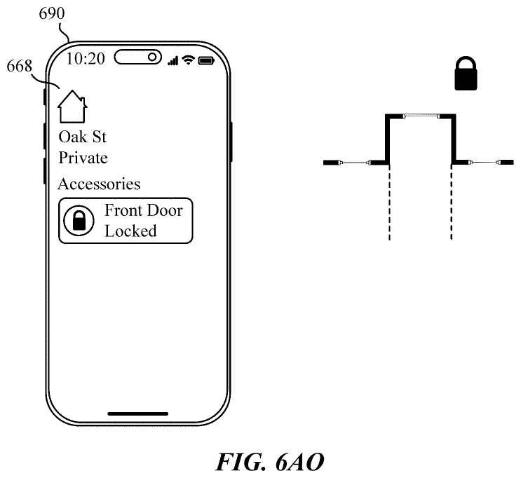

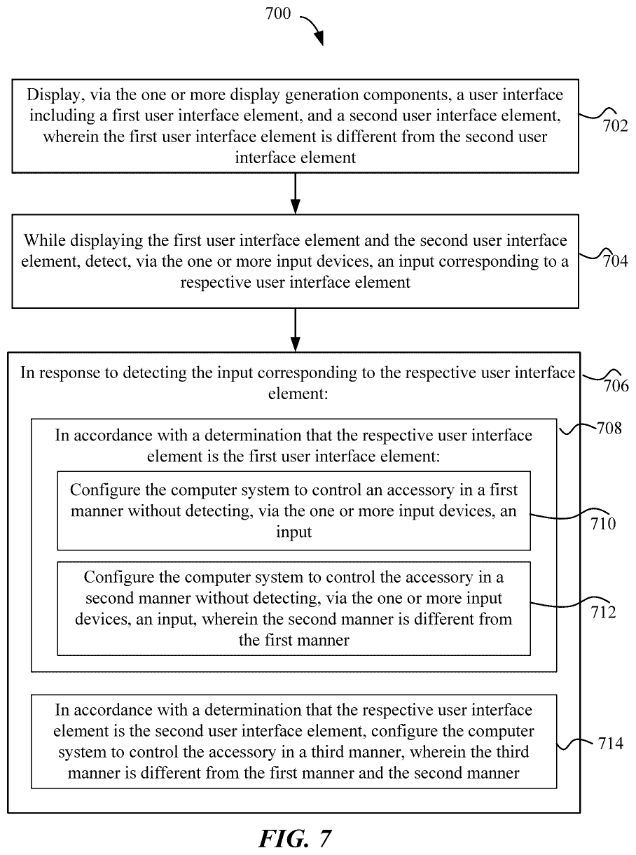

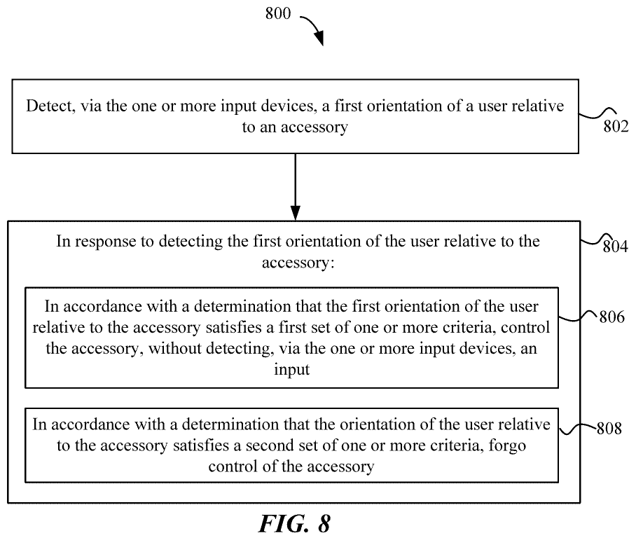

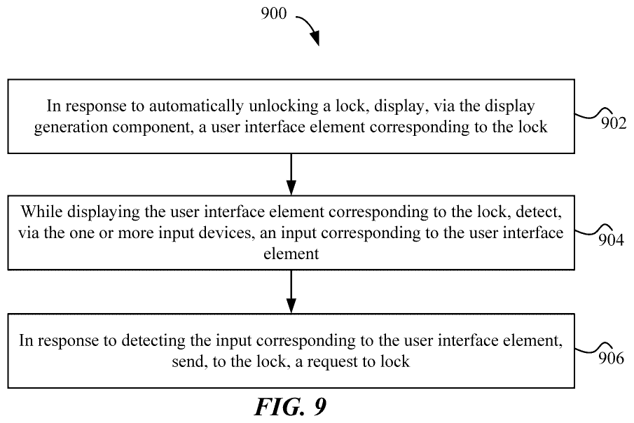

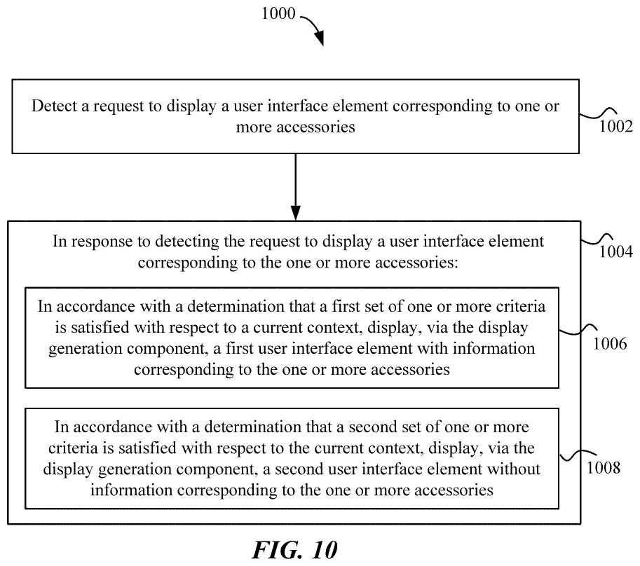

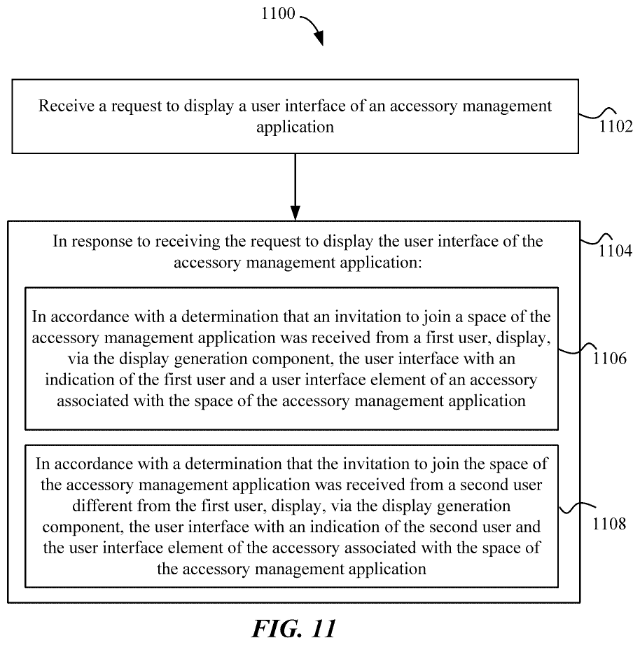

Below, FIGS. 1A-1B, 2, 3A-3G, 4A-4B, and 5A-5J provide a description of exemplary devices for performing the techniques for managing accessories. FIGS. 6A-6AO illustrate exemplary user interfaces for managing accessories in accordance with some embodiments. FIG. 7 is a flow diagram illustrating a process for configuring accessories to be controlled in different manners in accordance with some embodiments. The user interfaces in FIGS. 6A-6R are used to illustrate the processes described below, including the processes in FIG. 7. FIG. 8 is a flow diagram illustrating a process for configuring accessories to be controlled based on orientation in accordance with some embodiments. The user interfaces in FIGS. 6A-6R are used to illustrate the processes described below, including the processes in FIG. 8. FIG. 9 is a flow diagram illustrating a process for surfacing a control in accordance with some embodiments. The user interfaces in FIGS. 6A-6R are used to illustrate the processes described below, including the processes in FIG. 9. FIG. 10 is a flow diagram illustrating a process for notifying users of a current context in accordance with some embodiments. The user interfaces in FIGS. 6S-6AO are used to illustrate the processes described below, including the processes in FIG. 10. FIG. 11 is a flow diagram illustrating a process for distinguishing types of users in accordance with some embodiments. The user interfaces in FIGS. 6S-6AO are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or increasing security. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

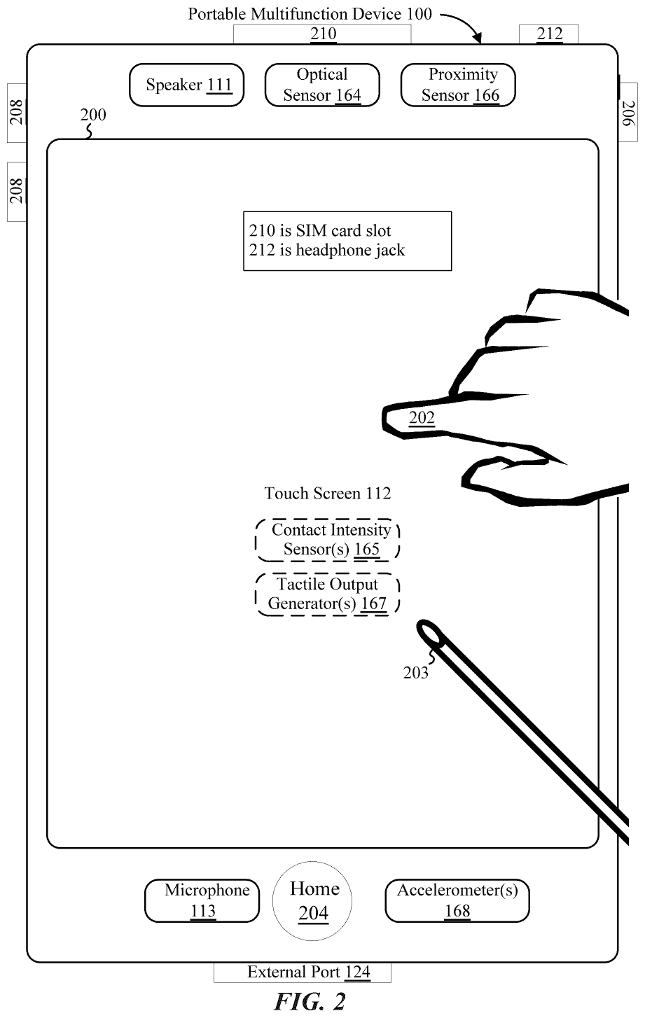

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

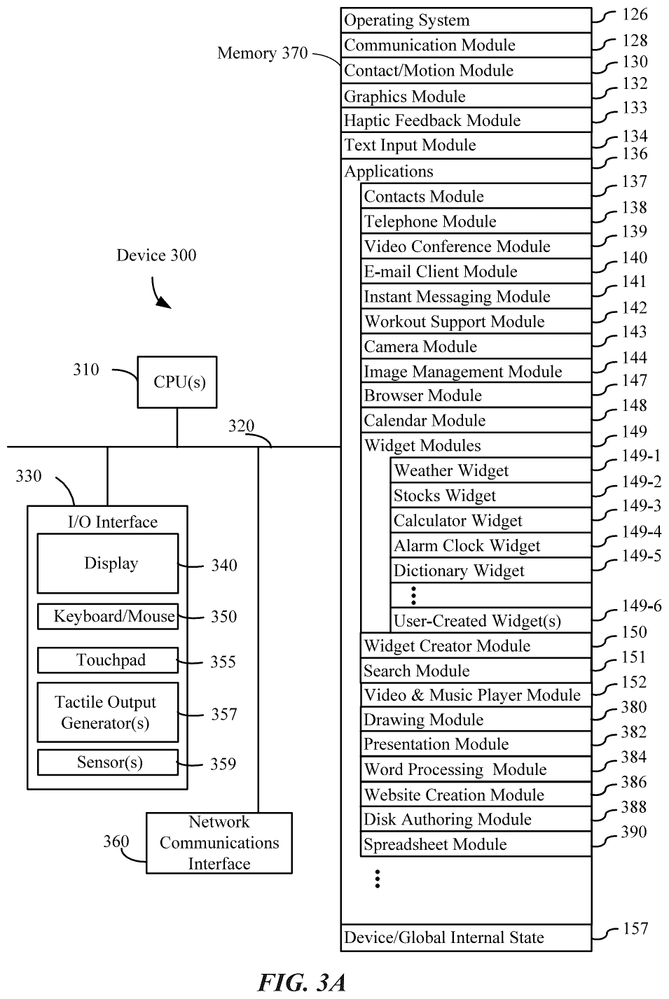

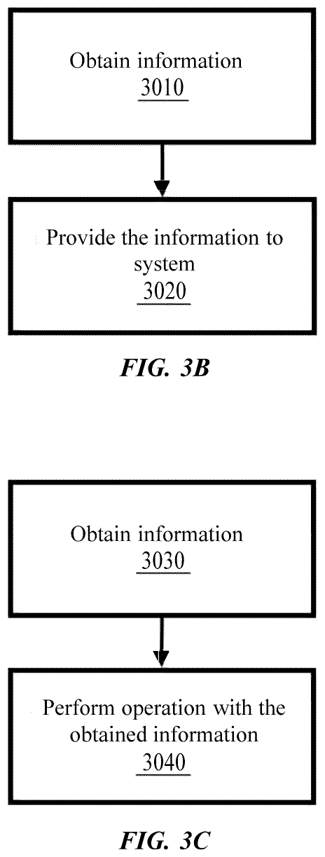

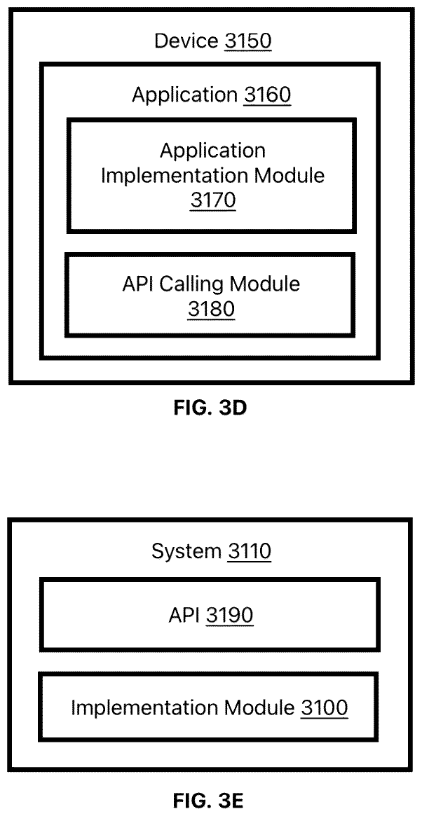

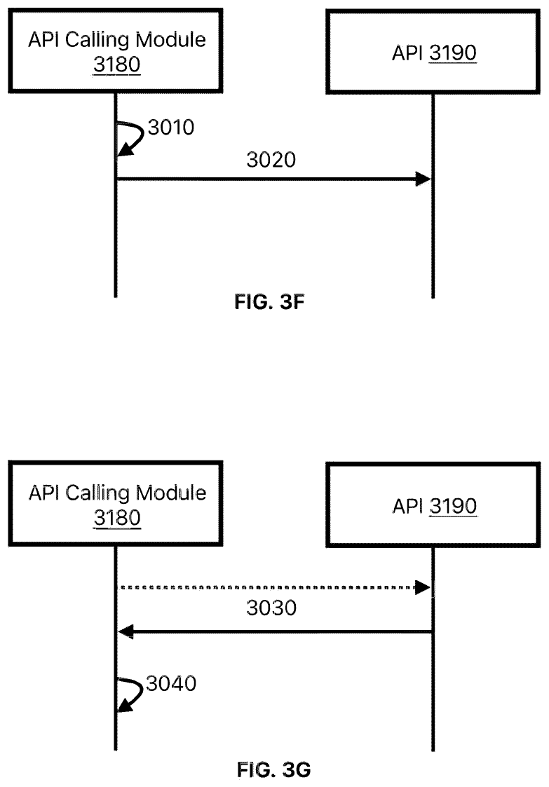

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700, 800, 900, 1000, and 1100 (FIGS. 7, 8, 9, 10, and 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

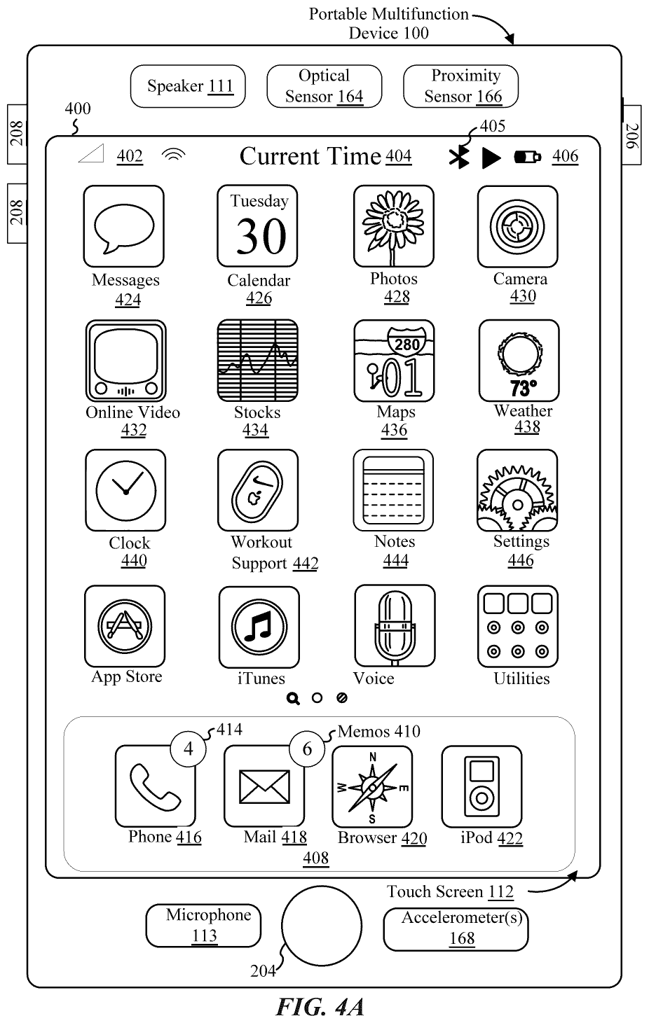

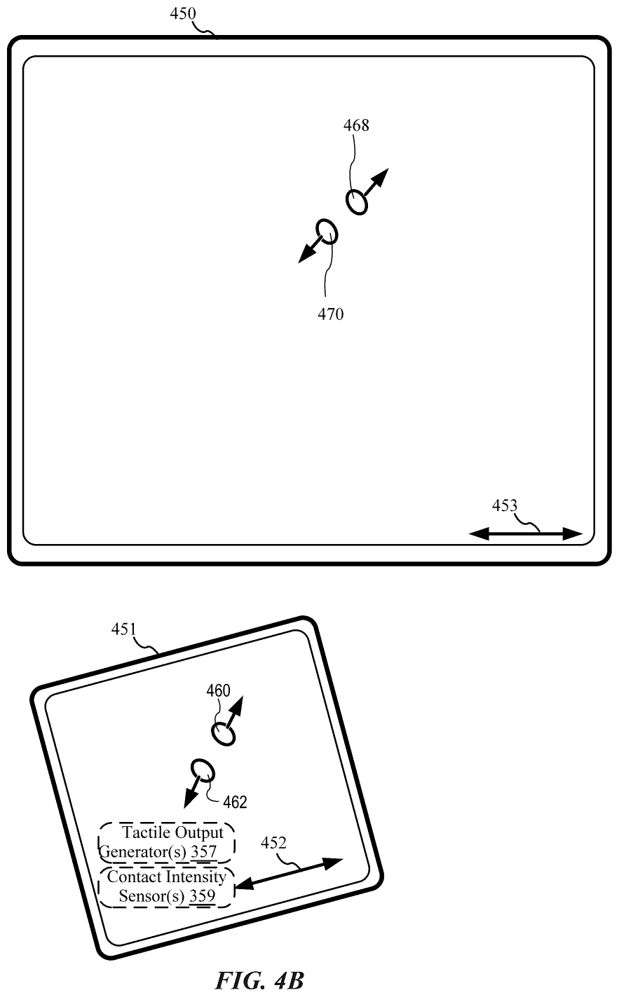

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

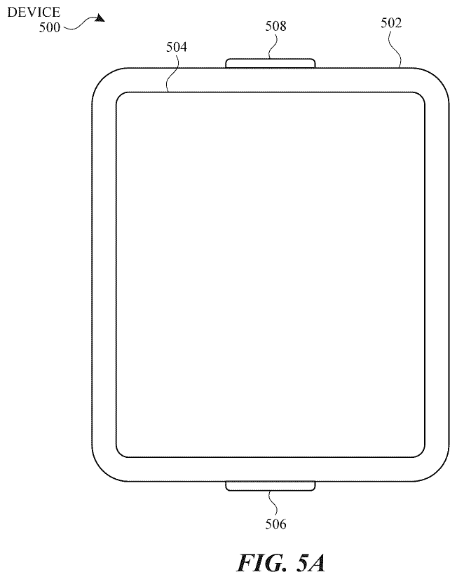

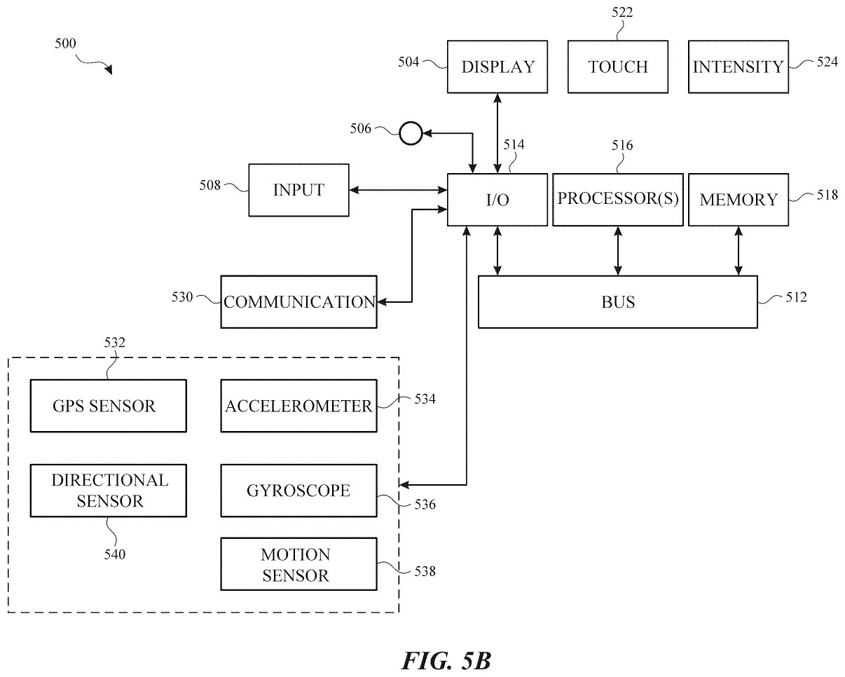

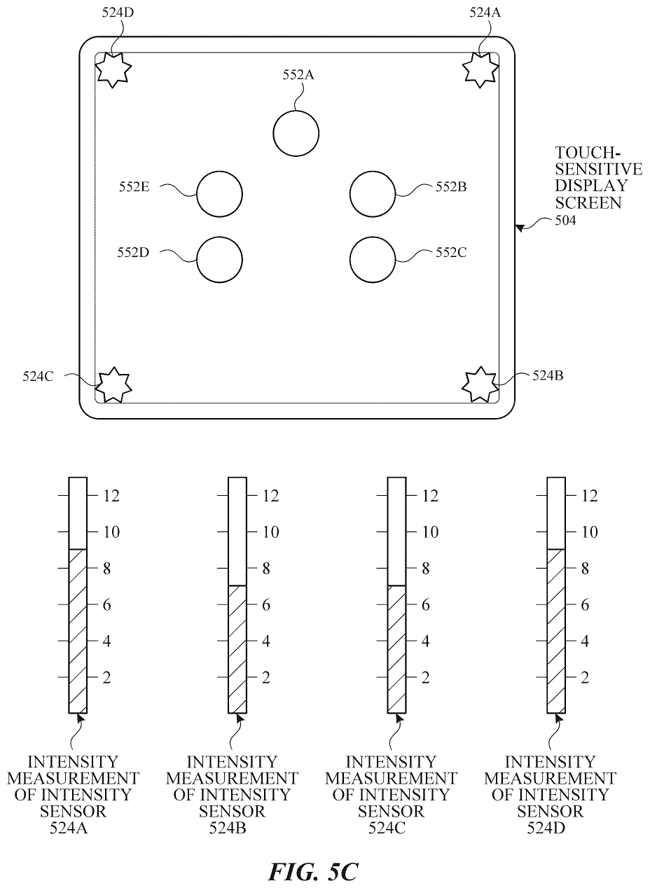

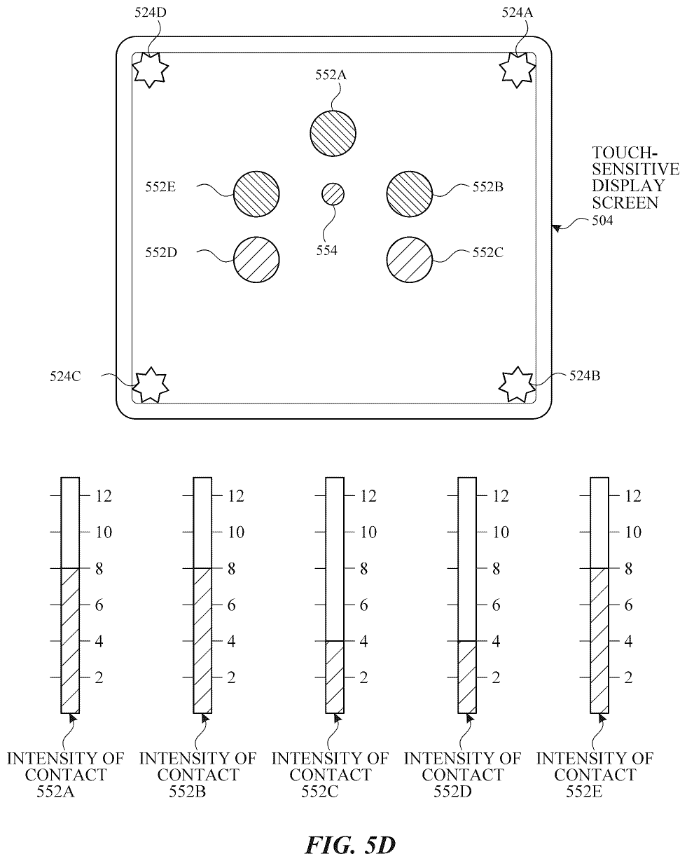

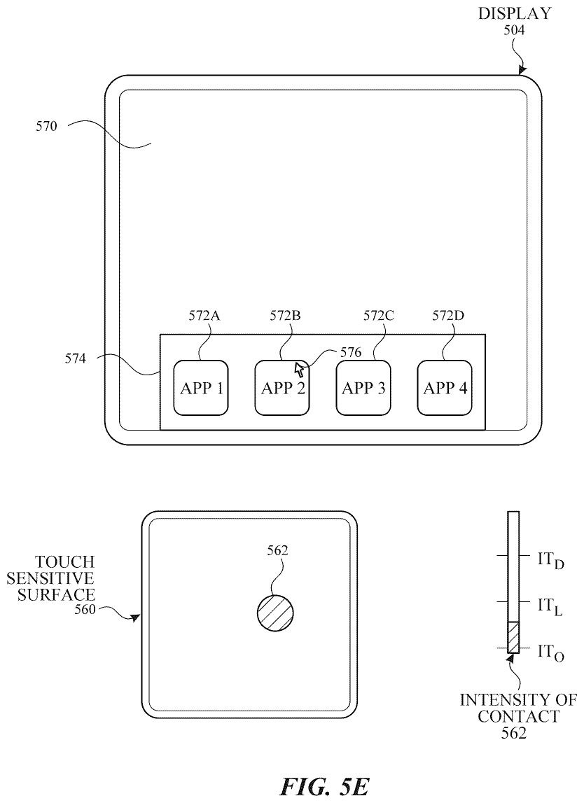

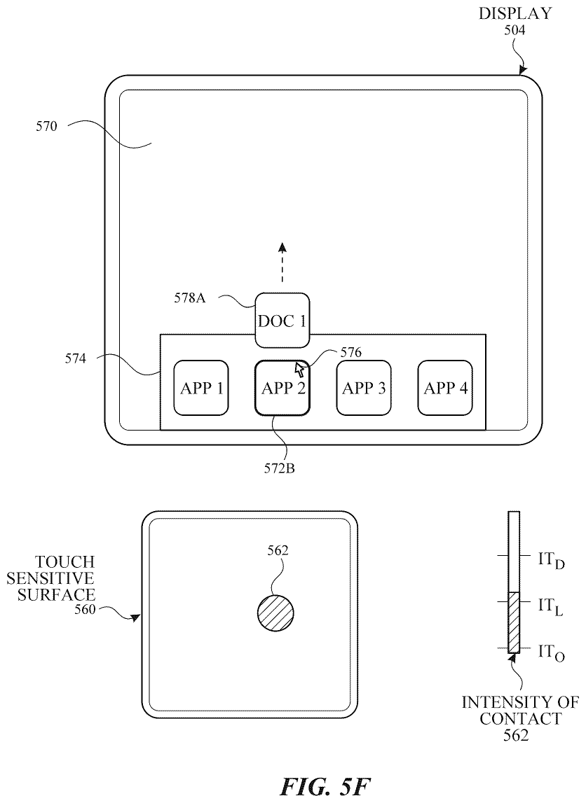

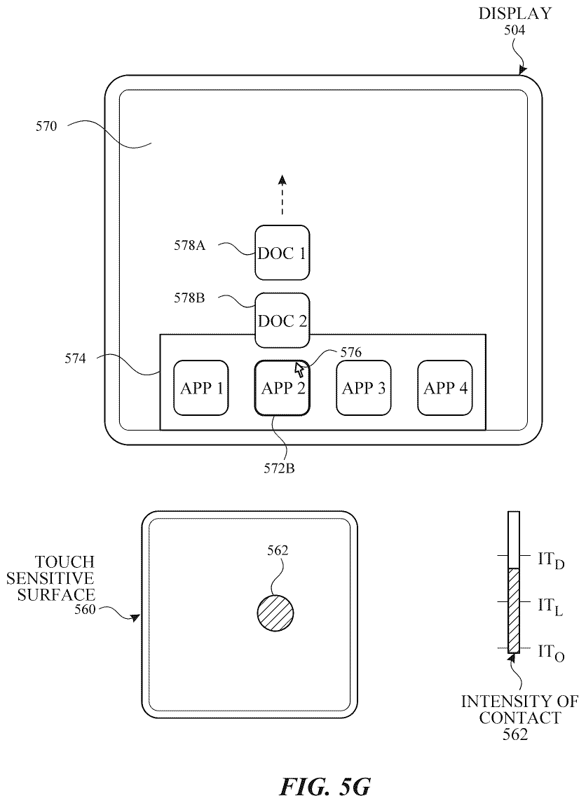

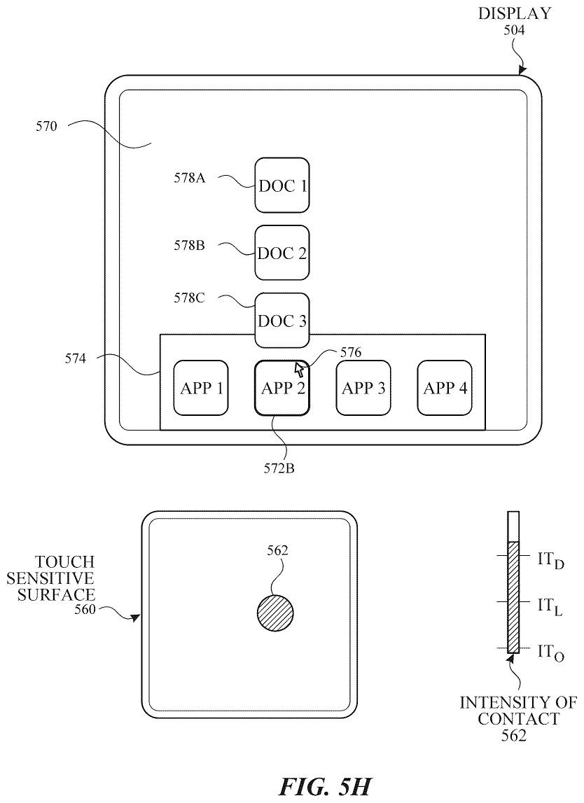

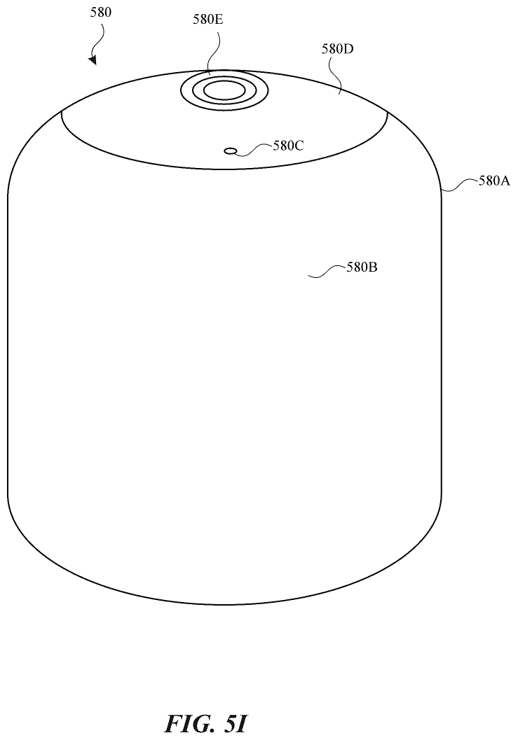

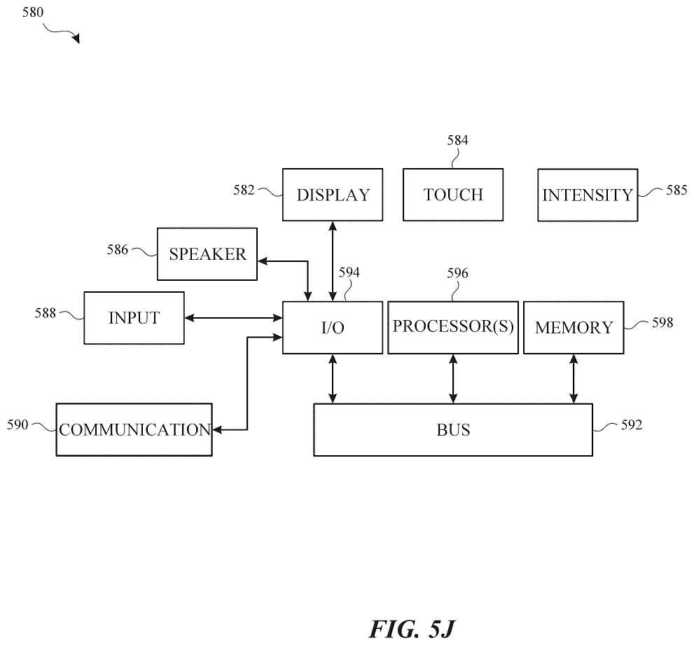

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, 900, 1000, and 1100 (FIGS. 7, 8, 9, 10, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

FIG. 5I illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some examples, the one or more displays are comprised of one or more of another type of light-emitting elements.

FIG. 5J depicts exemplary personal electronic device 580. In some embodiments, device 580 can include some or all of the components described with respect to FIGS. 1A, 1B, 3A-3G, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some examples. Input mechanism 588 is, optionally, a microphone, in some examples. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 700, 800, 900, 1000, and 1100 (FIGS. 7, 8, 9, 10, and 11)). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. 5J, but can include other or additional components in multiple configurations.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6AO illustrate exemplary user interfaces for managing accessories in accordance with some embodiments. The user interfaces in these figures are used to illustrate the processes described below, including the processes in FIG. 7.

The left side FIGS. 6A-6AA illustrate computer system 600 as a smart phone displaying different user interface objects. It should be recognized that computer system 600 can be other types of computer systems such as a smart watch, a tablet, a laptop, a communal device, an accessory, a personal gaming system, a desktop computer, a fitness tracking device, and/or a head-mounted display (HMD) device. In some embodiments, computer system 600 includes and/or is in communication with one or more input devices and/or sensors (e.g., a camera, a LiDAR sensor, a motion sensor, an inertial measurement unit (IMU), an infrared sensor, a microphone, a touch-sensitive surface, and/or a physical input mechanism such as a button, a rotational mechanism, and/or a slider). Such sensors can be used to detect presence of, attention of, statements from, inputs corresponding to, requests from, and/or instructions from a user in an environment. In some embodiments, computer system 600 includes a near frequency communication (NFC) chip, an ultra-wideband (UWB) antenna, and/or a Bluetooth antenna to allow for detection of and/or communication with nearby devices. It should be recognized that, while some embodiments described herein refer to inputs being touch inputs detected via a touch-sensitive surface, other types of inputs can be used with techniques described herein, such as voice inputs that are detected via one or more microphones and/or air gestures detected via a camera that is in communication (e.g., wireless and/or wired communication) with computer system 600.

At FIGS. 6A-6AA computer system 600 is in communication with a smart home control system that monitors a status of and/or coordinates control of smart home accessories (e.g., devices that can be remotely managed through a secondary device via a network connection). Examples of smart home accessories include controllable lights, speakers, displays (e.g., televisions), security cameras, locks, thermostats, fans, appliances, outlets, switches, and/or window coverings. At FIGS. 6A-6AA, computer system 600 is the secondary device managing the smart home accessories. In examples described below, computer system 600 detects user inputs that correspond to requests pertaining to a smart home accessory that is a smart lock on a front door of a building, also referred to as the front door lock within this document. In some embodiments, computer system 600 is communicating directly with the front door lock and not through a smart home control system. In some embodiments, computer system 600 includes a smart home application used in communication with smart home accessories and/or the smart home control system.

The right side of FIGS. 6A-6AO include diagram 610, which is representation of a front of the building which includes door representation 612 and lock status 614. Door representation 612 is a representation of the front door of the building, and the position of door representation 612 (e.g., open or closed) is representative of the position of the front door. Lock status 614 is representative of the status of the front door lock (e.g., locked or unlocked).

At FIG. 6A, the front door lock is added to the smart home control system and/or the smart home application on computer system 600. As illustrated in FIG. 6A, in response to the front door lock being added to the smart home control system, computer system 600 displays key available user interface 602 overlayed on home key user interface 604 to indicate to the first user that a digital key for the front door lock is available in the digital wallet of computer system 600. As illustrated in FIG. 6A, key available user interface 602 includes key available icon 602a and key available control 602b. In some embodiments, home key user interface 604 is a user interface within the smart home control application installed on computer system 600.

In some embodiments, key available user interface 602 is a user interface within the smart home application on computer system 600 in which computer system 600 displays information pertaining to digital keys included in the smart home application. In some embodiments, digital keys are encrypted codes that allow smart devices such as smart phones (e.g., computer system 600), smart watches, and/or smart fobs to access and/or control smart locks. At FIG. 6A, the digital key corresponding to key available user interface 602 corresponds to the front door lock of the door represented by door representation 612 in diagram 610. As illustrated in diagram 610 within FIG. 6A, door representation 612 is in the closed position indicating that the door is closed, and lock status 614 is in the locked position indicating that the door lock is locked. As illustrated in FIG. 6A, computer system 600 includes physical input mechanism 606. At FIG. 6A, computer system 600 detects selection input 605a as a tap at a location corresponding to key available control 602b.

As illustrated in FIG. 6B, in response to detecting selection input 605a, computer system 600 displays express mode user interface 616 overlayed on home key user interface 604 and ceases display of key available user interface 602. As illustrated in FIG. 6B, express mode user interface 616 includes turn on express control 616a and express not now control 616b. Express mode user interface 616 also includes text to inform to the first user the setting corresponding to express mode user interface 616 in more detail (e.g., unlock this door automatically as you approach the door or tap lock with your phone). In some embodiments at FIG. 6B, computer system 600 detects selection input 605b1 as a tap at a location corresponding to turn on express control 616a, causing computer system 600 to react as discussed below with respect to FIG. 6C. In some embodiments at FIG. 6B, computer system 600 detects selection input 605b2 as a tap at a location correspond to express not now control 616b, causing computer system 600 to react as discussed below with respect to FIG. 6N.

In FIGS. 6C-6M, computer system 600 displays different user interfaces initiated by computer system 600 detecting selection input 605b1. FIGS. 6C-6M illustrate the process of setting up express mode and using express mode to unlock the front door lock. This process includes the first user selecting one or more directions of approach and, when the first user with computer system 600 is detected approaching the front door lock from the selected directions, computer system 600 transfers a request to unlock the front door lock. In some embodiments, the direction of approach of the first user with computer system 600 is detected via sensors such as GPS antenna, an IMU sensor, a UWB antenna, and or cameras connected to and/or in communication with computer system 600, the front door lock, and/or the smart home control system.

As illustrated in FIG. 6C, in response to detecting selection input 605b1, computer system 600 displays approach direction user interface 618 overlayed on home key user interface 604 and ceases display of key express mode user interface 616. As illustrated in FIG. 6C, approach direction user interface 618 includes left approach icon 618a, center approach icon 618b, right approach icon 618c, left approach control 618d, center approach control 618e, right approach control 618f, direction instructions 618g, and approach done control 618h. As illustrated in FIG. 6C, left approach icon 618a includes a visual representation of a person walking from the left to the right and right approach icon 618c includes a visual representation of a person walking from the right to the left. As illustrated in FIG. 6C, center approach icon 618b includes a visual representation of a person standing in front of a door.

In some embodiments, computer system 600 does not display left approach icon 618a, center approach icon 618b, and/or right approach icon 618c. In some embodiments, computer system 600 displays different icons to left approach icon 618a, center approach icon 618b, and/or right approach icon 618c. For example, computer system 600 displays a right pointing arrow instead of left approach icon 618a and a left pointing arrow instead of right approach icon 618c.

At FIG. 6C, left approach icon 618a and left approach control 618d correspond to the left side of the front door as represented by left 610a within diagram 610. At FIG. 6C, center approach icon 618b and center approach control 618e correspond to in front of the front door as represented by center 610b within diagram 610. At FIG. 6C, right approach icon 618c and right approach control 618f correspond to the right side of the front door as represented by right 610c within diagram 610.

As illustrated in FIG. 6C, computer system 600 displays left approach control 618d, center approach control 618e, and right approach control 618f as circles with labels indicating the corresponding direction (e.g., left, center, and right). As illustrated in FIG. 6C, left approach control 618d, center approach control 618e, and right approach control include checkmarks within the circles, indicating that each is in the on position. Also illustrated in FIG. 6C, computer system 600 displays center approach control 618e as greyed out to indicate that center approach control 618e cannot be interacted with and therefore cannot be turned off, because as long as computer system 600 and the front door lock are configured to user approach to unlock, the first user (e.g., computer system 600) being detected approaching the lock from the center will cause computer system 600 to transfer the request to unlock the front door lock.

As illustrated in FIG. 6C, direction instructions 618g includes text to inform the first user to the purpose of approach direction user interface 618 (e.g., expand or contract the angle of approach to this lock). At FIG. 6C, in response to computer system 600 displaying left approach control 618d and right approach control 618f in the on position (e.g., as illustrated in FIG. 6C), computer system 600 is configured to transfer the request to unlock the front door lock when the first user is detected approaching the front door lock from the left side (e.g., left 610a) and/or the right side (e.g., right 610c) of the front door lock.

In some embodiments, computer system 600 displays left approach control 618d, center approach control 618e, and right approach control 618f differently. For example, computer system 600 displays left approach control 618d, center approach control 618e, and right approach control 618f as toggles. In some embodiments, computer system 600 does not display center approach control 618e since it is not selectable. At FIG. 6C, computer system 600 detects selection input 605c as a tap at a location corresponding to left approach control 618d.

As illustrated in FIG. 6D, in response to detecting selection input 605c, computer system 600 displays left approach control 618d without a check mark to indicate that left approach control 618d is in the off position. Computer system 600 displaying left approach control 618d in the off position indicates that computer system 600 is not configured to transfer the request to unlock the front door lock when the first user (e.g., computer system 600) is detected approaching the front door lock from the left side. At FIG. 6D, computer system 600 not being configured to transfer the request to unlock the front door lock when the first user is detected approaching the front door lock from the left side is indicated by left 610a being illustrated as greyed out in diagram 610. At FIG. 6D, in response to detecting selection input 605c, computer system 600 ceases displaying left approach icon 618a as a second indication that computer system 600 is not configured to transfer the request to unlock the front door lock when the first user is detected approaching the front door lock from the left side. In some embodiments, computer system 600 continues to display left approach icon 618a after detecting selection input 605c. At FIG. 6D, computer system 600 detects selection input 605d as a tap at a location corresponding to approach done control 618h.

In some embodiments, computer system 600 detects a selection input as a tap at a location corresponding to right approach control 618f, and, in response, computer system 600 displays right approach control 618f without a check mark to indicate that right approach control 610e is in the off position. In such embodiments, in response to computer system 600 displaying right approach control 618f in the off position, computer system 600 is configured to not transfer the request to unlock the front door lock when the first user (e.g., computer system 600) is detected approaching the front door lock from the right side. In some embodiments, computer system 600 displays left approach control 618d and right approach control 618f in the off position (e.g., without a checkmark). In such embodiments, computer system 600 transfers the request to unlock the front door lock when the first user is detected approaching the front door lock from the center and computer system 600 does not transfer the request to unlock the front door lock when the first user is detected approaching the front door from the left or right.

As illustrated in FIG. 6E, in response to detecting selection input 605d, computer system 600 displays create code user interface 620 overlayed on home key user interface 604 and ceases display of approach direction user interface 618. In some embodiments, in response to detecting selection input 605b2 on not now control 616b, computer system 600 displays create code user interface 620 overlayed on home key user interface 604 and ceases display of express mode user interface 616. Stated differently, in some embodiments, computer system 600 displays create code user interface 620 when a user does not turn on express mode. In some embodiments, computer system 600 displays create code user interface 620 when a lock (e.g., the front door lock) supports access codes. In such embodiments, computer system 600 would not display create code user interface 620 when a lock (e.g., the front door lock) does not support access codes and instead proceed to FIG. 6G. As illustrated in FIG. 6E, create code user interface 620 includes create code control 620a, create code not now control 620b, and text asking the first user if they want to create a personal access code. At FIG. 6E, computer system 600 detects selection input 605e as a tap at a location corresponding to create code control 620a.

As illustrated in FIG. 6F, in response to detecting selection input 605e, computer system 600 displays enter code user interface 622 overlayed on home key user interface 604 and ceases displaying create code user interface 620. Enter code user interface 622 includes numbers zero through nine and/or one or more symbols for the first user to select from to create a personal access code for the front door lock. Enter code user interface 622 also includes enter code done control 622a. In some embodiments, computer system 600 detects of one or more selection inputs as taps at locations corresponding to one or more numbers and/or symbols creating an access code. At FIG. 6F, computer system 600 detects selection input 605f as a tap at a location corresponding to enter code done control 622a.

As illustrated in FIG. 6G, in response to detecting selection input 605f, computer system 600 displays unlock type user interface 624. As illustrated in FIG. 6G, unlock type user interface 624 includes home key icon 624a, home key name 624b, home app control 624c, and add code control 624d. Also illustrated in FIG. 6G, unlock type user interface 624 includes approach unlock indicator 624e, approach unlock control 624f, tap unlock indicator 624g, and tap unlock control 624h. As illustrated in FIG. 6G, computer system 600 displays approach unlock control 624f and tap unlock control 624h as toggles in the on position, indicating that computer system 600 is configured to use each method to unlock the front door lock. In some embodiments, computer system 600 displays approach unlock control 624f and tap unlock control 642h as something other than toggles, such as circles with check marks. At FIG. 6G, approach unlock indicator 624e and approach unlock control 624f corresponds to the unlock on approach setting while tap unlock indicator 624g and tap unlock control corresponds to the tap to unlock without authentication setting that will be discussed in more detail in FIG. 6R. At FIG. 6G, computer system 600 detects selection input 605g as a press on physical input mechanism 606.

FIGS. 6H-6L describe scenarios where the first user approaches the front door lock with computer system 600 from different directions and depending on the detected direction of approach and/or detected position or the first user relative to the front door lock, the front door lock unlocks or remains locked. In these scenarios, the one or more directions of approach and/or position of the first user relative to the front door lock that will cause the front door lock to unlock or remain locked are chosen by the user. In FIGS. 6H-6L, the first user is in possession of computer system 600, and it is the position of computer system 600 that is being detected and/or the position's change in time (e.g., direction) that is being detected. In some embodiments, the first user is in possession of a different computer system such as a smart watch that is acting as a proxy to computer system 600 and/or is in communication with computer system 600, and it is the position of this computer system that is being detected.

Although the below description of FIGS. 6H-6I describe direction of approach as towards the front door lock, it should be understood that a user may move away from the front door lock (e.g., before unlocking the lock). In some embodiments where the user is detected as moving in a direction away from the lock (e.g., before unlocking the lock), computer system 600 does not send instructions to the front door lock to unlock even though the user is within an area to unlock the first door lock.

As illustrated in FIG. 6H, in response to detecting selection input 605g, computer system 600 displays lock screen 626. At FIG. 6H, the first user approaches the front door from the left while the front door lock is locked. At FIG. 6H, the first user is represented within diagram 610 by first user representation 628 and the location of first user representation 628 relative to door representation 612 within diagram 610 is representative of the location of the first user within the environment relative to the front door and the front door lock. The first user approaching the front door from the left is represented in diagram 610 by first user representation 628 being illustrated within left 610a with left user path 628a to indicate the direction of travel of the first user. Since the first user is in possession of computer system 600, the position of first user representation 628 relative to door representation 612 within diagram 610 is also representative of the location of computer system 600 within the environment relative to the front door and the front door lock.

At FIG. 6H, the first user (e.g., computer system 600) is detected approaching the front door lock from the left via one of the methods described above. At FIG. 6H, in response to the first user being detected approaching the front door lock from the left, computer system 600 does not transfer the request for the front door lock to be unlocked, resulting in the front door remaining locked, as indicated by lock status 614 being illustrated as a locked lock. In some embodiments, the first user continues moving forward along the path indicated by left user path 628a until the first user is detected approaching the front door lock from the center in (e.g., center 610b within diagram 610). In such embodiments, in response to the first user being detected approaching the front door lock from the center, computer system 600 transfers the request for the front door lock to be unlocked, resulting in the front door lock unlocking. In some embodiments, when the first user is detected at a distance that is considered to be too far away from the front door lock (e.g., 15 feet and/or 300 feet away), computer system 600 does not transfer the request to unlock the front door lock. In some embodiments, the distance is considered too far away from the front door lock to transfer the request to unlock based on limitations of the hardware of the lock and/or computer system 600 (e.g., beyond Bluetooth range, Wi-Fi range, and/or near-field-communication range). In some embodiments, the distance detected for approach is user configurable (e.g., a user can set the distance for detection of approach at 3 feet or 20 feet away). In some embodiments, the first user is close enough but too far to the left to be detected approaching from the center.

In some embodiments, computer system 600 detects a second input as a tap at a location corresponding to left approach control 618d, resulting in computer system 600 redisplaying left approach icon 618a and displaying left approach control 618d with a check mark to indicate that left approach control 618d is in the on position. In such embodiments, computer system 600 displaying left approach control 618d in the on position indicates that computer system 600 is reconfigured to transfer the request to unlock the front door lock when the first user (e.g., computer system 600) is detected approaching the front door lock from the left side. For example, the first user at FIG. 6H changes how computer system 600 is configured so that computer system 600 does transfer the request to unlock the front door lock while the first user is detected to the left of the front door lock.

At FIG. 6I, at a time after the first user is detected approaching the front door lock from the left, the first user approaches the front door lock from the right with computer system 600 while the front door lock is locked and computer system 600 is in a locked state. The position of the first user is indicated within diagram 610 by first user representation 628 being illustrated within right 610c and right user path 628b indicates the direction of travel of the first user. At FIG. 6I, the first user (e.g., computer system 600) is detected approaching the front door lock from the right. At FIG. 6I, in response to the first user being detected approaching the front door lock from the right, computer system 600 transfers the request for the front door lock to be unlocked, resulting in the front door lock being unlocked, as indicated by the lock status 614 being illustrated as an unlocked lock.

At FIG. 6I, computer system 600 receives the information that the front door lock is unlocked. As illustrated in FIG. 6I, in response to receiving information that the front door lock is unlocked, computer system 600 displays notification 630 overlaying a portion of the top of lock screen 626. As illustrated in FIG. 6I, notification 630 includes notification key icon 630a and notification lock icon 630b. As illustrated in FIG. 6I, in response to receiving information that the front door lock is unlocked, computer system 600 displays notification lock icon 630b with a representation of an unlocked lock. As illustrated in FIG. 6I, computer system 600 displays notification key icon 630a as version of home key icon 624a that is small enough to fit within notification 630. In some embodiments, computer system 600 displays that the front door lock is unlocked only when the front door lock is unlocked based on the detected approach of the user (e.g., automatically).

At FIG. 6I, computer system 600 detects selection input 605i2 as a long press at a location corresponding to notification lock icon 630b. In some embodiments, computer system 600 does not detect selection input 605i2. In such embodiments, if computer system 600 does not detect a selection input at a location corresponding to any part of notification 630 within a predetermined amount of time (e.g., 0.5-2 seconds) of computer system 600 displaying notification 630, computer system 600 ceases display of notification 630. In some embodiments, at FIG. 6I, computer system 600 detects selection input 605i2 as a tap at a location corresponding to notification lock icon 630b. In such embodiments, in response to detecting selection input 605i2, computer system 600 transfers a request for the front door lock to be locked, resulting in the front door lock locking. This allows the first user to relock the front door lock if the first user determines that they do not want the front door lock unlocked yet, such as the first user decides to wait outside for a delivery driver after being detected approaching the front door from the right. In some embodiments, computer system 600 detects selection input 605i1 as a tap at a location corresponding to notification key icon 630a, and in response computer system 600 opens the home key user interface 604.

As illustrated in FIG. 6J, in response to detecting selection input 605i2 as a long press, computer system 600 displays large notification 632 overlaying a portion of the top of lock screen 626. As illustrated in FIG. 6J, large notification 632 overlays a larger portion of lock screen 626 than notification 630 does in FIG. 6G. As illustrated in FIG. 6J, large notification 632 includes large notification key icon 632a, notification door status indicator 632b, and large notification lock icon 632c. As illustrated in FIG. 6J, in response to receiving information that the front door lock is unlocked, notification door status indicator 632b includes text to inform the first user that the front door lock is unlocked. As illustrated in FIG. 6J, large notification key icon 632a is a larger version of notification key icon 630a and large notification lock icon 632c is a larger version of notification lock icon 630b. In some embodiments, computer system 600 displays large notification 632 by increasing the size of notification 630. At FIG. 6J, the first user walks through the door, as indicated by first user representation 628 being illustrated on the other side of door representation 612 within diagram 610. At FIG. 6J, computer system 600 detects selection input 605j as a tap at a location corresponding to large notification lock indicator 632c.

At FIG. 6K, in response to detecting selection input 605j, computer system 600 transfers the request to lock the front door. As illustrated in FIG. 6K, in response to detecting selection input 605h, computer system 600 displays notification door status indicator 632b with text to inform the first user that the front door lock is in the process of locking and computer system 600 displays large notification lock icon 632c with a spinning animation to indicate that the front door is in the process of locking. In some embodiments, computer system 600 does not display large notification lock icon 632d with a spinning animation and instead computer system 600 displays large notification lock icon 636c with a different visual representation and/or animation in response to detecting selection input 605j. In some embodiments, in response to detecting selection input 605j, computer system 600 changes configuration to no longer allow the front door lock to unlock when the first user (e.g., computer system 600) is detected approaching the front door lock from the right side. In some embodiments, in response to the first user relocking the front door lock a threshold amount of times when the first user is approaching from a certain direction, computer system 600 determines that the first user no longer wants the front door lock to be automatically unlocked for that direction and instead reconfigures the front door lock to no longer automatically unlock when the first user is approaching from the certain direction. This automatic change when manually locking the lock after automatically unlocking the front door lock enables the computer system to prevent additional approaches and/or erroneous approaches from unlocking the front door lock.

At FIG. 6L, the front door lock is locked, as indicated by lock status 614 being illustrated as a locked lock. At FIG. 6L, computer system 600 receives the information that the front door lock is locked. As illustrated in FIG. 6J in response to receiving information that the front door is locked, computer system 600 displays large notification lock icon 632c with an icon of locked lock and computer system 600 displays notification door status indicator 632b with text to inform the first user that the front door is locked.

In some embodiments, the first user has not walked through the door and is still in front of the front door lock. In such embodiments, computer system 600 will respond to selection input 605j as described in FIGS. 6J-6L. This allows the first user to relock the front door lock if the first user determines that they do not want the front door lock unlocked yet, such as the first user remembers an appointment and has to leave the property again.

In some embodiments, computer system 600 receives information that the front door has locked automatically. For example, the front door lock locks automatically in response to the front door opening and closing as illustrated in FIGS. 6I-6K and/or in response to being the front door lock being unlocked and the front door not being opened after a predetermined period of time. In such embodiments, in response to receiving the information that the front door lock has automatically locked, computer system 600 displays an indication similar to notification 630 and/or large notification 632 to inform the first user that the front door lock is locked. In some such embodiments, computer system 600 includes a user interface element similar to notification lock icon 630b and/or large notification lock icon 632c within the notification. For example, computer system 600 displays an icon of an unlocked lock that when computer system 600 detects a selection input as a tap at a location corresponding to that icon, computer system 600 transfers the request to unlock the front door lock. In some such embodiments, computer system 600 does not include a user interface element similar to notification lock icon 630b and/or large notification lock icon 632c within the notification.

FIG. 6M illustrates the tap to unlock without authentication process as part of the express mode. Tap to unlock with or without authentication includes bringing computer system 600 in close contact with the front door lock and the proximity of computer system 600 to the front door lock being detected. In some embodiments, the proximity of computer system 600 to the front door lock is detected via a communication channel such as Bluetooth, UWB, and/or NFC). The process for tap to unluck with authentication is discussed in more detail below with respect to FIG. 6O. While the process described with respect to FIG. 6M uses computer system 600, it should be noted that the same process can be accomplished using a different computer system such as a smart watch that is acting a s proxy to computer system 600 and/or is in communication with computer system 600.

As illustrated in FIG. 6M, computer system 600 displays unlock type user interface 624 with approach unlock control 624f in the off position and tap unlock control 624h in the on position, indicating that computer system 600 is configured to use the tap unlock method but not the approach unlock method to unlock the front door lock. In some embodiments, computer system 600 displays approach unlock control 624f in the off position as a result of computer system 600 detecting a selection input as a tap at a location corresponding to approach unlock control 624f. For example, on days when the first user needs to spend time near the front door, such as a block party, the first user turns approach unlock control 624f to turn off the unlock on approach configuration to prevent the front door lock from unlocking unnecessarily. In such embodiments, in response to detecting a second selection input as a tap at a location corresponding to approach unlock control 624f, computer system 600 displays approach unlock control 624f in the on position. In some embodiments, computer system 600 displays approach unlock control 624f in the off position in response to the front door lock not supporting the approach unlock configuration. For example, the front door lock is a model of smart lock that does not support the ability to unlock when the first user is detected approaching.

At FIG. 6M, the first user is in possession of computer system 600 and is in close proximity to the front door and thereby the front door lock, as indicated by the position of first user representation 628 in relation to door representation 612 within diagram 610. At FIG. 6M, the front door lock is locked, as indicated by lock status 614 being illustrated as a locked lock. At FIG. 6M, the first user brings computer system 600 in close contact with (e.g., taps against) the front door lock. At FIG. 6M, computer system 600 being in close contact with the front door lock is detected.

At FIG. 6M, in response computer system 600 being detected in close contact with the front door lock, computer system 600 transfers the request to unlock the front door lock, resulting in the front door lock being unlocked, as indicated by lock status 614 being illustrated as an unlocked lock. In some embodiments, computer system 600 uses the tap to unlock without authentication process while configured to use unlock on approach to unlock the front door lock. For example, if the first user is not detected approaching from a direction configured to unlock the front door lock, the first user can bring computer system 600 in close proximity to the front door lock and complete the process described in FIG. 6M.

FIGS. 6N-6R describe scenarios where unlocking the front door requires the first user to identify themselves through such methods as facial recognition, a password, and/or a personal access code. In FIGS. 6N-6R, computer system 600 displays different user interfaces in response to computer system 600 detecting selection input 605b2 at FIG. 6B followed by computer system 600 responding as described in FIGS. 6E-6F.

As illustrated FIG. 6N, in response to detecting selection input 605f at FIG. 6F after detecting selection input 605b2 at FIG. 6B, computer system 600 displays unlock type user interface 624 and ceases displaying home key user interface 604 and enter code user interface 622. As illustrated in FIG. 6N, in response to detecting selection input 605f after detecting selection input 605b2, computer system 600 displays unlock type user interface 624 with approach unlock control 624f and tap unlock control 624h in the off position, indicating that computer system 600 is not configured to use either method of unlocking the front door lock. At FIG. 6N, computer system 600 detects selection input 605n as a single press on physical input mechanism 606.

As illustrated in FIG. 6O, in response to detecting selection input 605n, computer system 600 displays lock screen 626. At FIG. 6O, the first user is in possession of computer system 600 and is in close proximity to the front door and thereby the front door lock, as indicated by the position of first user representation 628 in relation to door representation 612 within diagram 610. At FIG. 6O, the front door lock is locked, as indicated by lock status 614 being illustrated as a locked lock. At FIG. 6O, the first user brings computer system 600 in close contact with (e.g., taps against) the front door lock. At FIG. 6O, computer system 600 being in close contact with the front door lock is detected.

As illustrated in FIG. 6P, in response to computer system 600 being detected in close contact with the front door lock, computer system 600 displays facial recognition icon 634 to inform the first user that computer system 600 is starting a facial recognition scan using one or more cameras in communication with computer system 600. As illustrated in in FIG. 6P, computer system 600 displays facial recognition icon 634 overlaying a portion of the top of lock screen 626. At FIG. 6P, computer system 600 scans the face of the first user and confirms the first user's identification via the facial scan. In some embodiments, while scanning the first user's face, computer system 600 replaces facial recognition icon 634 with an icon to indicate to the first user that a facial recognition scan is in progress. It should be recognized that facial recognition is just one example of a technique for authenticating a user and that other techniques can be used herein. For example, a user can enter a password and/or a code used to unlock computer system 600 to authenticate the user.

As illustrated in FIG. 6Q, in response to computer system 600 confirming the first user's identification via the facial scan, computer system 600 replaces facial recognition icon 634 with recognition complete icon 636. At FIG. 6Q, in response to computer system 600 confirming the user's identification, computer system 600 transfers the request to unlock the front door lock, resulting in the front door lock being unlocked, as indicated by lock status 614 being illustrated as an unlocked lock.

It should be recognized that, in FIG. 6Q, computer system 600 does not display a user interface element similar to notification lock icon 630b and/or large notification lock icon 632c in response to unlocking the lock (e.g., as described above with respect to FIGS. 6I-6L). In some embodiments, computer system 600 does not display the user interface element indicating the lock is unlocked because the user authenticated in FIG. 6P. Therefore, the user is already aware of the action being completed by computer system 600, making the notification unnecessary.

FIG. 6R, describes a scenario where computer system 600 is not configured to use facial recognition to identify the first user. As illustrated in FIG. 6R, in response to computer system 600 being detected in close proximity to the front door lock, computer system 600 displays PIN code user interface 638 which includes numbers zero through nine and/or one or more symbols for the user to select to enter their personal access code for the front door lock. PIN code user interface 638 also includes PIN continue control 638a. In some embodiments, in response to detecting a selection input as a tap on a location corresponding to PIN continue control 638a, computer system 600 transfers to the personal access code to the front door lock. In some embodiments, in response to detecting a selection input as a tap on a location corresponding to PIN continue control 638a, computer system 600 compares the entered code to the personal access code created at FIG. 6F, and if the codes match, computer system 600 transfers the request to unlock the front door lock. In some embodiments, computer system 600 displays PIN code user interface 638 in response to computer system 600 not being about to identify the first user via facial recognition scan in FIG. 6P.

In the tap to unlock without authentication method, the tap to unlock with authentication method, and the unlock with personal access code method, computer system 600 receives the information that the front door is unlocked. When using tap to unlock without authentication, tap to unlock with authentication, and unlock with personal access code, computer system 600 does not display notification 630 in response to receiving information that the front door is unlocked. Please note that this is a different reaction to when computer system 600 is using the unlock on approach method. In some embodiments, computer system 600 does not display notification 630 and/or large notification lock icon 632c in response to receiving information that the front door is unlocked when the first user is detected approaching from the center. In some embodiments, computer system 600 has access to multiple smart locks. In some such embodiments, the settings for different smart locks are configured differently. For example, computer system 600 is configured to open the front door lock using tap to unlock without authentication and computer system 600 is configured to open the back door lock using a personal access code.

FIGS. 6S-6AA describe the process where the first user invites a second user to have access to one or more accessories within the smart home control system as a guest (e.g., configured to have limited access as a guest). In some embodiments, the first user sending the invitation is registered as a resident of the home (e.g., smart home control system). In some embodiments, the first user sending the invitation is registered as the owner of the home. In some embodiments, the first user sending the invitation is registered as guest who is configured to have permission to send invitations to other users.

As illustrated in FIG. 6S, computer system 600 displays my home user interface 640, which is the home screen for the smart home system control application and includes controls for smart home accessories and/or controls for navigating to user interfaces within the smart home system control application. As illustrated in FIG. 6S, one of the controls computer system 600 displays in the upper right corner within my home user interface 640 is add control 640a. As illustrated in FIG. 6S, my home user interface 640 includes controls for accessories such as lights, speakers, the front door lock, and the back door lock. In some embodiments, computer system 600 displays my home user interface 640 as including more or less controls and/or different controls than are illustrated in FIG. 6S. For example, computer system 600 can display my home user interface 640 as including a garage door control, a thermostat control, a fan control, and/or a security camera feed. At FIG. 6S, computer system 600 detects selection input 605s as a tap at a location corresponding to add control 640a.

As illustrated in FIG. 6T, in response to detecting selection input 605s, computer system 600 displays add user interface 642 overlayed on top of my home user interface 640. As illustrated in FIG. 6T, add user interface 642 includes controls for adding functions to the smart home control system such as adding accessories, scenes, automations, rooms, homes and/or users. As illustrated in FIG. 6T, computer system 600 displays add people control 642a which corresponds to adding users within add user interface 642. As illustrated in FIG. 6T, computer system 600 displays the controls included in add user interface 642 with labels and icons to identify which function the control corresponds to (e.g., accessories, scenes, automations, rooms, homes, and/or users). In some embodiments, computer system 600 displays the controls within add user interface 642 without icons. At FIG. 6T, computer system 600 detects selection input 605t as a tap at a location corresponding to add people control 642a.

As illustrated in FIG. 6U, in response to detecting selection input 605t, computer system 600 displays invitation type user interface 644 and ceases display of my home user interface 640 and add user interface 642. As illustrated in FIG. 6U, invitation type user interface 644 includes resident control 644a, guest control 644b, and PIN access control 644c. Resident control 644a includes the text “resident” and text to inform the first user that a user invited as a resident has access to accessories all of the time. Guest control 644b includes the text “guest” and text to inform the first user that a user invited as a guest has access to specific accessories and/or at set times. PIN access control 644c includes the text “PIN code access” and, when selected, opens a user interface that allows the first user to set personal access codes for specific users.

At FIG. 6U, computer system 600 detects selection input 605u as a tap at a location corresponding to guest control 644b. In some embodiments, computer system 600 detects a selection input as a tap at a location corresponding to resident control 644a, resulting in a process where computer system 600 sends a communication to a third computer (e.g., computer system 690) inviting a third user to have access to the smart home control system as a resident (e.g., configured to have the full access as a resident). This process will be discussed in more detail below with respect to FIGS. 6AM-6AO.

As illustrated in FIG. 6V, in response to detecting selection input 605u, computer system 600 displays people user interface 646. As illustrated in FIG. 6V, people user interface 646 includes first common contact control 646a, second common contact 646b, previous guests control 646c, and invite control 636d. Also illustrated in FIG. 6V, people user interface 646 includes accessories list 646e to inform the first user which accessories are available to be shared with a guest. At FIG. 6V, computer system 600 detects selection input 605v as a tap at a location corresponding to invite control 636d.

As illustrated in FIG. 6W, in response to detecting selection input 605v, computer system 600 displays choose person user interface 648 and ceases displaying people user interface 646. As illustrated in FIG. 6W, choose person user interface 648 includes home key icon 624a, home key name 622b, contact search 648a, and four contacts including second contact 648b. At FIG. 6W, computer system 600 detects selection input 605w as a tap at a location corresponding second contact 648b.

As illustrated in FIG. 6X, in response to detecting selection input 605w, computer system 600 displays choose access user interface 650, which includes controls to customize the access of the selected guest. As illustrated in FIG. 6X, choose access user interface 650 includes scheduled access control 650a, anytime control 650b, first accessory name 650c, first accessory control 650d, second accessory name 650e, second accessory control 650f, third accessory name 650g, third accessory control 650h, send control 650i, as well as home key icon 624a and home key name 624b. As illustrated in FIG. 6X, first accessory name 650c and first accessory control 650d correspond to the front door, second accessory name 650e and second accessory control 650f correspond to the back door, and third accessory name 650g and third accessory control 650h correspond to the garage door.

In some embodiments, at FIG. 6X, computer system 600 detects selection input 605v1 as a tap at a location corresponding to scheduled access control 650a, resulting in computer system 600 reacting as discussed below with respect to FIG. 6Z. In some embodiments, at FIG. 6X, computer system 600 detects selection input 605v2 as a tap at a location corresponding to anytime control 650b, resulting in computer system 600 reacting as discussed below with respect to FIG. 6Y.

As illustrated in FIG. 6X, computer system 600 displays first accessory control 650d in the on position indicating the invited guest access is configured to have some control over the front door lock. In some embodiment, computer system 600 displays first accessory control 650d in the on position due to detecting a selection input as a tap at a location corresponding first accessory control 650d. For example, the first user selected the front door lock as the accessory for Johnny (e.g., the second user) (e.g., the invited guest) to control. In some embodiments, computer system 600 detects selection inputs as taps at locations corresponding to controls corresponding to more than one accessory, causing computer system 600 to display more than one accessory control in the on position. For example, the guest access is configured to have some control over the front door and the garage. In some embodiments at FIG. 6X, computer system 600 detects selection input 605x3 as a tap at a location corresponding to send control 650i after detecting a selection input as a tap at a location corresponding to guest accessory done control 652a at FIG. 6Y and/or FIG. 6AA, resulting computer system 600 sending a communication to a second computer (e.g., computer system 660) inviting a second user to have access to the smart home control system in a process discussed in more detail starting with respect to FIG. 6AB.

As illustrated in FIG. 6Y, in response to detecting selection input 605x2, computer system 600 displays guest accessories user interface 652, which contains information for the first user to verify what accessories within the smart home control system the invited guest has access to. As illustrated in FIG. 6Y, computer system 600 displays guest accessories user interface 652 with guest icon 652a, guest name 652b and guest accessory done control 652e. Also illustrated in FIG. 6W, in response to the invited guest access being configured to have some control over the front door lock, computer system 600 displays guest accessories user interface 652 with first guest accessory icon 652c and first guest accessory name 652d which correspond to the front door lock just as first accessory name 650c and first accessory control 650d do within choose access user interface 560 in FIG. 6X. In some embodiments, computer system 600 detects selection input as a tap at a location corresponding to guest accessory done control 652e resulting in computer system 600 computer system 600 displaying choose access user interface 650 as displayed in FIG. 6X with the difference of computer system 600 displaying anytime 650b as emphasized.

As illustrated in FIG. 6Z, in response to detecting selection input 605v1, computer system displays guest schedule user interface 654, which includes guest icon 652a and guest name 652b. Also illustrated in FIG. 6Z, guest schedule user interface 654 includes controls to set the access schedule for the invited guest such as specific days control 654a, all day label 654b, all day control 654c, start label 654d, end label 654e, repeat control 654f, and guest schedule done control 654g. As illustrated in FIG. 6Z, computer system 600 displays all day control 654c in the on position, indicating that the invited guest access is configured to allow the invited guest access all day on the selected days. As illustrated in FIG. 6Z, computer system 600 displays repeat control 654f with the text, “every Friday and Saturday,” to indicate the selected repeating days of the access schedule. In some embodiments, computer system 600 displays the text indicated the selected repeating days after detecting a selection input as a tap at a location corresponding to repeat control 654f resulting in computer system 600 displaying a user interface including ways to select which days are to be repeated. For example, computer system 600 can detect a selection input corresponding to every fourth Monday of the month.

In some embodiments, computer system 600 detects a selection input as a tap at a location corresponding to all day control 654c, resulting in computer system 600 displaying all day control 654c in the off position and displaying time controls to the right of start label 654d and end label 654e. In such embodiments, the time controls allow the first user to set a start time and end time for the invited guest access on the selected days. For example, computer system 600 detects a selection input (e.g., a tap, a swipe, and/or keyboard entry) at location corresponding to the time control to the right of start label 654d setting the start time to ten in the morning and computer system 600 detects a selection input (e.g., a tap, a swipe, and/or keyboard entry) at a location corresponding to the time control to the right of end label 654e setting the end time to four in the afternoon. At FIG. 6Z, computer system 600 detects selection input 605z as a tap at a location corresponding to guest schedule done control 654g.

As illustrated in FIG. 6AA, in response to detecting selection input 605z, computer system 600 displays guest accessories user interface 652. As illustrated in FIG. 6AA, in response to the invited guest access being configured to have access all day every Friday and Saturday, computer system 600 displays guest schedule 652f with text to inform the first user of this configured setting (e.g., all day, Friday and Saturday). In some embodiments, computer system 600 displays guest schedule 652f with different text in response to the invited guest access being configured to have access at different times. For example, computer system 600 displays guest schedule 652f with text to inform the first user that the guest access is configured to have access from 6 in the evening on Tuesday the twenty-first of May until ten in the morning on Monday the twenty-seventh of May. In some embodiments, the guest access has been configured to have access at more than one scheduled time, resulting in computer system 600 displaying guest schedule 652f with text to inform the first user of each of the scheduled times. For example, computer system 600 can display guest schedule 652f with text to inform the first user that the invited guest access is configured to have access from noon until eight in the evening every Thursday and all day on June first. As illustrated in FIG. 6AA, while displaying guest schedule 652f, computer system 600 displays first guest accessory icon 652c and first guest accessory name 652d farther down within guest accessories user interface 652 to accommodate guest schedule. In some embodiments, computer system 600 does not move first guest accessory icon 652c and first guest accessory name 652d and instead computer system 600 displays guest schedule 652f below first guest accessory icon 652c and first guest accessory name 652d. In some embodiments, computer system 600 detects selection input as a tap at a location corresponding to guest accessory done control 652e resulting in computer system 600 computer system 600 displaying choose access user interface 650 as displayed in FIG. 6X with the difference of computer system 600 displaying scheduled access control 650a as emphasized.

FIGS. 6AB-6AL illustrate computer system 660, which is different from computer system 600, as a smart phone of the second user who is the invited guest (e.g., Johnny). The left side of FIGS. 6AB-6AL illustrate computer system 660 as a smart phone displaying different user interface objects. It should be recognized that computer system 660 can be other types of computer systems such as a smart watch, a tablet, a laptop, a communal device, an accessory, a personal gaming system, a desktop computer, a fitness tracking device, and/or a head-mounted display (HMD) device. In some embodiments, computer system 660 has the same input devices, sensors, and/or capabilities as computer system 600 as described above. At FIGS. 6AB-6AL, after receiving the communication from computer system 600 inviting computer system 660 to have access to the smart home control system, computer system 660 is in communication with the same smart home control system as computer system 600.

As illustrated in FIG. 6AB, computer system 660 displays lock screen 662. In response to computer system 600 detecting selection input 605x3, computer system 600 transfers an invitation causing computer system 660 display home invitation user interface 664 overlaid on top of lock screen 662. As illustrated in FIG. 6AB, home invitation user interface 664 includes invited by indicator 664a, join home control 664b, and decline invitation control 664c. Invited by indicator 664a includes text to inform the second user of the name of the person who is inviting them (e.g., Steve) to have access to the smart home control system. In some embodiments, invited by indicator 664a does not include the name and/or includes different information to inform the second user who the person is who is inviting them to have access to the smart home control system, such as a phone number, email address, and/or username. For example, computer system 660 can display invited by indicator 664a with text indicating the inviter's username and/or phone number. In some embodiments, the name displayed to indicate the inviter is a name associated with the inviter within computer system 600 and/or a name associated with the inviter within computer system 660 and/or a different computer system (e.g., the name of the inviter as stored on the inviter's computer system). For example, computer system 600 has the first user (e.g., the inviter) identified as Steve while computer system 660 has the first user identified as Steve, causing computer system 660 to display the name Steve within invited indicator 664a. In some embodiments, Steve is the owner and/or a resident of the smart home control system. In these embodiments, Steve's name is displayed so the invitee knows who to contact for questions about the smart home control system. In some embodiments, Steve is a guest of the smart home control system, and computer system 600 does not display Steve's name and/or contact information. Steve's name is not provided in these embodiments because Steve may not have authority and/or control to assist with the smart home control system. At FIG. 6AB, computer system 660 detects selection input 605ab as a tap at a location corresponding to join home control 664b.

As discussed above, the second user is being invited to access the smart home control system as a guest. In some embodiments, invitation user interface 664 includes text to inform the second user that they are being invited to have access as a guest. For example, computer system 660 displays invitation user interface 660 with the text, “home invitation with guest access permissions.” In some embodiments, invitation user interface 664 includes text to inform the second user if they have local access (e.g., while at the property) and/or remote access to the smart home control system. For example, computer system 660 displays the text, “you are invited by Steve as a guest with local access” within invitation user interface 664. In some embodiments, invitation user interface 664 includes information such as which accessories the second user will have control and/or any time restrictions for the control of the accessories.

As illustrated in FIG. 6AC, in response to detecting selection input 605ab, computer system 660 displays your access user interface 666 which includes text to inform the second user that their invited access has a set schedule. Your access user interface 666 includes schedule indicator 666a, home joined indicator 666b, and your access close control 666c. Schedule indicator 666a includes information to inform the second user what the access schedule is set for. In some embodiments, more than one schedule has been set, resulting in computer system 660 displaying more than one schedule indicator. For example, the first user set the access of the second user to the property to be all day on Friday and Saturday as well as on the first of every month from noon to nine in the evening. At FIG. 6AC, computer system 660 detects selection input 605ac as a tap at a location corresponding to your access close control 666c

As illustrated in FIG. 6AD computer system 660 displays access information user interface 668, which includes property indicator 668a, first accessory control 668b, schedule indicator 666a, set up now control 668c, and inviter contact control 668d. As illustrated in FIG. 6AD, computer system 660 displays property indicator 668a with information about the property that the second user has been invited to access such as the name of the property and the name of the person who invited the second user. In some embodiments, computer system 600 displays property indicator 668a with the same and/or different information about the property that the second user has been invited to access such as the address of the property, the name of the owner, and/or the longitude and latitude. At FIG. 6AD, first accessory control 668d corresponds to the front door lock and includes an icon depicting a locked lock to indicate the status of the front door lock as well as text to identify the accessory and the status of the accessory (e.g., front door locked). In some embodiments, the second user has been invited to control more than one accessory. In such embodiments, computer system 660 displays more than one accessory control within access information user interface 668. At FIG. 6AD, computer system 660 detects selection input 605ad as a tap at a location corresponding to set up now control 668c.

As illustrated in FIG. 6AE, in response to computer system 660 detecting selection input 605ad, computer system 660 displays key setup user interface 670 which includes property information 670a, schedule indicator 666a, guest key accessory indicator 670b and guest key done control 670c. Property information 670a includes the same information about the property as property indicator 668a. In some embodiments, computer system 660 displays property information 670a with additional and or different information about the property as property indicator 668a. For example, computer system 660 displays property indicator 668a with the address of the property and the name of the inviter and computer system 660 displays property information 670a with the name of the property, the address of the property, the name of the inviter, and the name of the owner of the property. At FIG. 6AE, computer system 660 detects selection input 605ae as a tap at a location corresponding to guest key done control 670c.

As illustrated in FIG. 6AF, in response to detecting selection input 605ae, computer system 660 displays access information user interface 668 without set up now control 668c. In some embodiments, in response to not displaying set up now control 668c, computer system 660 displays information that did not fit within access information user interface 668 while computer system 660 displays set up now control 668c. For example, computer system 660 displays other accessory controls that the second user has access to.

At FIGS. 6AG-6AI, computer system 660 displays a user element (e.g., guest access status control 676) that selectively includes information corresponding to the front door lock within the user element depending on detected context such as current time and/or the current location of computer system 660. In some embodiments, computer system 660 selectively displays information corresponding to different and/or more accessories. For example, if the second user has access to the front door and the garage door, computer system 660 selectively displays information corresponding to both accessories within guest access status control 676. In some embodiments, computer system 660 selectively displays the information corresponding to one or more accessories within a smart home application user interface.

As illustrated in FIG. 6AG, computer system 660 displays home screen user interface 672, which includes controls to access applications included on computer system 660 including guest access status control 676. As illustrated in FIG. 6AG, guest access status control 676 includes accessory identity indicator 676a and accessory status indicator 676b. Accessory identity indicator 676a includes text to identify the corresponding accessory (e.g., oak st. front door) and accessory status indicator 676b includes text to indicate the status of the corresponding accessory. At FIG. 6AG, the second user is represented by second user representation 674 within diagram 610, and the location of second user representation 674 relative to door representation 612 within diagram 610 is representative of the location of the second user within the environment relative to the front door and the front door lock. At FIG. 6AG, the second user arrives at the front door of the property as indicated by second user representation 674 being illustrated near door representation 612 in diagram 610 during a scheduled access day (e.g., Friday or Saturday) and while the front door lock is locked.

At FIG. 6AG, the second user brings computer system 660 in close contact with (e.g., taps against) the front door lock causing computer system 660 being in close contact with the front door lock to be detected. In some embodiments, in response to the computer system 660 being detected in close proximity to the front door lock, computer system 660 performs a facial recognition scan similar to the facial recognition scan performed by computer system 600 as described in FIGS. 6O-6Q.

At FIG. 6AG, in response to computer system 660 being detected in close contact with the front door lock during a scheduled access day, computer system 660 sends a request to unlock the front door lock. At FIG. 6AG, the front door lock is unlocked, as indicated by lock status 614 within diagram 610 being illustrated as an unlocked lock. At FIG. 6AG, computer system 660 receives the information that the front door lock is unlocked resulting in computer system 660 displaying accessory status indicator 676b with the text “unlocked.” In some embodiments, computer system 660 detects a selection input as a tap at a location corresponding to guest access status control 676 while the front door lock is locked, computer system 660 is at the property, and during a scheduled access day causing computer system 660 to transfer the request to unlock the front door lock.

FIG. 6AH, illustrates a similar scenario to the one described in FIG. 6AG except that the second user is at the property on a day that is not a scheduled access day (e.g., Sunday, Monday, Tuesday, Wednesday, or Thursday). At FIG. 6AH, the second user arrives at the front door of the property as indicated by second user representation 674 being illustrated near door representation 612 within diagram 610. As illustrated in FIG. 6AH, in response to the day not being one of the scheduled access days, computer system 660 displays outside schedule indicator 676c and outside schedule icon 676d within guest access status control 676 and does not display accessory identity indicator 676a or accessory status indicator 676b. In some embodiments, in response to the day not being one of the scheduled access days, computer system 660 displays a different combination of accessory identity indicator 676a, accessory status indicator 676b, outside schedule indicator 676c and/or outside schedule icon 676d. For example, in response to the day no being one of the scheduled access days, computer system 660 displays guest access status control 676 as including accessory identity indicator 676a, outside schedule indicator 676c, and outside schedule icon 676d.

At FIG. 6AI, the second user is not at the property as indicated by second user representation 674 not being illustrated within diagram 610, resulting in computer system 660 detecting that the second user is not at the property. As illustrated in FIG. 6AI, in response to detecting that the second user is not at the property, computer system 660 displays guest access status control 676 with away access indicator 676e. At FIG. 6AI, computer system 660 detects selection input 605ai as a tap at a location corresponding to guest access status control 676.

It should be noted that while FIGS. 6AG-6AI depict computer system 660 selectively displaying information corresponding to the front door lock while unlocked, in some embodiments, computer system 660 selectively displays information corresponding to the front door lock while locked within a locked screen user interface. For example, computer system 660 displays a version of guest status control 676 within the locked screen user interface. In some embodiments, the information corresponding to the front door lock is selectively displayed within a watch complication displayed by a smart watch. For example, the smart watch can display icons depicting a locked lock, an unlocked lock, a clock (e.g., outside scheduled time), or a person walking (e.g., not at the property) to indicate the different statuses of the front door lock or the reasons that the status of the front door lock is not indicated. In some such embodiments, computer system 660 is the smart watch. In some such embodiments, computer system 660 is in communication with the smart watch.

As illustrated in FIG. 6AJ, in response to detecting selection input 605ai, computer system 660, displays away access user interface 678 which includes text to inform the second user that computer system 660 (e.g., the second user) can only view and/or control the accessories at the property while computer system 660 is at the property during the scheduled access times. Away access user interface 678 also includes close control 678a and contact inviter control 678b. At FIG. 6AJ, computer system 660 detects selection input 605aj1 as a tap at a location corresponding to close control 678a. In some embodiments, at FIG. 6AJ, computer system 660 detects selection input 605aj2 as a tap at a location corresponding to contact inviter control 678b, causing computer system 660 to respond as described below with respect to FIG. 6AL.

As illustrated in FIG. 6AK, in response to detecting selection input 605aj1 computer system 660 displays access information user interface 668. As illustrated in FIG. 6AK, in response to detecting that the second user is not at the property, computer system 660 displays first accessory control 668b with text to inform the second user that access to the accessories for the property is not available while computer system 660 is not located at the property. At FIG. 6AK, computer system 660 detects selection interface 605ak as a tap at a location corresponding to inviter contact control 668d.

As illustrated in FIG. 6AL, in response to detecting selection input 605aj2 at FIG. 6AJ or detecting selection input 605ak at FIG. 6AK, computer system 660 displays messaging user interface 680 with message 680a and message input section 680b. As illustrated in FIG. 6AL, message 680a includes text requesting access to the property. In some embodiments, in response to detecting selection input 605aj2, computer system 660 displays text requesting access to the property within message input section 680b, allowing the second user to edit the message and/or decide when to send the message.

FIGS. 6AM-6AO illustrate computer system 690 which is different from computer system 600 and/or computer system 660. The left side of FIGS. 6AM-6AO illustrate computer system 690 as a smart phone displaying different user interface objects. It should be recognized that computer system 690 can be other types of computer systems such as a smart watch, a tablet, a laptop, a communal device, an accessory, a personal gaming system, a desktop computer, a fitness tracking device, and/or a head-mounted display (HMD) device. In some embodiments, computer system 690 has the same input devices, sensors, and/or capabilities as computer system 600 and/or computer system 660as described above. At FIGS. 6AM-6AO, after receiving the communication from computer system 600 inviting computer system 690 to have access to the smart home control system as a resident, computer system 660 is in communication with the same smart home control system as computer system 600.

As illustrated in FIG. 6AM, computer system 690 displays lock screen 694. As illustrated in FIG. 6AM, in response to computer system 600 detecting selection input 605x3, computer system 600 transfers an invitation causing computer system 690 display home invitation user interface 664 overlaid on top of lock screen 694. As illustrated in FIG. 6AM, in response to the third user being configured to have access to the smart home control system as a resident, computer system 690 display home invitation user interface 664 without invited by indicator 664a. At FIG. 6AM, computer system 690 detects selection input 605am as a tap at a location corresponding to join home control 664b.

As illustrated in FIG. 6AN, in response to detecting selection input 605am, computer system 690 displays access information user interface 668. As illustrated in FIG. 6AN, in response to the third user being configured to have access as a resident and not as a guest as the second user was, computer system 600 displays access information user interface 668 without inviter contact control 668d. Computer system 690 displays access information user interface 668 with first accessory control 668b. In some embodiments, in response to the third user being configured to have access as a resident, computer system 690 displays additional and/or different accessory controls within access information user interface. For example, in response to the third user being configured to have access as a resident, computer system 690 displays first accessory control 668b as well as controls for the back door, the garage door, lights, and speakers. At FIG. 6AN, computer system 690 detects selection input 605an as a tap at a location corresponding to set up now control 668c and in response computer system 690 goes through the process described above for computer system 600 in FIGS. 6A-6F.

As illustrated in FIG. 6AO, in response to detecting a selection input at a location corresponding to enter code done control 622a within enter code user interface 622, computer system 690 displays access information user interface 668 without set up now control 668c or inviter contact control 668d.

FIG. 7 is a flow diagram illustrating a process (e.g., process 700) for configuring accessories to be controlled in different manners in accordance with some embodiments. Some operations in process 700 are, optionally, combined, the orders of some operations are, optionally, changed, and some operations are, optionally, omitted.

As described below, process 700 provides an intuitive way for configuring accessories to be controlled in different manners. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication (e.g., wired communication and/or wireless communication) with one or more input devices (e.g., a communication radio, a camera, a depth sensor, a microphone, a hardware input mechanism, a rotatable input mechanism, a heart monitor, a temperature sensor, and/or a touch-sensitive surface), and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system displays (702), via the one or more display generation components, a user interface (e.g., a user interface of a home application, a user interface of a credential management application, a notification, an overlay, a lock screen, a home screen, and/or a user interface that is displayed while the computer system is in a locked state) (e.g., 616) including a first user interface element (e.g., an icon, a widget, a control, and/or a window) (e.g., 616a) and a second user interface element (e.g., an icon, a widget, a control, and/or a window) (e.g., 616b) different from the second user interface element.

While displaying the first user interface element and the second user interface element, the computer system detects (704), via the one or more input devices, an input (e.g., a selection input and/or a non-selection input) (e.g., 605b1 and/or 605b2) corresponding to a respective user interface element. In some embodiments, the input corresponding to the respective user interface element includes a selection of the first user interface element or the second user interface element. In some embodiments, the input corresponding to the respective user interface element includes a keyboard input to select the respective user interface element.

In response to (706) detecting the input corresponding to the respective user interface element, in accordance with (708) a determination that the respective user interface element is the first user interface element, the computer system configures (710) (e.g., as described with respect to FIGS. 6C-6G) the computer system to control (e.g., send, to the accessory, a command and/or cause an operation to be performed by) an accessory in a first manner (e.g., to operate based on a position of the computer system relative to the accessory and/or to operate based on the proximity of the computer system relative to the accessory) (e.g., corresponding to 624f being active) without detecting, via the one or more input devices, an input (e.g., a selection input and/or a non-selection input) (and/or without authentication of a user). In some embodiments, the location is coordinates and/or position in a physical environment.

In response to (706) detecting the input corresponding to the respective user interface element, in accordance with (708) the determination that the respective user interface element is the first user interface element, the computer system configures (712) (e.g., separately configures and/or independently configures relative to configuring the computer system to control the accessory to unlock based on a location of the computer system relative to the accessory without detecting, via the one or more input devices, an input) (e.g., as described with respect to FIGS. 6C-6G) the computer system to control the accessory in a second manner (e.g., to operate the accessory to unlock based on the computer system being within a first proximity of the accessory and/or to operate based on the location of the computer system relative to the accessory without detecting, via the one or more input devices, an input) (e.g., corresponding to 624h being active) without detecting, via the one or more input devices, an input (and/or without authentication of a user), wherein the second manner is different from the first manner. In some embodiments, proximity is a distance and/or closeness. In some embodiments, the first proximity includes a threshold distance (e.g., 1 inch, 0.1 mm) of the accessory to the computer system. In some embodiments, the first proximity is determined by a location (e.g., coordinate and/or position) in a physical environment. In some embodiments, the first proximity is determined based on presence, near-field communication, and/or short radio wave without detecting the physical position of the computer system in the environment. In some embodiments, the first proximity is between the location of the accessory and the location of the computer system within a defined area of positions.

In response to (706) detecting the input corresponding to the respective user interface element, in accordance with a determination that the respective user interface element is the second user interface element, the computer system configures (714) (e.g., as described with respect to FIGS. 6C-6G) the computer system to control the accessory in a third manner (e.g., to operate based on an authentication of a user and/or to operate based on an authentication of the computer system) (and/or the computer system being within a second proximity of the accessory) (e.g., without configuring the computer system to control the accessory in the first manner and/or the second manner) (e.g., corresponding to 624f and 624h being inactive), wherein the third manner is different from the first manner and the second manner. In some embodiments, after configuring the computer system to control the accessory in the third manner, the computer system detects, via the one or more input devices, the first accessory within the second proximity of the computer system. In some embodiments, in response to detecting the first accessory within the second proximity of the computer system, the computer system displays, via the display generation device, an indication (e.g., a text, a graphical image, a symbol, and/or an animation) that an authentication is required (e.g., an authentication of a user). In some embodiments, the first proximity is different from the second proximity. In some embodiments, the second proximity includes a threshold distance (e.g., 1 inch, 0.1 mm) of the accessory to the computer system. In some embodiments, the second proximity is determined by a location (e.g., coordinate and/or position) in a physical environment. In some embodiments, the second proximity is determined based on presence, near-field communication, and/or short radio wave without detecting the physical position of the computer system in the environment. In some embodiments, the second proximity is between the location of the accessory and the location of the computer system within a defined area of positions. In some embodiments, in response to detecting the input corresponding to the respective user interface element and in accordance with the determination that the respective user interface element is the first user interface element, the computer system configures the computer system to control the accessory in the third manner. Configuring the computer system to control in multiple manners in response to detecting an input corresponding to a first user interface element and another manner in response to detecting an input corresponding to a second user interface element enables a user many different ways to control the accessory, thereby reducing the number of inputs needed to perform an operation and/or performing an operation when a set of conditions has been met without requiring further user input.

In some embodiments, the computer system is in communication with one or more sensors (e.g., wireless sensor technologies, a Inertial Measurement Units (IMU), a camera, and/or a GPS). In some embodiments, configuring the computer system to control the accessory in the first manner (e.g., as described with respect to FIGS. 6C-6G) (e.g., corresponding to 624f being active) without detecting, via the one or more input devices, an input includes configuring the computer system to control the accessory based on a position of the computer system detected via the one or more sensors. In some embodiments, the wireless sensor technologies includes Ultra-Wideband (UWB). Configuring the computer system to control an accessory based on a position of the computer system detected via one or more sensors enables control of the accessory without requiring user inputs, thereby reducing the number of inputs needed to perform an operation and/or providing additional control options without cluttering the user interface with additional displayed controls.

In some embodiments, configuring the computer system to control the accessory in the second manner (e.g., as described with respect to FIGS. 6C-6G) (e.g., corresponding to 624h being active) without detecting, via the one or more input devices, an input includes configuring the computer system to control the accessory based on a proximity of the computer system detected via a communication channel (e.g., the proximity is achieved when there is communication via the communication channel and the proximity is not achieved when there is not communication via the communication channel). In some embodiments, the communication channel is Bluetooth, Ultra-Wideband (UWB), and/or near-field communication (NFC). In some embodiments, proximity is a distance and/or closeness. In some embodiments, the proximity includes a threshold distance (e.g., 1 inch, 0.1 mm) of the accessory to the computer system. In some embodiments, the proximity is determined by a location (e.g., coordinate and/or position) in a physical environment. In some embodiments, the proximity is determined based on presence, near-field communication, and/or short radio wave without detecting a physical position of the computer system in the environment. In some embodiments, the proximity is between the location of the accessory and the location of the computer system within a defined area of positions. Configuring the computer system to control an accessory based on a proximity of the computer system detected via a communication channel enables control of the accessory without requiring user inputs, thereby reducing the number of inputs needed to perform an operation and/or providing additional control options without cluttering the user interface with additional displayed controls.

In some embodiments, the accessory is a lock (e.g., a smart lock, a door lock, and/or an electronic keypad) (e.g., 612).

In some embodiments, while the accessory is in a locked state (e.g., a state that requires a physical key, a password, and/or other information before the accessory can transition into an unlocked state and/or a state that is more accessible to interact with the accessory than another state in which the accessory can operate) (e.g., as illustrated by and discussed with respect to 614 in FIG. 6B) and after configuring the computer system to control the accessory in the first manner (and/or while the computer system is configured to control the accessory in the first manner), the computer system detects that the computer system (and/or the accessory) satisfies a first set of one or more criteria (e.g., based on a position of the computer system) (e.g., as described with respect to FIG. 6I) corresponding to the first manner without detecting, via the one or more input devices, an input. In some embodiments, in response to detecting that the computer system (and/or the accessory) satisfies the first set of one or more criteria corresponding to the first manner without detecting, via the one or more input devices, an input, the computer system controlls (e.g., unlocks, sends a command, a request, and/or an instruction to, and/or obtains information from) (e.g., as described with respect to FIG. 6I) the accessory (performs, via the accessory, a first operation). In some embodiments, while the accessory is in the locked state and after configuring the computer system to control the accessory in the second manner (and/or while the computer system is configured to control the accessory in the second manner), the computer system detects that the computer system (and/or the accessory) satisfies a second set of one or more criteria (e.g., based on a proximity of the computer system) (e.g., as described with respect to FIG. 6M), different from the first set of one or more criteria, corresponding to the second manner without detecting, via the one or more input devices, an input. In some embodiments, in response to detecting that the computer system (and/or the accessory) satisfies the second set of one or more criteria corresponding to the second manner without detecting, via the one or more input devices, an input, the computer system controlls (e.g., unlocks, sends a command, a request, and/or an instruction to, and/or obtains information from) (e.g., as described with respect to FIG. 6M) the accessory (performs, via the accessory, the first operation). In some embodiments, while the accessory is in the locked state and after configuring the computer system to control the accessory in the third manner (and/or while the computer system is configured to control the accessory in the third manner), the computer system detects that the computer system (and/or the accessory) satisfies a third set of one or more criteria (e.g., based on an input detected via the one or more input devices) (e.g., as described with respect to FIGS. 6O-6Q and/or 6R), different from the first set of one or more criteria and the second set of one or more criteria, corresponding to the third manner. In some embodiments, in response to detecting that the computer system (and/or the accessory) satisfies the third set of one or more criteria corresponding to the third manner, the computer system controlls (e.g., unlocks, sends a command, a request, and/or an instruction to, and/or obtains information from) (e.g., as described with respect to FIG. 6Q) the accessory (performs, via the accessory, the first operation). In some embodiments, the input corresponding to the respective user interface element is detected while the accessory is in the locked state. Controlling an accessory while the accessory is in a locked state in different manners depending on how the computer system is configured enables a user many different ways to control the accessory even when the accessory is in the locked state, thereby reducing the number of inputs needed to perform an operation and/or performing an operation when a set of conditions has been met without requiring further user input.

In some embodiments, while the computer system is in a locked state (e.g., (1) a state that requires a password and/or other information to be entered before the computer system can transition into an unlocked state and/or (2) a state that is more secure, less functional, and/or include less information than another state in which the computer system can operate) (e.g., 626 and/or as described with respect to FIGS. 6H-6L and 6O-6Q), after configuring the computer system to control the accessory in the first manner (and/or while the computer system is configured to control the accessory in the first manner), the computer system detects that the computer system (and/or the accessory) satisfies a first set of one or more criteria (e.g., based on a position of the computer system) (e.g., as described with respect to FIG. 6I) corresponding to the first manner without detecting, via the one or more input devices, an input. In some embodiments, while the computer system is in the locked state, in response to detecting that the computer system (and/or the accessory) satisfies the first set of one or more criteria corresponding to the first manner without detecting, via the one or more input devices, an input, the computer system controlls (e.g., unlocks, sends a command, a request, and/or an instruction to, and/or obtains information from) (e.g., as described with respect to FIG. 6I) the accessory (performs, via the accessory, a first operation). In some embodiments, while the computer system is in the locked state, after configuring the computer system to control the accessory in the second manner (and/or while the computer system is configured to control the accessory in the second manner), the computer system detects that the computer system (and/or the accessory) satisfies a second set of one or more criteria (e.g., based on a proximity of the computer system) (e.g., as described with respect to FIG. 6M), different from the first set of one or more criteria, corresponding to the second manner without detecting, via the one or more input devices, an input. In some embodiments, while the computer system is in the locked state, in response to detecting that the computer system (and/or the accessory) satisfies the second set of one or more criteria corresponding to the second manner without detecting, via the one or more input devices, an input, the computer system controlls (e.g., unlocks, sends a command, a request, and/or an instruction to, and/or obtains information from) (e.g., as described with respect to FIG. 6M) the accessory (performs, via the accessory, the first operation). In some embodiments, while the computer system is in the locked state, after configuring the computer system to control the accessory in the third manner (and/or while the computer system is configured to control the accessory in the third manner), the computer system detects that the computer system (and/or the accessory) satisfies a third set of one or more criteria (e.g., based on an input detected via the one or more input devices) (e.g., as described with respect to FIGS. 6O-6Q and/or 6R), different from the first set of one or more criteria and the second set of one or more criteria, corresponding to the third manner. In some embodiments, while the computer system is in the locked state, in response to detecting that the computer system (and/or the accessory) satisfies the third set of one or more criteria corresponding to the third manner, the computer system controlls (e.g., unlocks, sends a command, a request, and/or an instruction to, and/or obtains information from) (e.g., as described with respect to FIG. 6Q) the accessory (performs, via the accessory, the first operation). In some embodiments, the input corresponding to the respective user interface element is detected while the computer system is in the locked state. Controlling an accessory while the computer system is in a locked state in different manners depending on how the computer system is configured enables a user many different ways to control the accessory even when the computer system is in the locked state, thereby reducing the number of inputs needed to perform an operation and/or performing an operation when a set of conditions has been met without requiring further user input.

In some embodiments, after configuring the computer system to control the accessory in the third manner (and/or while the computer system is configured to control the accessory in the third manner), the computer system detects (e.g., via the one or more input devices, via the one or more sensors, and/or via the communication channel) a proximity of the accessory relative to the computer system (e.g., as described with respect to FIGS. 6O-6R). In some embodiments, the proximity is a distance and/or closeness. In some embodiments, the proximity includes a threshold distance (e.g., 1 inch to 0.1 mm) of the accessory to the computer system. In some embodiments, the proximity is determined by a location (e.g., coordinate and/or position) in a physical environment. In some embodiments, the proximity is determined based on presence, near-field communication, and/or short radio wave without detecting the physical position of the computer system in the environment. In some embodiments, the proximity is between the location of the accessory and the location of the computer system within a defined area of positions. In some embodiments, after (and/or in response to) detecting the proximity of the accessory relative to the computer system, the computer system displays, via the one or more display generation components, a user interface element (e.g., an icon, a widget, a control, and/or a window) to authenticate (e.g., to provide an input to identify and/or confirm) a user (e.g., 628 and/or 600) of the computer system (e.g., as described with respect to 6P-6R). In some embodiments, while displaying the user interface to authenticate the user of the computer system, the computer system authenticates the user (e.g., via detecting a set of one or more inputs corresponding to a password and/or biometric data). In some embodiments, in response to authenticating the user, the computer system controls (e.g., unlocks, sends a command, a request, and/or an instruction to, and/or obtains information from) the accessory (performs, via the accessory, the first operation). Requiring a user to authenticate via the computer system when the computer system is configured to control an accessory in a particular manner allows the computer system additional security in certain contexts, thereby improving security and/or performing an operation when a set of conditions has been met without requiring further user input.

In some embodiments, after configuring the computer system to control the accessory in the first manner (and/or while the computer system is configured to control the accessory in the first manner) and after configuring the computer system to control the accessory in the second manner (and/or while the computer system is configured to control the accessory in the second manner), the computer system detects, via the one or more input devices, a first input (e.g., a selection input and/or a non-selection input) corresponding to a first request to change a first respective configuration (e.g., as described with respect to FIGS. 6M-6N). In some embodiments, in response to detecting the first input corresponding to the first request to change the first respective configuration, in accordance with a determination that the first respective configuration is a first configuration, the computer system configures (e.g., as described with respect to FIGS. 6M-6N) the computer system to no longer control the accessory in the first manner while maintaining the computer system configured to control the accessory in the second manner (and/or the third manner). In some embodiments, in response to detecting the first input corresponding to the first request to change the first respective configuration, in accordance with a determination that the first respective configuration is a second configuration different from the first configuration, the computer system configures (e.g., as described with respect to FIGS. 6M-6N) the computer system to no longer control the accessory in the second manner while maintaining the computer system configured to control the accessory in the first manner (and/or the third manner). In some embodiments, in response to detecting the first input corresponding to the first request to change the first respective configuration and in accordance with a determination that the first respective configuration is a fifth configuration different from the first configuration and the second configuration, the computer system configures the computer system to no longer control the accessory in the first manner and the second manner while maintaining the computer system configured to control the accessory in the third manner. In some embodiments, after configuring the computer system to control the accessory in the third manner (and/or while the computer system is configured to control the accessory in the third manner), the computer system detects, via the one or more input devices, a second input (e.g., a selection input and/or a non-selection input) corresponding to a second request to change a second respective configuration (e.g., as described with respect to FIGS. 6M-6N). In some embodiments, in response to detecting the second input corresponding to the second request to change the second respective configuration, in accordance with a determination that the second respective configuration is a third configuration different from the first configuration, the computer system configures (e.g., as described with respect to FIGS. 6M-6N) the computer system to control the accessory in the first manner (e.g., while maintaining the computer system configured to control the accessory in the third manner). In some embodiments, in response to detecting the second input corresponding to the second request to change the second respective configuration, in accordance with a determination that the second respective configuration is a fourth configuration different from the second configuration, the computer system configures (e.g., as described with respect to FIGS. 6M-6N) the computer system to control the accessory in the second manner (e.g., while maintaining the computer system configured to control the accessory in the third manner). Individually changing how the computer system is configured to control an accessory even though an initial configuration did multiple configurations with a single input enables a user more control of how to control the accessory, thereby performing an operation when a set of conditions has been met without requiring further user input.

In some embodiments, the accessory is a first accessory. In some embodiments, the respective user interface element is a first respective user interface element. In some embodiments, while the first accessory is configured to be controlled in the first manner (and/or the second manner), the computer system displays, via the one or more display generation components, a third user interface element (e.g., an icon, a widget, a control, and/or a window) (and/or a fourth user interface element (e.g., an icon, a widget, a control, and/or a window) different from the third user interface element). In some embodiments, while the first accessory is configured to be controlled in the first manner, while displaying the third user interface element (and/or the fourth user interface element), the computer system detects, via the one or more input devices, an input (e.g., a selection input and/or a non-selection input) corresponding to the third user interface element. In some embodiments, the input corresponding to the third user interface element includes a selection of the third user interface element. In some embodiments, the input corresponding to the third user interface element includes a keyboard input to select the third user interface element. In some embodiments, while the first accessory is configured to be controlled in the first manner, in response to detecting the input corresponding to the third user interface element, the computer system configures the computer system to control (e.g., send, to the accessory, a command and/or cause an operation to be performed by) a second accessory, different from the first accessory, in a fourth manner (e.g., the second manner, the third manner, or another manner different from the second manner and the third manner) different from the first manner (and/or the second manner). Different accessories being able to be controlled in different manners enables a user more control of how to interact with different accessories, thereby providing additional control options without cluttering the user interface with additional displayed controls and/or performing an operation when a set of conditions has been met without requiring further user input.

In some embodiments, configuring the computer system to control the accessory in the third manner includes configuring the computer system to control the accessory in response to the computer system authenticating a user (e.g., as described with respect to 616b and/or FIGS. 6O-6R). Requiring a user to authenticate when the computer system is configured to control an accessory in a particular manner enables a user to require different levels of security in different contexts, thereby increasing security and/or performing an operation when a set of conditions has been met without requiring further user input.

In some embodiments, configuring the computer system to control the accessory in the first manner includes: displaying, via the one or more display generation components, a user interface (e.g., 618) including a first indication (e.g., 618a-6f) corresponding to first set of one or more positions (e.g., to the left or to the right of the accessory) and a second indication (e.g., 618a-6f and/or 618h) corresponding to a second set of one or more positions (e.g., to the left or to the right of the accessory) different from the first set of one or more positions. In some embodiments, the second indication is separate from the first indication; while displaying the user interface including the first indication and the second indication, detecting, via the one or more input devices, an input (e.g., a selection input and/or a non-selection input) (e.g., 605c and/or 618h) corresponding to a respective indication; and In some embodiments, the input corresponding to the respective indication is a tap input on the respective indication, after detecting the input corresponding to the respective indication: in accordance with a determination that the respective indication is the first indication, configuring (e.g., as described with respect to FIG. 6D) the computer system to control the accessory in response to detecting the computer system in the first set of one or more positions (e.g., with or without configuring the computer system to control the accessory in response to detecting the computer system in the second set of one or more positions); and in accordance with a determination that the respective indication is the second indication, configuring (e.g., as described with respect to FIG. 6D) the computer system to control the accessory in response to detecting the computer system in the second set of one or more positions (e.g., with or without configuring the computer system to control the accessory in response to detecting the computer system in the first set of one or more positions). Configuring the computer system to automatically control an accessory from different positions enables a user to customize control of the accessory, thereby increasing security, providing additional control options without cluttering the user interface with additional displayed controls, and/or reducing the number of inputs needed to perform an operation.

In some embodiments, in response to detecting the input corresponding to the respective user interface element, the computer system initiates (e.g., as described about with respect to FIGS. 6E-6F) a process to configure a code (e.g., a PIN code, a password, and/or one or more numbers entered in sequence) for the accessory. In some embodiments, initiating the process to configure the code includes displaying, the one or more display generation components, a user interface (e.g., for entering the code). In some embodiments, after entering the code, the computer system sends the code to the accessory (e.g., for use by the accessory to allow access to a user using the code). Initiating a process to configure a code for an accessory after configuring the computer system to control the accessory enables a user to have different ways to control the accessory, thereby performing an operation when a set of conditions has been met without requiring further user input.

In some embodiments, configuring the computer system to control the accessory in the first manner without detecting, via the one or more input devices, an input includes configuring the computer system to control the accessory based on a position of the computer system relative to the accessory (e.g., as described above with respect to FIGS. 6H-6I). In some embodiments, the location is coordinates and/or position in a physical environment. Configuring the computer system to control an accessory based on a position of the computer system relative to the accessory enables the computer system to automatically control the accessory from different positions, thereby reducing the number of inputs needed to perform an operation, providing additional control options without cluttering the user interface with additional displayed controls, and/or performing an operation when a set of conditions has been met without requiring further user input.

In some embodiments, configuring the computer system to control the accessory in the second manner without detecting, via the one or more input devices, an input includes configuring the computer system to control the accessory based on a proximity of the computer system relative to the accessory (e.g., as described above with respect to FIG. 6M). In some embodiments, proximity is a distance and/or closeness. In some embodiments, the proximity includes a threshold distance (e.g., 1 inch, 0.1 mm) of the accessory to the computer system. In some embodiments, the proximity is determined by a location (e.g., coordinate and/or position) in a physical environment. In some embodiments, the proximity is determined based on presence, near-field communication, and/or short radio wave without detecting the physical position of the computer system in the environment. In some embodiments, the proximity is between the location of the accessory and the location of the computer system within a defined area of positions. Configuring the computer system to control an accessory based on a proximity of the computer system relative to the accessory enables the computer system to automatically control the accessory when in proximity, thereby reducing the number of inputs needed to perform an operation, providing additional control options without cluttering the user interface with additional displayed controls, and/or performing an operation when a set of conditions has been met without requiring further user input.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the first set of one or more criteria of method 800 can correspond to the first manner of method 700. For brevity, these details are not repeated herein.

FIG. 8 is a flow diagram illustrating a process (e.g., process 800) for configuring accessories to be controlled based on orientation in accordance with some embodiments. Some operations in process 800 are, optionally, combined, the orders of some operations are, optionally, changed, and some operations are, optionally, omitted.

As described below, process 800 provides an intuitive way for configuring accessories to be controlled based on orientation. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device.

The computer system detects (802), via the one or more input devices, a first orientation (e.g., position, and/or location) (e.g., as described above with respect to FIGS. 6H-6I) of a user (e.g., 628 and/or 600) relative to an accessory (e.g., a computer system configured to lock and unlock a lock, a different computer system than the computer system, a smart lock, and/or a door) (e.g., 612).

In response to (804) detecting the first orientation of the user relative to the accessory, in accordance with a determination that the first orientation of the user relative to the accessory satisfies a first set of one or more criteria (e.g., that the first orientation has been selected as an orientation and/or a distance from the accessory to control the accessory) (e.g., as described above with respect to FIG. 6I), the computer system controlls (806) (e.g., sends, to the accessory, a command and/or causes an operation to be performed by) (e.g., as described above with respect to FIG. 6I) the accessory without detecting, via the one or more input devices, an input (e.g., a selection input and/or a non-selection input). In some embodiments, the first orientation is to the left or to the right of the accessory. In some embodiments, the first orientation is included in an orientation range of between −10 to −90 degrees. In some embodiments, the first orientation is included in an orientation range of between 10 to 90 degrees. In some embodiments, controlling the accessory includes sending a command to the accessory such as to cause the accessory to turn on and/or unlock. In some embodiments, in response to detecting the first orientation of the user relative to the accessory and in accordance with the determination that the first orientation of the user relative to the accessory satisfies the first set of one or more criteria, the computer system outputs, via one or more output devices (e.g., a display generation component (e.g., a display screen, a projector, and/or a touch-sensitive display), an audio generation component (e.g., speaker, smart speaker, home theater system, soundbar, headphone, earphone, earbud, speaker, television speaker, augmented reality headset speaker, audio jack, optical audio output, Bluetooth audio output, and/or HDMI audio output), and/or a haptic generation component) of the computer system, an indication that the computer system is controlling the accessory.

In response to (804) detecting the first orientation of the user relative to the accessory, in accordance with a determination that the first orientation of the user relative to the accessory satisfies a second set of one or more criteria (e.g., that the first orientation has not been selected as an orientation and/or a distance from the accessory to control the accessory) (e.g., as described above with respect to FIG. 6H) different from the first set of one or more criteria, the computer system forgoes (808) (e.g., as described above with respect to FIG. 6H) control of the accessory. In some embodiments, in response to detecting the first orientation of the user relative to the accessory and in accordance with the determination that the first orientation of the user relative to the accessory satisfies the second set of one or more criteria, the computer system outputs, via the one or more output devices, an indication that the computer system has not controlled the accessory. Different orientations of a user relative to an accessory selectively controlling the accessory without detecting user input enables the user to control the accessory by their orientation to the accessory, thereby reducing the number of inputs needed to perform an operation and/or providing additional control options without cluttering the user interface with additional displayed controls.

In some embodiments, the computer system is in communication with one or more display generation components (e.g., a display screen, a projector, and/or a touch-sensitive display). In some embodiments, before detecting the first orientation of the user relative to the accessory, the computer system displays, via the one or more display generation components, a user interface (e.g., 618) for configuring the computer system to control the accessory based on orientation, wherein the user interface includes a non-selectable user interface element (e.g., 618b and/or 618e) corresponding to first set of one or more orientations (e.g., to the left or to the right of the accessory and/or an orientation range of between −10 and 10 degrees) (e.g., within a first predefined distance of the accessory) and a selectable user interface element (e.g., 618d and/or 618e) corresponding to a second set of one or more orientations (e.g., to the left or to the right of the accessory and/or an orientation range of between 10 to 90 degrees and/or −10 to −90 degrees) (e.g., within a second predefined distance (e.g., the first predefined distance or another predefined distance different from the first predefined distance) of the accessory) different from the first set of one or more orientations, wherein the selectable user interface element is separate from the non-selectable user interface element, and wherein the user interface does not include a selectable user interface element corresponding to the first set of one or more orientations. In some embodiments, while displaying the user interface including the non-selectable user interface element and the selectable user interface element, the computer system detects, via the one or more input devices, an input (e.g., 618d) corresponding to the selectable user interface element. In some embodiments, after detecting the input corresponding to the selectable user interface element, in accordance with a determination that the input corresponding to the selectable user interface is an input to select the selectable user interface, the computer system configures (e.g., as described above with respect to FIGS. 6D-6G) the computer system to control the accessory in response to the computer system being at an orientation of the first set of one or more orientations (e.g., within the first predefined distance of the accessory) and the second set of one or more orientations (e.g., within the second predefined distance of the accessory) (e.g., without detecting, via the one or more input devices, an input and/or without authentication of a user). In some embodiments, the first set of one or more orientations includes the first orientation. In some embodiments, the second set of one or more orientations includes the first orientation (e.g., in accordance with the determination that the input corresponding to the selectable user interface is an input to select the selectable user interface). In some embodiments, after detecting the input corresponding to the selectable user interface element, in accordance with a determination that the input corresponding to the selectable user interface element is an input to deselect the selectable user interface, the computer system configures (e.g., as described above with respect to FIGS. 6D-6G) the computer system to control the accessory in response to the computer system being at an orientation of the first set of one or more orientations (e.g., within the first predefined distance of the accessory) without configuring the computer system to control the accessory in response to the computer system being at an orientation of the second set of one or more orientations (e.g., within the second predefined distance of the accessory) (e.g., the first set of one or more orientations is not able to be disabled) (e.g., without detecting, via the one or more input devices, an input and/or without authentication of a user). In some embodiments, after detecting the input corresponding to the selectable user interface element and in accordance with the determination that the input corresponding to the selectable user interface element is an input to deselect the selectable user interface, configuring the computer system to not control the accessory in response to the computer system being at an orientation of the second set of one or more orientations (e.g., within the second predefined distance of the accessory). Enabling a user to configure which orientations control an accessory while requiring certain orientations to always control the accessory when orientation is enabled allows the computer system to ensure that the accessory can always be controlled by orientation while allowing some customization, thereby providing additional control options without cluttering the user interface with additional displayed controls and/or performing an operation when a set of conditions has been met without requiring further user input.

In some embodiments, the first set of one or more criteria includes a criterion that is satisfied when the user is within a predefined distance (e.g., 0-10 feet) of the accessory. In some embodiments, the second set of one or more criteria includes a criterion that is satisfied when the user is not within the predefined distance of the accessory (e.g., as described above with respect to FIGS. 6G-6Q). Requiring a user be within a predefined distance of an accessory to automatically control the accessory ensures that the user intended to control the accessory, thereby increasing security and/or performing an operation when a set of conditions has been met without requiring further user input.

In some embodiments, after controlling the accessory in response to detecting the first orientation of the user relative to the accessory, the computer system detects, via the one or more input devices, an input (e.g., a selection input and/or a non-selection input) corresponding to a request to configure the computer system to not control the accessory in the first orientation. In some embodiments, the input corresponding to the request to configure the computer system to not control the accessory in the first orientation is an input on a selectable user interface element (e.g., an icon, a widget, a control, and/or a window) corresponding to a set of one or more orientations including the first orientation. In some embodiments, in response to detecting the input corresponding to the request to configure the computer system to not control the accessory in the first orientation, the computer system configures the computer system to not control the accessory in the first orientation. In some embodiments, after configuring the computer system to not control the accessory in the first orientation (and/or while the computer system is configured to not control the accessory in the first orientation), the computer system detects, via the one or more input devices, a second orientation of the user relative to the accessory, wherein the second orientation is the same as the first orientation. In some embodiments, in response to detecting the second orientation of the user relative to the accessory, the computer system forgoes control of the accessory. In some embodiments, after forgoing control of the accessory in response to detecting the first orientation of the user relative to the accessory, the computer system detects, via the one or more input devices, an input (e.g., a selection input and/or a non-selection input) corresponding to a request to configure the computer system to control the accessory in the first orientation. In some embodiments, the input corresponding to the request to configure the computer system to control the accessory in the first orientation is an input on a selectable user interface element (e.g., an icon, a widget, a control, and/or a window) corresponding to a set of one or more orientations including the first orientation. In some embodiments, in response to detecting the input corresponding to the request to configure the computer system to control the accessory in the first orientation, configuring the computer system to control the accessory in the first orientation. In some embodiments, after configuring the computer system to control the accessory in the first orientation (and/or while the computer system is configured to control the accessory in the first orientation), the computer system detects, via the one or more input devices, another orientation of the user relative to the accessory. In some embodiments, the other orientation is the same as the first orientation. In some embodiments, in response to detecting the other orientation of the user relative to the accessory, the computer system controls the accessory without detecting, via the one or more input devices, an input. Enabling a user to change which orientations work for automatically controlling an accessory allows the user to configure control of the accessory by their orientation to the accessory, thereby reducing the number of inputs needed to perform an operation and/or providing additional control options without cluttering the user interface with additional displayed controls.

In some embodiments, the accessory is a lock (e.g., a computer system configured to lock and unlock a lock, a different computer system than the computer system, a smart lock, and/or a door) (e.g., 612). In some embodiments, the lock is a physical lock for locking a physical door, a window, and/or an opening.

In some embodiments, the first orientation of the user relative to the accessory is detected while the accessory is in a locked state (e.g., physically locked, mechanically and/or digitally prevented from revealing contents, and/or restricted) (e.g., as illustrated by and discussed with respect to 614 in FIG. 6B). Controlling an accessory while the accessory is in a locked state enables a user a quick way to control the accessory even when the accessory is in the locked state, thereby reducing the number of inputs needed to perform an operation and/or performing an operation when a set of conditions has been met without requiring further user input.

In some embodiments, the first orientation of the user relative to the accessory is detected while the computer system is in a locked state (e.g., digitally restricted from displaying content and/or prevented from displaying an application and/or home screen corresponding to the computer system) (e.g., 626 and/or as described with respect to FIGS. 6H-6L and 6O-6Q). Controlling an accessory while the computer system is in a locked state enables a user a quick way to control the accessory even when the computer system is in the locked state, thereby reducing the number of inputs needed to perform an operation and/or performing an operation when a set of conditions has been met without requiring further user input.

In some embodiments, controlling the accessory includes sending, to the accessory, a request (e.g., an instruction and/or a command) to unlock (e.g., changing from a locked state to an unlocked state, and/or removing restrictions to access one or more contents of) (e.g., as described above with respect to 614 in FIG. 6I) the accessory.

In some embodiments, the first orientation of the user relative to the accessory is an orientation of the computer system relative to the accessory. In some embodiments, the computer system is at the same location and/or being carried by the user.

In some embodiments, the computer system is in communication with one or more display generation components (e.g., a display screen, a projector, and/or a touch-sensitive display). In some embodiments, controlling the accessory includes performing, via the accessory, a first operation (e.g., sends, to the accessory, a command and/or causes an operation to be performed by the accessory). In some embodiments, after (e.g., in response to and/or while) controlling the accessory without detecting, via the one or more input devices, an input, the computer system displays, via the one or more display generation components, a user interface element (e.g., an icon, a widget, a control, and/or a window) (e.g., 632 and/or 632c) corresponding to the accessory. In some embodiments, while displaying the user interface element corresponding to the accessory, the computer system detects, via the one or more input devices, an input (e.g., a selection input and/or a non-selection input) (e.g., 605j) corresponding to the user interface element corresponding to the accessory. In some embodiments, in response to detecting the input corresponding to the user interface element corresponding to the accessory, the computer system performs, via the accessory, a second operation that reverses the first operation (e.g., if the first operation unlocks the accessory, the second operation locks the accessory) (e.g., as described above with respect to FIG. 6J). Displaying a user interface element to reverse an operation performed automatically enables a user a quick way to reverse something that they did not intend to do, thereby reducing the number of inputs needed to perform an operation and/or reducing the number of inputs needed to perform an operation.

In some embodiments, after forgoing control of the accessory in response to detecting the first orientation of the user relative to the accessory (and/or while the computer system is configured to control the accessory in a second manner as described above with respect to process 700), the computer system detects (e.g., via the one or more input devices, via the one or more sensors, and/or via the communication channel) a proximity of the accessory relative to the computer system (e.g., as described above with respect to FIG. 6M). In some embodiments, the proximity is a distance and/or closeness. In some embodiments, the proximity includes a threshold distance (e.g., 1 inch to 0.1 mm) of the accessory to the computer system. In some embodiments, the proximity is determined by a location (e.g., coordinate and/or position) in a physical environment. In some embodiments, the proximity is determined based on presence, near-field communication, and/or short radio wave without detecting the physical position of the computer system in the environment. In some embodiments, the proximity is between the location of the accessory and the location of the computer system within a defined area of positions. In some embodiments, in response to detecting the proximity of the accessory relative to the computer system (and/or regardless of an orientation of the user relative to the accessory), the computer system controls (e.g., as described above with respect to FIG. 6M) the accessory without detecting, via the one or more input devices, an input. Enabling proximity in addition to orientation to automatically control an accessory allows a user different ways to control the accessory, thereby performing an operation when a set of conditions has been met without requiring further user input.

In some embodiments, the determination that the first orientation of the user relative to the accessory satisfies the first set of one or more criteria includes a determination that a direction of movement of the user relative to the accessory is a first direction (e.g., between 0 and 180 degrees of the accessory and/or a direction by which a distance between the accessory and the computer system is changing) (e.g., the user is approaching the accessory) (e.g., as described above with respect to FIGS. 6H-6L). In some embodiments, the determination that the first orientation of the user relative to the accessory satisfies the second set of one or more criteria includes a determination that the direction of movement of the user relative to the accessory is a second direction (e.g., the user is not approaching the accessory) different from the first direction. Using a direction of movement of a user relative to an accessory to determine whether to automatically control the accessory reduces likelihood of accidentally controlling the accessory, thereby increasing security and/or performing an operation when a set of conditions has been met without requiring further user input.

Note that details of the processes described above with respect to process 800 (e.g., FIG. 8) are also applicable in an analogous manner to other processes described herein. For example, process 900 optionally includes one or more of the characteristics of the various processes described above with reference to process 800. For example, the first list of one or more entities of method 400 can include the identification of the first user interface object of method 500. For brevity, these details are not repeated herein.

FIG. 9 is a flow diagram illustrating a process (e.g., process 900) for surfacing a control in accordance with some embodiments. Some operations in process 900 are, optionally, combined, the orders of some operations are, optionally, changed, and some operations are, optionally, omitted.

As described below, process 900 provides an intuitive way for surfacing a control. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 600) that is in communication (e.g., wired communication and/or wireless communication) with one or more input devices (e.g., a sensor, a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

In response to automatically unlocking a lock (e.g., a computer system configured to lock and unlock a lock, a smart lock, and/or a door lock) (and/or a device, such as a personal computing device and/or an accessory) (e.g., as described above with respect to FIG. 6I), the computer system displays (902), via the one or more display generation components, a user interface element (e.g., a selectable user interface element to lock the lock, an icon, a widget, a control, and/or a window) (e.g., 630, 630b, 632, and/or 632c) corresponding to the lock (e.g., without previously displaying a user interface element corresponding to sending, to the lock, a request to unlock and/or without previously displaying the user interface element corresponding to the lock and/or another user interface element corresponding to the lock). In some embodiments, automatically unlocking includes sending, to the lock, a request to unlock without detecting, via the one or more input devices, an input (e.g., a tap input and/or a non-tap input (e.g., a verbal input, an audible request, an audible command, an audible statement, a swipe input, a hold-and-drag input, a gaze input, an air gesture, mouse movement, and/or a mouse click)) (and/or without detecting, via the one or more input devices, any input including the input). In some embodiments, the user interface element corresponding to the lock is displayed on a lock screen. In some embodiments, the user interface element corresponding to the lock is displayed while displaying a user interface corresponding to an application unrelated to the lock. In some embodiments, the user interface element corresponding to the lock is a live activity. In some embodiments, the user interface element corresponding to the lock is displayed in a notification.

While displaying the user interface element corresponding to the lock, the computer system detects (904), via the one or more input devices, an input (e.g., a selection input and/or a non-selection input) (e.g., 605i2 and/or 605j) corresponding to (e.g., at) the user interface element. In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, the input corresponding to the user interface element includes a selection of a button corresponding to the lock. In some embodiments, the input corresponding to the request to display the user interface element includes a voice input corresponding to the lock (e.g., “lock the lock”).

In response to detecting the input corresponding to the user interface element, the computer system sends (906), to the lock, a request to lock (e.g., as described above with respect to FIGS. 6I-J). Displaying a user interface element to lock a lock in response to automatically unlocking the lock allows the computer system to provide a quick way to reverse an automatic operation, thereby performing an operation when a set of conditions has been met without requiring further user input and/or reducing the number of inputs needed to perform an operation.

In some embodiments, in conjunction with (e.g., while, after, and/or in response to) automatically unlocking the lock, the computer system displays, via the one or more display generation components, an indication (e.g., 630, 630b, 632, and/or 632b) that the lock was automatically unlocked (and/or that the lock was unlocked) (e.g., while displaying the user interface element corresponding to the lock). In some embodiments, the user interface element corresponding to the lock includes the indication that the lock was automatically unlocked. In some embodiments, the indication that the lock was automatically unlocked is separate from the user interface element corresponding to the lock. Displaying an indication that a lock was automatically unlocked in conjunction with automatically unlocking the lock allows the computer system to indicate when the computer system has automatically performed an operation, thereby performing an operation when a set of conditions has been met without requiring further user input and/or providing improved visual feedback to the user.

In some embodiments, in conjunction with (e.g., while, after, and/or in response to) detecting the input corresponding to the user interface element (and/or in conjunction with sending the request to lock and/or in response to a determination that the lock is locked in response to receiving the request to lock), the computer system displays, via the one or more display generation components, an indication (e.g., 632b in FIG. 6L) that the lock was locked (e.g., while displaying the user interface element corresponding to the lock). In some embodiments, the user interface element corresponding to the lock includes the indication that the lock was locked. In some embodiments, the user interface element corresponding to the lock is separate from the indication that the lock was locked. Displaying an indication that a lock was locked in conjunction with detecting an input to lock the lock allows the computer system to indicate when the computer system has automatically performed an operation, thereby performing an operation when a set of conditions has been met without requiring further user input and/or providing improved visual feedback to the user.

In some embodiments, in conjunction with (e.g., while, after, and/or in response to) automatically unlocking the lock, the computer system displays, via the one or more display generation components, an identification (e.g., name, brand, and/or model) (e.g., 630a, 632a, and/or 632b) of the lock (e.g., while displaying the user interface element corresponding to the lock). In some embodiments, the user interface element corresponding to the lock includes the identification of the lock. In some embodiments, the user interface element corresponding to the lock is separate from the identification of the lock. Displaying an identification of a lock in conjunction with automatically unlocking the lock allows the computer system to indicate when the computer system has automatically performed an operation, thereby performing an operation when a set of conditions has been met without requiring further user input and/or providing improved visual feedback to the user.

In some embodiments, the user interface element corresponding to the lock is not displayed when automatically locking the lock. In some embodiments, the user interface element corresponding to the lock is not displayed when manually unlocking the lock. In some embodiments, the user interface element corresponding to the lock is not displayed when manually locking the lock. In some embodiments, in response to automatically locking the lock, the computer system forgoes display of an indication that the lock was locked (and/or automatically locked). In some embodiments, in response to automatically locking the lock, the computer system forgoes display of the user interface element corresponding to the lock. In some embodiments, in response to automatically locking the lock, the computer system displays, via the one or more display generation components, the user interface element corresponding to the lock. In some embodiments, in response to manually locking the lock, the computer system forgoes display of an indication that the lock was locked (and/or manually locked). In some embodiments, in response to manually locking the lock, the computer system forgoes display of the user interface element corresponding to the lock. In some embodiments, in response to manually locking the lock, the computer system displays, via the one or more display generation components, the user interface element corresponding to the lock. In some embodiments, in response to manually unlocking the lock, the computer system forgoes display of an indication that the lock was unlocked (and/or manually unlocked). In some embodiments, in response to manually unlocking the lock, the computer system forgoes display of the user interface element corresponding to the lock. In some embodiments, in response to manually unlocking the lock, the computer system displays, via the one or more display generation components, the user interface element corresponding to the lock. Only automatically displaying a user interface to change a state of a lock when the lock was automatically locked allows the computer system to surface controls when it is possible that a user did not want an operation to automatically be performed, thereby increasing security and/or performing an operation when a set of conditions has been met without requiring further user input

In some embodiments, before displaying the user interface element corresponding to the lock and while the lock is locked, the computer system detects, via the one or more input devices, a respective orientation (and/or a position and/or a location) of a user (e.g., a person and/or the computer system) relative to the lock. In some embodiments, in response to detecting the respective orientation of the user relative to the lock, in accordance with a determination that the respective orientation is a first orientation, the computer system automatically unlocks the lock. In some embodiments, in response to detecting the respective orientation of the user relative to the lock, in accordance with a determination that the respective orientation is a second orientation, the computer system forgoes automatically unlocking the lock (and/or maintaining the lock being locked). In some embodiments, the first orientation is not a center orientation. In some embodiments, the first orientation is a center orientation. In some embodiments, the first orientation is to the left or to the right of the lock. Automatically unlocking a lock when a user is in particular orientations relative to the lock allows the computer system to predict and/or anticipate needs of the user, thereby performing an operation when a set of conditions has been met without requiring further user input.

In some embodiments, the respective orientation is a first respective orientation. In some embodiments, in response to detecting the input corresponding to the user interface element (and/or while sending the request to lock), the computer system configures the computer system to no longer automatically unlock the lock in response to detecting the first respective orientation (e.g., the first orientation) of the user relative to the lock (e.g., while the computer system continues to be configured to automatically unlock the lock in response to detecting another orientation, different from the respective orientation, of the user relative to the lock). In some embodiments, after configuring the computer system to no longer automatically unlock the lock in response to detecting the first respective orientation of the user relative to the lock, the computer system detects, via the one or more input devices, a second respective orientation of the user relative to the lock. In some embodiments, in response to detecting the second respective orientation of the user relative to the lock, in accordance with a determination that the second respective orientation is the first respective orientation, the computer system forgoes automatically unlocking the lock. In some embodiments, in response to detecting the orientation of the user relative to the lock and in accordance with the determination that the orientation of the user relative to the lock is the third orientation, the computer system displays, via the one or more display generation components, a user interface element (e.g., an icon, a widget, a control, and/or a window) corresponding to an indication the computer system has forgone control of the lock. In some embodiments, in response to detecting the second respective orientation of the user relative to the lock, in accordance with a determination that the second respective orientation is a fourth orientation different from the first respective orientation (e.g., while the computer system is configured to automatically unlock the lock in response to detecting the fourth orientation), the computer system automatically unlocks the lock. Configuring the computer system to no longer automatically unlock a lock with certain orientations that previously unlocked the lock allows the computer system to adapt to interactions by users, thereby reducing the number of inputs needed to perform an operation and/or performing an operation when a set of conditions has been met without requiring further user input.

In some embodiments, the computer system is in a locked state (e.g., a state that requires a password and/or other information to be entered before the computer system can transition into an unlocked state and/or a state that is more secure, less functional, and/or include less information than another state in which the computer system can operate) (e.g., 626 and/or as described with respect to FIGS. 6H-6L and 6O-6Q) while detecting the respective orientation of the user relative to the lock. Automatically unlocking a lock when the computer system is in a locked state allows a user access to functionality without requiring unlocking the computer system, thereby reducing the number of inputs needed to perform an operation and/or performing an operation when a set of conditions has been met without requiring further user input.

In some embodiments, in response to automatically locking the lock, the computer system displays, via the one or more display generation components, an indication (e.g., a graphical indication, image, symbol, an/or text) that the lock was automatically locked. Displaying an indication that a lock was automatically locked in response to automatically locking the lock allows the computer system to provide indications when automations are performed in case a user would like to reverse those automations, thereby reducing the number of inputs needed to perform an operation and/or performing an operation when a set of conditions has been met without requiring further user input.

In some embodiments, in response to automatically locking the lock, the computer system forgoes display of a selectable user interface element to unlock the lock. Not displaying a selectable user interface element to unlock a lock in response to automatically locking the lock allows the computer system to provide notifications to a user with every automation, thereby performing an operation when a set of conditions has been met without requiring further user input and/or providing improved visual feedback to the user.

In some embodiments, the input corresponding to the user interface element is an input of a first type. In some embodiments, the input of the first type is a tap input. In some embodiments, while displaying the user interface element corresponding to the lock (and/or before detecting the input corresponding to the user interface element), the computer system detects, via the one or more input devices, an input (e.g., a selection input and/or a non-selection input) (e.g., 605i1) of a second type (e.g., over a threshold period of time and/or a continuous input), different from the first type, corresponding to the user interface element. In some embodiments, the input of the second type is a press and hold input. In some embodiments, in response to detecting the input of the second type corresponding to the user interface element, the computer system displays, via the one or more display generation components, the user interface element changing from a first size (e.g., as illustrated by 630 in FIG. 6I) to a second size (e.g., as illustrated by 632 in FIG. 6J) different from (e.g., smaller or larger than) the first size. In some embodiments, changing the user interface element corresponding to the lock from the first size to the second size maintains a position of at least a portion of the user interface element. In some embodiments, in response to detecting an input of a third type different from the second type (an/or the first type) corresponding to the user interface element (e.g., an input at a different location than the input of the first type), the computer system displays, via the one or more display generation components, a user interface of an application. In some embodiments, the application corresponds to the user interface element. Expanding a user interface element in response to detecting a particular type of input allows the computer system to provide information in a different manner when detecting certain inputs, thereby performing an operation when a set of conditions has been met without requiring further user input and/or providing improved visual feedback to the user.

In some embodiments, the input corresponding to the user interface element is detected at a first location of the user interface element. In some embodiments, while displaying the user interface element corresponding to the lock (and/or before detecting the input corresponding to the first location of the user interface element and/or after sending the request to lock), the computer system detects, via the one or more input devices, an input (e.g., a selection input and/or a non-selection input) (e.g., 605i1) corresponding to a second location, different from the first location, of the user interface element. In some embodiments, the input corresponding to the second location of the user interface element is a tap input at the second location. In some embodiments, in response to detecting the input corresponding to the second location of the user interface element, the computer system displays, via the one or more display generation components, a user interface (e.g., 624 and/or 640) of a home application (e.g., without sending, to the lock, a request to lock or unlock). In some embodiments, the user interface of the home application includes information corresponding to the lock. In some embodiments, the user interface of the home application includes the user interface element and/or another user interface element to lock or unlock the lock. Performing different operations depending on where in a user interface element an input is detected allows the computer system to allow for different operations to be performed using a single user interface element, thereby performing an operation when a set of conditions has been met without requiring further user input and/or providing additional control options without cluttering the user interface with additional displayed controls.

In some embodiments, before displaying the user interface element corresponding to the lock and while the lock is locked, the computer system detects a position (e.g., an orientation and/or a location) of a user relative to the lock. In some embodiments, in response to detecting the position of the user relative to the lock, in accordance with a determination that the position of the user relative to the lock satisfies a first set of one or more criteria (e.g., that the position is within a predefined distance and/or in a particular orientation) (e.g., as described above with respect to process 700) (e.g., as described above with respect to FIG. 6I), the computer system automatically unlocks (e.g., as described above with respect to FIG. 6I) the lock. In some embodiments, in response to detecting the position of the user relative to the lock, in accordance with a determination that the position of the user relative to the lock satisfies a second set of one or more criteria, the computer system forgoes automatically (e.g., as described above with respect to FIG. 6H) unlocking the lock (and/or maintains the lock being locked). In some embodiments, in response to detecting the position of the user relative to the lock and in accordance with the determination that the position of the user relative to the lock satisfies the second set of one or more criteria, the computer system outputs, via one or more output devices, an indication that the computer system has not automatically unlocked the lock. Automatically unlocking a lock based on a position of a user relative to the lock allows the computer system to predict when the user is likely to want the lock unlocked and perform such without requiring additional user input, thereby performing an operation when a set of conditions has been met without requiring further user input and/or reducing the number of inputs needed to perform an operation.

In some embodiments, in response to unlocking (e.g., manually and/or automatically unlocking) the lock in a respective manner (e.g., as described above with respect to process 700), in accordance with a determination that the respective manner is a first manner (e.g., the first manner, the second manner, or the third manner as described above with respect to process 700), the computer system unlocks (e.g., automatically or manually unlocks) the lock while displaying the user interface element corresponding to the lock. In some embodiments, in response to unlocking the lock in the respective manner, in accordance with a determination that the respective manner is a second manner different from the first manner, the computer system unlocks (e.g., automatically or manually unlocks) the lock without displaying the user interface element corresponding to the lock. Not showing a user interface element to lock a lock in response to unlocking the lock in a different manner (e.g., different from automatically unlocking as described above) allows the computer system to predict when a user is likely to want to lock the lock and provide such controls at that time, thereby performing an operation when a set of conditions has been met without requiring further user input.

Note that details of the processes described above with respect to process 900 (e.g., FIG. 9) are also applicable in an analogous manner to other processes described herein. For example, process 1000 optionally includes one or more of the characteristics of the various processes described above with reference to process 900. For example, the automatically unlocking of method 1000 can correspond to the controlling of method 900. For brevity, these details are not repeated herein.

FIG. 10 is a flow diagram illustrating a process (e.g., process 1000) for notifying users of a current context in accordance with some embodiments. Some operations in process 1000 are, optionally, combined, the orders of some operations are, optionally, changed, and some operations are, optionally, omitted.

As described below, process 1000 provides an intuitive way for notifying users of a current context. Process 1000 reduces the cognitive burden on a user, thereby creating a more efficient human-machine interface. For battery-operated computing devices, enabling a user to interact with such devices faster and more efficiently conserves power and increases the time between battery charges.

In some embodiments, process 1000 is performed at a computer system (e.g., 600) that is in communication (e.g., wired communication and/or wireless communication) with one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system detects (1002) (e.g., via one or more input devices (e.g., a camera, a depth sensor, a microphone, a hardware input mechanism, a rotatable input mechanism, a heart monitor, a temperature sensor, and/or a touch-sensitive surface) of the computer system and/or via an application of the computer system) a request (e.g., 605f, 605i1, 605ae, and/or 605an) to display (and/or update display of) a user interface element (e.g., an icon, a widget, a control, and/or a user interface) (e.g., 640, 668, 670, 672, and/or 676) corresponding to one or more accessories (e.g., another computer system different from the computer system, a smart lock, a light, a speaker, a television, and/or a door lock) (e.g., as described above with respect to FIGS. 6AE, 6AF, 6AG, 6AH, 6AI, 6AN, and/or 6AN). In some embodiments, detecting the request to display the user interface element corresponding to the one or more accessories includes detecting, via the one or more input devices, an input (e.g., a selection input and/or a non-selection input) corresponding to the request to display the user interface element corresponding to the one or more accessories. In some embodiments, a selection input includes a tap input, a verbal input, an audible command, a gaze input, an air gesture, a mouse click, and/or a submission of a user-interface element and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, the input corresponding to the request to display the user interface element includes a selection of a home application of the computer system. In some embodiments, the input corresponding to the request to display the user interface element includes a voice input to display the user interface element (e.g., “display the home application”).

In response to (1004) detecting the request to display a user interface element corresponding to the one or more accessories, in accordance with a determination that a first set of one or more criteria (e.g., context, dates of approved access, and/or locations of approved access) is satisfied with respect to a current context (e.g., a current state of at least one accessory of the one or more accessories, a current location (e.g., coordinates and/or position in a physical environment) of the computer system, and/or a current time of the computer system) (e.g., as described above with respect to FIGS. 6U-6AO), the computer system displays (1006), via the one or more display generation components, a first user interface element (e.g., 640, 668, 670, 672, and/or 676) with information corresponding to the one or more accessories (e.g., as illustrated in FIG. 6AF and/or 6AO).

In response to (1004) detecting the request to display the user interface element corresponding to the one or more accessories, in accordance with a determination that a second set of one or more criteria is satisfied with respect to the current context, the computer system displays (1008), via the one or more display generation components, a second user interface element (e.g., 640, 668, 670, 672, and/or 676) without information corresponding to the one or more accessories (e.g., 640, 668, 670, 672, and/or 676) (e.g., as illustrated in FIGS. 6AG, 6AH, 6AI, and/or 6AK). Selectively displaying information corresponding to one or more accessories depending on a current context allows a user managing the one or more accessories to control when others are able to view information about the one or more accessories, thereby increasing security and/or performing an operation when a set of conditions has been met without requiring further user input.

In some embodiments, the current context is a current time (e.g., as described above with respect to FIG. 6AH). A current context for determining whether to display information corresponding to one or more accessories being a current time allows a user managing the one or more accessories to control when others are able to view information about the one or more accessories, thereby increasing security and/or performing an operation when a set of conditions has been met without requiring further user input.

In some embodiments, the current context is a current location (e.g., coordinates and/or position in a physical environment) of the computer system (e.g., as described above with respect to FIG. 6AI and/or 6AK). A current context for determining whether to display information corresponding to one or more accessories being a current location of the computer system allows a user managing the one or more accessories to control when others are able to view information about the one or more accessories, thereby increasing security and/or performing an operation when a set of conditions has been met without requiring further user input.

In some embodiments, the first user interface element (and/or the information) includes a control (e.g., 668b and/or 676) for a first accessory of the one or more accessories. In some embodiments, in response to detecting (e.g., via one or more input devices (e.g., a camera, a depth sensor, a microphone, a hardware input mechanism, a rotatable input mechanism, a heart monitor, a temperature sensor, and/or a touch-sensitive surface) of the computer system and/or via an application of the computer system) an input (e.g., a selection input and/or a non-selection input) corresponding to a request to select the control for the first accessory of the one or more accessories, the computer system causes the first accessory to perform an operation and/or the computer system displays, via the one or more display generation components, an indication (e.g., a graphical indication, image, symbol, and/or text) of a current state of the first accessory. A user interface element including a control for an accessory when the computer system is allowed to control the accessory allows a user to only see the control when they are able to use it, thereby performing an operation when a set of conditions has been met without requiring further user input and/or providing improved visual feedback to the user.

In some embodiments, the first user interface element (and/or the information) includes an indication of a current state (e.g., on state, off state, lock state, and/or low-power state) (e.g., “locked,” “unlocked,” and/or icon of lock as described and/or illustrated with respect to FIGS. 6AF, 6AN, and/or 6AO) of a second accessory of the one or more accessories. A user interface element including an indication of a state of an accessory when the computer system is allowed to control the accessory allows a user to only see the current state when they are able to use it, thereby performing an operation when a set of conditions has been met without requiring further user input and/or providing improved visual feedback to the user.

In some embodiments, in response to detecting the request to display a user interface element corresponding to the one or more accessories and in accordance with the determination that the second set of one or more criteria is satisfied with respect to the current context (and/or while displaying the second user interface element), the computer system displays, via the one or more display generation components, a control (e.g., an affordance, a button, and/or an add user interface element) (e.g., 668d, 668f, and/or 678b) for contacting a user (e.g., an owner, a user that invited a user of the computer system to a home including the one or more accessories, and/or a resident of a home including the one or more accessories) of the one or more accessories. In some embodiments, in response to detecting (e.g., via one or more input devices (e.g., a camera, a depth sensor, a microphone, a hardware input mechanism, a rotatable input mechanism, a heart monitor, a temperature sensor, and/or a touch-sensitive surface) of the computer system and/or via an application of the computer system) an input (e.g., a selection input and/or a non-selection input) corresponding to the control for contacting the user of the one or more accessories, the computer system displays, via the one or more display generation components, a communication user interface (e.g., of an email application, a messaging application, a calling application, and/or a contacts application) and/or an indication (e.g., a graphical indication, image, symbol, and/or text) that the computer system sent a request to contact the user of the one or more accessories (e.g., a sent message and/or a sent email). Displaying a control for contacting a user of one or more accessories allows the computer system to provide a way for contacting the user to change restrictions put on by the user, thereby reducing the number of inputs needed to perform an operation and/or performing an operation when a set of conditions has been met without requiring further user input.

In some embodiments, the computer system is in communication with one or more input devices (e.g., a camera, a depth sensor, a microphone, a hardware input mechanism, a rotatable input mechanism, a heart monitor, a temperature sensor, and/or a touch-sensitive surface). In some embodiments, while displaying the control for contacting the user of the one or more accessories, the computer system detects, via the one or more input devices, an input (e.g., a selection input and/or a non-selection input) (e.g., 605aj2 and/or 605ak) corresponding to the control for contacting the user of the one or more accessories. In some embodiments, the input corresponding to the control for contacting the user of the one or more accessories is a tap input on the control. In some embodiments, the input corresponding to the control for contacting the user of the one or more accessories is a tap input on a representation of a messaging application of the computer system. In some embodiments, in response to (and/or after) detecting input corresponding to the control for contacting the user of the one or more accessories, the computer system displays, via the one or more display generation components, a user interface (e.g., 680) of a messaging application. In some embodiments, the user interface of the messaging application includes an icon, a widget, a control, and/or a text entry field of the messaging application. In some embodiments, the user interface of the messaging application includes pre-filled content (e.g., text and/or images) corresponding to a request to control the one or more accessories (and/or to have access to first user interface element). Displaying a user interface of a messaging application in response to detecting an input corresponding to a control for contacting a user allows the computer system to provide a way for contacting the user from another application, thereby performing an operation when a set of conditions has been met without requiring further user input and/or reducing the number of inputs needed to perform an operation.

In some embodiments, the first user interface element is displayed within a user interface of a home application. In some embodiments, the home application allows for control of one or more accessory devices. A user interface element with information corresponding to one or more accessories being within a user interface that manages the one or more accessories allows the computer system to group similar functionality together, thereby reducing the number of inputs needed to perform an operation and/or providing improved visual feedback to the user.

In some embodiments, the first user interface element is displayed within a user interface of a watch (e.g., as a watch complication and/or watch widget). A user interface element with information corresponding to one or more accessories being within a user interface of a watch allows a user to access such functionality from their wrist without requiring to take out their phone, thereby providing improved visual feedback to the user.

In some embodiments, while displaying the first user interface element, the computer system detects a change in a current context (e.g., an updated state of at least one accessory of the one or more accessories, an updated location (e.g., coordinates and/or position in a physical environment) of the computer system, and/or a current time of the computer system). In some embodiments, in response to detecting the change in the current context (and/or in accordance with a determination that the second set of one or more criteria is satisfied with respect to the current context), the computer system displays, via the one or more display generation components, the second user interface element without information corresponding to the one or more accessories. In some embodiments, in response to detecting the change in the current context, the computer system ceases display of the first user interface element with information corresponding to the one or more accessories. In some embodiments, while displaying the second user interface element, the computer system detects a change in a current context (e.g., an updated state of at least one accessory of the one or more accessories, an updated location (e.g., coordinates and/or position in a physical environment) of the computer system, and/or a current time of the computer system). In some embodiments, in response to detecting the change in the current context (and/or in accordance with a determination that the first set of one or more criteria is satisfied with respect to the current context), the computer system displays, via the one or more display generation components, the first user interface element with information corresponding to the one or more accessories. In some embodiments, in response to detecting the change in the current context, the computer system ceases display of the second user interface element without information corresponding to the one or more accessories. Removing or adding display of information corresponding to one or more accessories depending on a current context allows the computer system to update based on changes that allow for different operations to occur, thereby performing an operation when a set of conditions has been met without requiring further user input and/or reducing the number of inputs needed to perform an operation.

In some embodiments, the one or more accessories is established for a network (e.g., a home, a building, an office, and/or a group of one or more accessories) (e.g., the same network, associated with the same user account, and/or within a threshold distance of a particular location). In some embodiments, the computer system has access to the one or more accessories via the network and/or in response to having permission to access the network.

In some embodiments, the one or more accessories includes a plurality of accessories.

In some embodiments, the one or more accessories consists of a single accessory.

In some embodiments, the second user interface element does not include an identification (e.g., a name, a device model, and/or brand) of an accessory of the one or more accessories. Not displaying an identification of an accessory while the computer system is not able to control the accessory allows such information to be protected outside of times or areas that the computer system is able to control the accessory, thereby increasing security and/or performing an operation when a set of conditions has been met without requiring further user input.

In some embodiments, the first user interface element includes an identification (e.g., a name, a device model, and/or brand) (e.g., “front door” as illustrated in FIG. 6AF) of an accessory of the one or more accessories. A user interface including an identification of an accessory while the computer system is able to control the accessory allows such information to be provided when the computer system is able to control the accessory, thereby increasing security and/or performing an operation when a set of conditions has been met without requiring further user input.

In some embodiments, the first user interface element is displayed while the computer system is in a locked state (e.g., 626 and/or as described with respect to FIGS. 6H-6L and 6O-6Q). In some embodiments, a locked state is a state that requires a password and/or other information to be entered before the computer system can transition into an unlocked state and/or a state that is more secure, less functional, and/or include less information than another state in which the computer system can operate. A user interface including information corresponding to one or more accessories being accessible while the computer system is in a locked state allows a user to access such information without requiring the user unlock the computer system, thereby performing an operation when a set of conditions has been met without requiring further user input.

In some embodiments, the first user interface element is displayed while the computer system is in an unlocked state (e.g., 640, 668, 670, 672, and/or 676). In some embodiments, an unlocked state is a state that is less secure, has more function, and/or includes more information than a locked state that is a state that requires a password and/or other information before the computer system can transition into the unlocked state. A user interface including information corresponding to one or more accessories being accessible while the computer system is in an unlocked state allows a user to access such information after requiring the user unlock the computer system, thereby increasing security and/or performing an operation when a set of conditions has been met without requiring further user input.

Note that details of the processes described above with respect to process 1000 (e.g., FIG. 10) are also applicable in an analogous manner to other processes described herein. For example, process 1100 optionally includes one or more of the characteristics of the various processes described above with reference to process 1000. For example, the one or more accessories of method 1100 can include the lock of method 1000. For brevity, these details are not repeated herein.

FIG. 11 is a flow diagram illustrating a process (e.g., process 1100) for distinguishing types of users in accordance with some embodiments. Some operations in process 1100 are, optionally, combined, the orders of some operations are, optionally, changed, and some operations are, optionally, omitted.

As described below, process 1100 provides an intuitive way for distinguishing types of users. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a computer system (e.g., 600) that is in communication (e.g., wired communication and/or wireless communication) with one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system receives (1102) (e.g., detects, via one or more input devices of the computer system, an input (e.g., a selection input and/or a non-selection input) corresponding to and/or receives, via an application of the computer system) a request (e.g., 605ad, 605ae, and/or 605am) to display a user interface (e.g., 668 and/or 670) of an accessory management application (e.g., a home application, a smart accessory application, and/or a security accessory application). In some embodiments, the input is an tap input on a user interface element (e.g., an icon, a widget, a control, and/or a window) corresponding to the accessory management application. In some embodiments, the computer system is in communication with a microphone (and/or the one or more input devices includes a microphone) and the input is a voice input, detected via the microphone, to open the accessory management application (e.g., “open the accessory management application”). In some embodiments, the accessory management application allows for control of accessories of and/or external devices different from the computer system. In some embodiments, the one or more input devices includes a camera, a depth sensor, a microphone, a hardware input mechanism, a rotatable input mechanism, a heart monitor, a temperature sensor, and/or a touch-sensitive surface.

In response to (1104) receiving the request to display the user interface of the accessory management application, in accordance with a determination that an invitation (e.g., a join request and/or participation offer) (e.g., 664) to join a space (e.g., a data structure corresponding to and/or including one or more accessories, a predefined space, a location, an abstraction of one or more accessories, a home, a commercial building, and/or a public space) of the accessory management application was received from a first user (e.g., a user account, and/or user of a computer system different from the computer system) (and/or that the user interface corresponds to the space) (e.g., “Steve” as described above), the computer system displays (1106), via the one or more display generation components, the user interface with an indication (e.g., an identification, a text, a graphical image, a symbol, and/or an animation) (e.g., “Invited by Steve”) of the first user and a user interface element (e.g., a representation, an indication, an identification, a graphical representation, an image, and/or a control) (e.g., 668b) of an accessory (e.g., a computer system configured to be controlled by the computer system, a light, a lock, a security system, a speaker, an appliance, and/or a thermostat) associated with the space of the accessory management application. In some embodiments, the user interface element is a control to control the accessory associated with the space of the accessory management application. In some embodiments, the user interface element includes status information corresponding to the accessory associated with the space of the accessory management application. In some embodiments, the user is a resident (e.g., full-time occupant, long-term presence invitee, and/or full access user) of the space. In some embodiments, the user is a guest (e.g., occasional visitor, short-term presence invitee, and/or temporary occupant) of the space.

In response to (1104) receiving the request to display the user interface of the accessory management application, in accordance with a determination that the invitation to join the space of the accessory management application was received from a second user (e.g., a user account, and/or user of a computer system different from the computer system) (and/or that the user interface corresponds to the space) (e.g., “John”) different from the first user, the computer system displays (1108), via the one or more display generation components, the user interface with an indication (e.g., an identification, a text, a graphical image, a symbol, and/or an animation) (e.g., “Invited by John”) of the second user and the user interface element (e.g., 668b) of the accessory associated with the space of the accessory management application. Displaying an indication of a user that invited a user of the computer system allows the computer system to indicate who restricted the computer system with respect to one or more accessories, thereby performing an operation when a set of conditions has been met without requiring further user input and/or providing improved visual feedback to the user.

In some embodiments, before (and/or while) receiving the request to display the user interface of the accessory management application, the computer system receives (e.g., via an application of the computer system and/or from the first user and/or the second user) the invitation to join the space of the accessory management application. Receiving an invitation to join a space before receiving a request to display a user interface corresponding to the space allows users managing the space to restrict how others can view information corresponding to the space, thereby increasing security and/or providing improved visual feedback to the user.

In some embodiments, the request to display the user interface of the accessory management application is a request to accept the invitation to join the space of the accessory management application. Displaying a user interface element of an accessory associated with a space in response to accepting an invitation to join the space allows a user to quickly access such information after joining the space, thereby reducing the number of inputs needed to perform an operation and/or reducing the number of inputs needed to perform an operation.

In some embodiments, after (and/or in response to) receiving the invitation to join the space of the accessory management application, the computer system displays, via the one or more display generation components, a representation (e.g., 664 and/or 666) of the invitation to join the space of the accessory management application, wherein the representation includes an indication (e.g., an identification, a text, a graphical image, a symbol, and/or an animation) (e.g., 666a) of one or more restrictions to control the accessory associated with the space of the accessory management application (and/or one or more additional accessories associated with the space). In some embodiments, the one or more restrictions to control the accessory includes a restriction on when the computer system is about to use and/or display a control for the accessory. In some embodiments, the representation of the invitation includes an indication (and/or identification) of the first user or an indication (and/or identification) of the second user (e.g., depending on which user sent the invitation). In some embodiments, the representation of the invitation includes an indication (and/or identification) of the accessory associated with the space of the accessory management application. In some embodiments, the representation of the invitation includes the user interface element of the accessory. In some embodiments, the one or more restrictions includes a time restriction (e.g., when the computer system has access) and/or a location restriction (e.g., where the computer system has access). In some embodiments, the user interface includes the indication (e.g., an identification, a text, a graphical image, a symbol, and/or an animation) of the one or more restrictions to control the accessory associated with the space of the accessory management application. A representation of an invitation to join a space including one or more restrictions for controlling accessories of the space allows a user to understand their restrictions if they accept the invitation, thereby reducing the number of inputs needed to perform an operation and/or providing improved visual feedback to the user.

In some embodiments, after (and/or in response to) receiving the invitation to join the space of the accessory management application, the computer system displays, via the one or more display generation components, a representation of the invitation to join the space of the accessory management application, wherein the representation includes an indication (e.g., an identification, a text, a graphical image, a symbol, and/or an animation) of one or more locations (e.g., coordinates and/or position in a physical environment) in which the computer system is able to control the accessory associated with the space of the accessory management application. In some embodiments, after joining the space of the accessory management application (and/or after displaying the user interface), the computer system receives (e.g., detects, via one or more input devices of the computer system, an input) another request to display the user interface of the accessory management application. In some embodiments, in response to receiving the other request to control the accessory associated with the space and in accordance with a determination that the computer system is at a first location (e.g., a location of the one or more locations) and/or that the invitation to join the space of the accessory management application was received from the first user, the computer system displays, via the one or more display generation components, the user interface with the indication of the first user and the user interface element of the accessory associated with the space of the accessory management application. In some embodiments, in response to receiving the other request to control the accessory associated with the space and in accordance with a determination that the computer system is at a second location (e.g., a location that is not one of the one or more locations), different from the first location, and/or that the invitation to join the space of the accessory management application was received from the first user, the computer system displays, via the one or more display generation components, the user interface with the indication of the first user without the user interface element of the accessory associated with the space of the accessory management application. In some embodiments, the user interface includes the indication of the one or more locations in which the computer system is able to control the accessory associated with the space of the accessory management application. A representation of an invitation to join a space including one or more locations in which the computer system is able to control accessories of the space allows a user to understand their restrictions if they accept the invitation, thereby reducing the number of inputs needed to perform an operation and/or providing improved visual feedback to the user.

In some embodiments, after (and/or in response to) receiving the invitation to join the space of the accessory management application, the computer system displays, via the one or more display generation components, a representation (e.g., 664 and/or 666) of the invitation to join the space of the accessory management application, wherein the representation includes an indication (e.g., an identification, a text, a graphical image, a symbol, and/or an animation) (e.g., 666a) of one or more times (e.g., a day and/or a time) in which the computer system is able to control the accessory associated with the space of the accessory management application. In some embodiments, after joining the space of the accessory management application (and/or after displaying the user interface), the computer system receives (e.g., detects, via one or more input devices of the computer system, an input) another request to display the user interface of the accessory management application. In some embodiments, in response to receiving the other request to control the accessory associated with the space and in accordance with a determination that a current time is at a first time (e.g., a time of the one or more times) and/or that the invitation to join the space of the accessory management application was received from the first user, the computer system displays, via the one or more display generation components, the user interface with the indication of the first user and the user interface element of the accessory associated with the space of the accessory management application. In some embodiments, in response to receiving the other request to control the accessory associated with the space and in accordance with a determination that a current time is at a second time (e.g., a time that is not one of the one or more times), different from the first time, and/or that the invitation to join the space of the accessory management application was received from the first user, the computer system displays, via the one or more display generation components, the user interface with the indication of the first user without the user interface element of the accessory associated with the space of the accessory management application. In some embodiments, the user interface includes the indication of the one or more times in which the computer system is able to control the accessory associated with the space of the accessory management application. A representation of an invitation to join a space including one or more times in which the computer system is able to control accessories of the space allows a user to understand their restrictions if they accept the invitation, thereby reducing the number of inputs needed to perform an operation and/or providing improved visual feedback to the user.

In some embodiments, while displaying the user interface with the indication of the first user and the user interface element of the accessory associated with the space, the computer system displays, via the one or more display generation components, a user interface element (e.g., a button, a representation, an indication, an identification, a graphical representation, an image, and/or a control) (e.g., 668d and/or 678b) to contact the first user (e.g., without displaying a user interface element to contact the second user). In some embodiments, while displaying the user interface element to contact the first user, the computer system detects, via one or more input devices of the computer system, an input (e.g., a selection input and/or a non-selection input) corresponding to the user interface element to contact the first user. In some embodiments, in response to detecting the input corresponding to the user interface element to contact the first user, the computer system displays, via the one or more display generation components, a communication user interface to contact the first user. In some embodiments, while displaying the user interface with the indication of the second user and the user interface element of the accessory associated with the space, the computer system displays, via the one or more display generation components, a user interface element (e.g., a button, a representation, an indication, an identification, a graphical representation, an image, and/or a control) to contact the second user (e.g., without displaying the user interface element to contact the first user). Displaying a user interface element to contact a user that invited a user of the computer system to join a space allows the user of the computer system to quickly be able to contact the user that invited them so as to change restrictions on the computer system, thereby reducing the number of inputs needed to perform an operation.

In some embodiments, the invitation to join the space of the accessory management application is an invitation to join the space of the accessory management application as a guest (e.g., occasional visitor, short-term presence invitee, and/or temporary occupant) (e.g., with limited rights as compared to a resident). In some embodiments, the invitation to join the space of the accessory management application received from the second user is an invitation to join the space of the accessory management application as a guest.

In some embodiments, in response to receiving the request to display the user interface of the accessory management application and in accordance with a determination that the invitation to join the space of the accessory management application was to join as a resident (and/or in accordance with a determination that the invitation to join the space of the accessory management application was received from a third user, such as the first user, the second user, or another user different from the first user and the second user) (e.g., 664), the computer system displays, via the one or more display generation components, the user interface with the user interface element of the accessory associated with the space and without an indication of a user (e.g., an indication of the third user) that sent the invitation to join the space of the accessory management application (e.g., as described above and/or illustrated with respect to FIGS. 6AN and/or 6AO). In some embodiments, a resident is a full-time occupant, long-term presence invitee, and/or full access user. Not displaying an indication of a user that invited a user of the computer system when the user of the computer system is joining the space as a resident allows the computer system to only display information of other users when they might need to be contacted, thereby performing an operation when a set of conditions has been met without requiring further user input.

In some embodiments, the indication of the first user includes an identification (e.g., name, email address, phone number, and/or username) (e.g., “Steve”) of the first user. In some embodiments, the indication of the second user includes an identification (e.g., name, email address, phone number, and/or username) of the second user.

In some embodiments, the identification of the first user includes a name assigned to a contact of the computer system (and/or of a user of the computer system). In some embodiments, the contact of the computer system corresponds to (and/or associated with) the first user.

In some embodiments, the computer system is a first computer system. In some embodiments, the identification of the first user includes a name assigned to the first user by a second computer system different from the first computer system. In some embodiments, the first computer system receives, from the second computer system, the name assigned to the first user by the second computer system. In some embodiments, the second computer system is a phone, a watch, a tablet, a fitness tracking device, a wearable device, an accessory, a speaker, a light, a head-mounted display (HMD), and/or a personal computing device.

In some embodiments, while displaying the user interface (e.g., with or without the indication of the first user and the user interface element of the accessory associated with the space) (and/or in response to receiving the request to display the user interface of the accessory management application), the computer system displays, via the one or more display generation components, an indication (e.g., an identification, a text, a graphical image, a symbol, and/or an animation) (e.g., 666a) of a time (e.g., period of time, start time, and/or end time) to control the accessory associated with the space of the accessory management application. A user interface including a user interface element to control an accessory including an indication of a time to control the accessory allows a user to understand their restrictions in a contextual manner, thereby performing an operation when a set of conditions has been met without requiring further user input.

In some embodiments, the request to display the user interface of the accessory management application is a first request. In some embodiments, after receiving the first request, the computer system receives (e.g., detects, via one or more input devices of the computer system, an input (e.g., a selection input and/or a non-selection input) corresponding to and/or receives, via an application of the computer system) a second request to display the user interface of the accessory management application. In some embodiments, in response to receiving the second request to display the user interface of the accessory management application, in accordance with a determination that a first set of one or more criteria is satisfied (e.g., that a current context satisfies the first set of one or more criteria as described above with respect to process 1000), the computer system displays, via the one or more display generation components, the user interface with (1) an indication (e.g., an identification, a text, a graphical image, a symbol, and/or an animation) of a time to control the accessory associated the space of the accessory management application and (2) the user interface element of the accessory associated with the space of the accessory management application. In some embodiments, in response to receiving the second request to display the user interface of the accessory management application, in accordance with a determination that the first set of one or more criteria is not satisfied, the computer system displays, via the one or more display generation components, the user interface (1) with the indication of the time to control the accessory associated with the space of the accessory management application and (2) without the user interface element of the accessory associated with the space of the accessory management application (e.g., as illustrated with respect to FIG. 6AK). Only displaying a user interface element to control an accessory when the accessory is able to be controlled allows the computer system to only surface controls that are able to be used, thereby performing an operation when a set of conditions has been met without requiring further user input and/or providing improved visual feedback to the user.

In some embodiments, the first set of one or more criteria includes a criterion that is satisfied when a determination is made that a current time is within a predefined time (e.g., period of time, start time, and/or end time) to control the accessory associated with the space of the accessory management application. A criterion for allowing a user to access controls of accessories in a space being based on time allows a user managing the accessories to restrict use of the accessories by time, thereby performing an operation when a set of conditions has been met without requiring further user input.

In some embodiments, the first set of one or more criteria includes a criterion that is satisfied when a determination is made that a location (e.g., coordinate and/or position in a physical environment) of the computer system is within a set of one or more locations to control the accessory associated with the space of the accessory management application. In some embodiments, the set of one or more locations includes a threshold distance and/or address corresponding to the location of the space of the accessory management application. A criterion for allowing a user to access controls of accessories in a space being based on location of the computer system allows a user managing the accessories to restrict use of the accessories by location, thereby performing an operation when a set of conditions has been met without requiring further user input.

In some embodiments, the first user is a guest (e.g., occasional visitor, short-term presence invitee, and/or temporary occupant) of the space of the accessory management application. In some embodiments, the second user is a guest of the space of the accessory management application.

In some embodiments, the second user is a resident (e.g., full-time occupant, long-term presence invitee, and/or full access user) of the space of the accessory management application. In some embodiments, the first user is a resident of the space of the accessory management application. In some embodiments, the first user is not a resident of the space of the accessory management application.

In some embodiments, the second user is an owner (e.g., full-time occupant, long-term presence invitee, and/or full access user) of the space of the accessory management application.

In some embodiments, the first user is not an owner (e.g., full-time occupant, long-term presence invitee, and/or full access user) of the space of the accessory management application.

In some embodiments, a user of the computer system is not an owner (e.g., full-time occupant, long-term presence invitee, and/or full access user) of the space of the accessory management application.

In some embodiments, the accessory is a first accessory. In some embodiments, in accordance with the determination that the invitation to join the space of the accessory management application was received from the first user, the user interface includes a user interface element of a second accessory, different from the first accessory, associated with the space of the accessory management application. In some embodiments, the second accessory is a different type of accessory than the first accessory (e.g., has a different type of input or output device, provides content in a different manner, and/or includes a different set of one or more sensors).

In some embodiments, the user interface element of the accessory associated with the space of the accessory management application includes (and/or is) a control for the accessory associated with the space of the accessory management application. In some embodiments, the control for the accessory associated with the space of the accessory management application is a control to perform an operation (e.g., to unlock, lock, close, open, and/or turn off/on). In some embodiments, while displaying the control for the accessory, the computer system detects, via one or more input devices, an input (e.g., a selection input and/or a non-selection input) corresponding to the control for the accessory. In some embodiments, in response to detecting the input corresponding to the control for the accessory, the computer system causes the accessory to perform an operation. Displaying a control for an accessory in a space with a user interface associated with the space allows the user interface to be a location to go for interacting with the space, thereby reducing the number of inputs needed to perform an operation and/or providing improved visual feedback to the user.

In some embodiments, the user interface element of the accessory associated with the space of the accessory management application includes a status (e.g., current state and/or operation) of the accessory associated with the space of the accessory management application. In some embodiments, the current state includes an indication (e.g., a graphical indication, image, symbol, and/or text) of locked, unlocked, open, shut, off, on, cooling, heating, and/or currently running (e.g., for an appliance). Displaying a status of an accessory in a space with a user interface associated with the space allows the user interface to be a location to go for interacting with the space, thereby reducing the number of inputs needed to perform an operation and/or providing improved visual feedback to the user.

Note that details of the processes described above with respect to process 1100 (e.g., FIG. 11) are also applicable in an analogous manner to the processes described herein. For example, process 700 optionally includes one or more of the characteristics of the various processes described herein with reference to process 1100. For example, the accessory of method 700 can be the accessory of method 1100. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve managing accessories. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing accessories. Accordingly, use of such personal information data enables users to have a computer system perform operations for managing accessories. Further, other uses for personal information data that benefit the user are also contemplated by the present disclosure. For instance, location data may be used to automatically control smart home accessories based on a user's proximity, thereby increasing convenience and/or responsiveness to the user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more input devices, and one or more display generation components:
displaying, via the one or more display generation components, a user interface including a first user interface element and a second user interface element different from the second user interface element;
while displaying the first user interface element and the second user interface element, detecting, via the one or more input devices, an input corresponding to a respective user interface element; and
in response to detecting the input corresponding to the respective user interface element:
in accordance with a determination that the respective user interface element is the first user interface element:
configuring the computer system to control an accessory in a first manner without detecting, via the one or more input devices, an input; and
configuring the computer system to control the accessory in a second manner without detecting, via the one or more input devices, an input, wherein the second manner is different from the first manner; and
in accordance with a determination that the respective user interface element is the second user interface element, configuring the computer system to control the accessory in a third manner, wherein the third manner is different from the first manner and the second manner.

2. The method of claim 1, wherein the computer system is in communication with one or more sensors, and wherein configuring the computer system to control the accessory in the first manner without detecting, via the one or more input devices, an input includes configuring the computer system to control the accessory based on a position of the computer system detected via the one or more sensors.

3. The method of claim 1, wherein configuring the computer system to control the accessory in the second manner without detecting, via the one or more input devices, an input includes configuring the computer system to control the accessory based on a proximity of the computer system detected via a communication channel.

4. The method of claim 1, wherein the accessory is a lock.

5. The method of claim 1, further comprising:
while the accessory is in a locked state and after configuring the computer system to control the accessory in the first manner, detecting that the computer system satisfies a first set of one or more criteria corresponding to the first manner without detecting, via the one or more input devices, an input;
in response to detecting that the computer system satisfies the first set of one or more criteria corresponding to the first manner without detecting, via the one or more input devices, an input, controlling the accessory;
while the accessory is in the locked state and after configuring the computer system to control the accessory in the second manner, detecting that the computer system satisfies a second set of one or more criteria, different from the first set of one or more criteria, corresponding to the second manner without detecting, via the one or more input devices, an input;
in response to detecting that the computer system satisfies the second set of one or more criteria corresponding to the second manner without detecting, via the one or more input devices, an input, controlling the accessory;
while the accessory is in the locked state and after configuring the computer system to control the accessory in the third manner, detecting that the computer system satisfies a third set of one or more criteria, different from the first set of one or more criteria and the second set of one or more criteria, corresponding to the third manner; and
in response to detecting that the computer system satisfies the third set of one or more criteria corresponding to the third manner, controlling the accessory.

6. The method of claim 1, further comprising:
while the computer system is in a locked state:
after configuring the computer system to control the accessory in the first manner, detecting that the computer system satisfies a first set of one or more criteria corresponding to the first manner without detecting, via the one or more input devices, an input; and
in response to detecting that the computer system satisfies the first set of one or more criteria corresponding to the first manner without detecting, via the one or more input devices, an input, controlling the accessory;
while the computer system is in the locked state:
after configuring the computer system to control the accessory in the second manner, detecting that the computer system satisfies a second set of one or more criteria, different from the first set of one or more criteria, corresponding to the second manner without detecting, via the one or more input devices, an input; and
in response to detecting that the computer system satisfies the second set of one or more criteria corresponding to the second manner without detecting, via the one or more input devices, an input, controlling the accessory; and
while the computer system is in the locked state:
after configuring the computer system to control the accessory in the third manner, detecting that the computer system satisfies a third set of one or more criteria, different from the first set of one or more criteria and the second set of one or more criteria, corresponding to the third manner; and
in response to detecting that the computer system satisfies the third set of one or more criteria corresponding to the third manner, controlling the accessory.

7. The method of claim 1, further comprising:
after configuring the computer system to control the accessory in the third manner, detecting a proximity of the accessory relative to the computer system; and
after detecting the proximity of the accessory relative to the computer system, displaying, via the one or more display generation components, a user interface element to authenticate a user of the computer system.

8. The method of claim 1, further comprising:
after configuring the computer system to control the accessory in the first manner and after configuring the computer system to control the accessory in the second manner, detecting, via the one or more input devices, a first input corresponding to a first request to change a first respective configuration;
in response to detecting the first input corresponding to the first request to change the first respective configuration:
in accordance with a determination that the first respective configuration is a first configuration, configuring the computer system to no longer control the accessory in the first manner while maintaining the computer system configured to control the accessory in the second manner; and
in accordance with a determination that the first respective configuration is a second configuration different from the first configuration, configuring the computer system to no longer control the accessory in the second manner while maintaining the computer system configured to control the accessory in the first manner;
after configuring the computer system to control the accessory in the third manner, detecting, via the one or more input devices, a second input corresponding to a second request to change a second respective configuration; and
in response to detecting the second input corresponding to the second request to change the second respective configuration:
in accordance with a determination that the second respective configuration is a third configuration different from the first configuration, configuring the computer system to control the accessory in the first manner; and
in accordance with a determination that the second respective configuration is a fourth configuration different from the second configuration, configuring the computer system to control the accessory in the second manner.

9. The method of claim 1, wherein the accessory is a first accessory, wherein the respective user interface element is a first respective user interface element, the method further comprising:
while the first accessory is configured to be controlled in the first manner:
displaying, via the one or more display generation components, a third user interface element;
while displaying the third user interface element, detecting, via the one or more input devices, an input corresponding to the third user interface element; and
in response to detecting the input corresponding to the third user interface element, configuring the computer system to control a second accessory, different from the first accessory, in a fourth manner different from the first manner.

10. The method of claim 1, wherein configuring the computer system to control the accessory in the third manner includes configuring the computer system to control the accessory in response to the computer system authenticating a user.

11. The method of claim 1, wherein configuring the computer system to control the accessory in the first manner includes:
displaying, via the one or more display generation components, a user interface including a first indication corresponding to first set of one or more positions and a second indication corresponding to a second set of one or more positions different from the first set of one or more positions, wherein the second indication is separate from the first indication;
while displaying the user interface including the first indication and the second indication, detecting, via the one or more input devices, an input corresponding to a respective indication; and
after detecting the input corresponding to the respective indication:
in accordance with a determination that the respective indication is the first indication, configuring the computer system to control the accessory in response to detecting the computer system in the first set of one or more positions; and
in accordance with a determination that the respective indication is the second indication, configuring the computer system to control the accessory in response to detecting the computer system in the second set of one or more positions.

12. The method of claim 1, further comprising:
in response to detecting the input corresponding to the respective user interface element, initiating a process to configure a code for the accessory.

13. The method of claim 1, wherein configuring the computer system to control the accessory in the first manner without detecting, via the one or more input devices, an input includes configuring the computer system to control the accessory based on a position of the computer system relative to the accessory.

14. The method of claim 1, wherein configuring the computer system to control the accessory in the second manner without detecting, via the one or more input devices, an input includes configuring the computer system to control the accessory based on a proximity of the computer system relative to the accessory.

15. A non-transitory computer-readable storage medium storing one or more programs configured to be executed by one or more processors of a computer system that is in communication with one or more input devices, and one or more display generation components, the one or more programs including instructions for:
displaying, via the one or more display generation components, a user interface including a first user interface element and a second user interface element different from the second user interface element;
while displaying the first user interface element and the second user interface element, detecting, via the one or more input devices, an input corresponding to a respective user interface element; and
in response to detecting the input corresponding to the respective user interface element:
in accordance with a determination that the respective user interface element is the first user interface element:
configuring the computer system to control an accessory in a first manner without detecting, via the one or more input devices, an input; and
configuring the computer system to control the accessory in a second manner without detecting, via the one or more input devices, an input, wherein the second manner is different from the first manner; and
in accordance with a determination that the respective user interface element is the second user interface element, configuring the computer system to control the accessory in a third manner, wherein the third manner is different from the first manner and the second manner.

16. A computer system configured to communicate with one or more input devices, and one or more display generation components, comprising:
one or more processors; and
memory storing one or more programs configured to be executed by the one or more processors, the one or more programs including instructions for:
displaying, via the one or more display generation components, a user interface including a first user interface element and a second user interface element different from the second user interface element;
while displaying the first user interface element and the second user interface element, detecting, via the one or more input devices, an input corresponding to a respective user interface element; and
in response to detecting the input corresponding to the respective user interface element:
in accordance with a determination that the respective user interface element is the first user interface element:
configuring the computer system to control an accessory in a first manner without detecting, via the one or more input devices, an input; and
configuring the computer system to control the accessory in a second manner without detecting, via the one or more input devices, an input, wherein the second manner is different from the first manner; and
in accordance with a determination that the respective user interface element is the second user interface element, configuring the computer system to control the accessory in a third manner, wherein the third manner is different from the first manner and the second manner.
